(19) United States
(12) Patent Application Publication
(10) Pub. No.: US 2017/0113485 A1
(43) Pub. Date: Apr. 27, 2017

(54) WHEEL ASSEMBLIES FOR A STROLLER

(71) Applicant: Austlen Baby Co., Berwyn, PA (US)

(72) Inventor: Patrick William Laffan, Berwyn, PA (US)

(21) Appl. No.: 15/299,114

(22) Filed: Oct. 20, 2016

Related U.S. Application Data
(60) Provisional application No. 62/244,359, filed on Oct. 21, 2015.

(51) Int. Cl. B60B 11/00; B62B 7/04; B62B 9/20; B60B 19/06

(52) U.S. Cl. CPC B60B 11/00; B60B 19/06; B62B 7/042; B62B 9/20; B60B 2360/32; B60B 2360/50

(57) ABSTRACT

Wheel assemblies and strollers comprising wheel assemblies are provided. The wheel assembly can comprise a standard wheel and a modular wheel, where the standard wheel has a first diameter that is greater than the diameter of the modular wheel. The modular wheel can be fixedly or removably attached to the standard wheel. The stroller can comprise at least one rear wheel assembly located proximate to a rear of the base. The stroller can also comprise at last one front wheel assembly located proximate to a front of the base. The stroller can also comprise a pulling and/or steering mechanism.

### TECHNICAL FIELD

The present disclosure relates generally to wheel assemblies, and in particular, modular wheel assemblies for a stroller.

### BACKGROUND

Baby strollers have been known and used for a number of years to provide a comfortable device to move a baby or small child. Typical strollers have standard wheels for moving over rigid surfaces, e.g., wood, concrete. However, it is difficult to move these strollers with standard wheels comfortably and easily across non-rigid surfaces, e.g., sand, gravel.

What is desired is a wheel assembly, in particular a modular wheel assembly for a stroller, that, among other things, is configured for use on both a rigid surface and a non-rigid surface.

### SUMMARY

In one embodiment of the present disclosure, a wheel assembly comprising at least one standard wheel, and at least one modular wheel, wherein the at least one standard wheel has a first diameter and the at least one modular wheel has a second diameter, and wherein the first diameter is greater than the second diameter, is provided. In another embodiment of the present disclosure, a stroller comprising at least one rear wheel assembly located proximate to a rear of the base, wherein the at least one rear wheel assembly comprises at least one rear standard wheel and at least one rear modular wheel, wherein the at least one rear standard wheel has a first rear diameter and the at least one rear modular wheel has a second rear diameter, and wherein the first rear diameter is greater than the second rear diameter, is provided.

### BRIEF DESCRIPTION OF THE DRAWINGS

FIG. 1 illustrates a front side perspective view of a stroller with modular wheel assembly, according to an exemplary embodiment.

FIG. 2 illustrates a front perspective view of the stroller with modular wheel assembly, according to an exemplary embodiment.

FIG. 3 illustrates a side perspective view of the stroller with modular wheel assembly, according to an exemplary embodiment.

FIG. 4 illustrates a front perspective view of a front wheel assembly of the stroller, according to an exemplary embodiment.

FIG. 5 illustrates a front perspective view of the stroller with modular wheel assembly, according to an exemplary embodiment, with a front wheel assembly shown detached from the stroller.

FIG. 6 illustrates a side perspective view of the stroller with modular wheel assembly, according to an exemplary embodiment, with a front wheel assembly shown detached from the stroller.

FIG. 7 illustrates a side perspective view of the stroller with modular wheel assembly, according to an exemplary embodiment, with a rear wheel assembly shown detached from the stroller.

FIG. 8 illustrates a front side perspective view of the stroller with modular wheel assembly, according to an exemplary embodiment, with the rear wheel assembly shown detached from the stroller.

FIG. 9 illustrates a side perspective view of the stroller with modular wheel assembly, according to an exemplary embodiment, with the rear wheel assembly shown detached from the stroller.

FIG. 10 illustrates a side perspective view of the rear wheel assembly, from the exterior of the stroller, according to an exemplary embodiment.

FIG. 11 illustrates a side perspective view of the rear wheel assembly, from the interior of the stroller, according to an exemplary embodiment.

FIG. 12 illustrates a front perspective view of the rear wheel assembly with a snap-on fit mechanism, according to an exemplary embodiment.

FIG. 13 illustrates a front perspective view of the modular wheel portion of the rear wheel assembly with the snap-on fit mechanism, from the exterior of the stroller, according to an exemplary embodiment.

FIG. 14 illustrates a front perspective view of the modular wheel portion of the rear wheel assembly with the snap-on fit mechanism, from the interior of the stroller, according to an exemplary embodiment.

FIG. 15 illustrates a front perspective view of the rear wheel assembly with the snap-on fit mechanism, according to an exemplary embodiment.

FIG. 16 illustrates a front perspective view of the stroller with modular wheel assembly, with the rear wheel assembly, with the snap-on fit mechanism, shown detached from the stroller, according to an exemplary embodiment.

FIG. 17 illustrates a front perspective view of the front wheel assembly with the snap-on fit mechanism, according to an exemplary embodiment.

FIG. 18 illustrates a front perspective view of the front wheel assembly with the snap-on fit mechanism, according to an exemplary embodiment.

FIG. 19 illustrates a front perspective view of the stroller with modular wheel assembly, with the front wheel assembly, with the snap-on fit mechanism, shown detached from the stroller, according to an exemplary embodiment.

FIG. 20 illustrates a front side perspective view of the front wheel assembly configured for a flexible pulling mechanism, according to an exemplary embodiment.

FIG. 21 illustrates a front side perspective view of the stroller with modular wheel assembly, with the front and rear wheel assemblies attached, and a flexible pulling mechanism, according to an exemplary embodiment.

FIG. 22 illustrates a front perspective view of the stroller with modular wheel assembly, with the front and rear wheel assemblies attached, and a flexible pulling mechanism, according to an exemplary embodiment.

FIG. 23 illustrates a front perspective view of the stroller with modular wheel assembly, with a flexible pulling mechanism, according to an exemplary embodiment.

FIG. 24 illustrates a front perspective view of the front wheel assembly with a flexible pulling mechanism, according to an exemplary embodiment.

FIG. 25 illustrates a front side perspective view of the stroller with modular wheel assembly with front and rear wheel assemblies and a rigid pulling mechanism, according to an exemplary embodiment.

FIG. 26 illustrates a front side perspective view of the stroller with modular wheel assembly with front and rear wheel assemblies and a rigid pulling mechanism, according to an exemplary embodiment.

FIG. 27 illustrates a front perspective view of a stroller with modular wheel assembly and a steering pull mechanism, according to an exemplary embodiment.

FIG. 28 illustrates a front perspective view of the stroller with modular wheel assembly and a steering pull mechanism, according to an exemplary embodiment.

FIG. 29 illustrates a front perspective view of the stroller with modular wheel assembly and a steering pull mechanism, according to an exemplary embodiment.

FIG. 30 illustrates a front side perspective view of the stroller with modular wheel assembly and a steering pull mechanism, according to an exemplary embodiment.

FIG. 31 illustrates a front side perspective view of the stroller with modular wheel assembly and a steering pull mechanism, according to an exemplary embodiment.

FIG. 32 illustrates a front side perspective view of the stroller with modular wheel assembly and a steering pull mechanism, according to an exemplary embodiment.

FIG. 33 illustrates a front side perspective view of the stroller with modular wheel assembly and a steering pull mechanism, according to an exemplary embodiment.

FIG. 34 illustrates a side perspective view of the stroller with modular wheel assembly and a steering pull mechanism, according to an exemplary embodiment.

FIG. 35 illustrates a front side perspective view of the stroller with modular wheel assembly and a steering pull mechanism, according to an exemplary embodiment.

FIG. 36 illustrates a top perspective view of the stroller with modular wheel assembly and a steering pull mechanism, according to an exemplary embodiment.

FIG. 37 illustrates a front perspective view of the axel of the stroller with modular wheel assembly and a steering pull mechanism, according to an exemplary embodiment.

FIG. 38 illustrates a front perspective view of the axel of the stroller with modular wheel assembly and a steering pull mechanism, according to an exemplary embodiment.

FIG. 39 illustrates a front perspective view of the stroller with modular wheel assembly and a steering pull mechanism, according to an exemplary embodiment.

FIG. 40 illustrates a front perspective view of the stroller with modular wheel assembly and a steering pull mechanism, according to an exemplary embodiment.

FIG. 41 illustrates a side perspective view of the stroller with modular wheel assembly and a steering pull mechanism, according to an exemplary embodiment.

FIG. 42 illustrates a front side perspective view of a stroller with modular wheel assembly, according to an exemplary embodiment.

FIG. 43 illustrates a close-up view of front wheel assembly attached to a stroller frame, according to an exemplary embodiment.

FIG. 44 illustrates a close-up view of front wheel assembly detached from a stroller frame, according to an exemplary embodiment

FIG. 45 illustrates a close-up view of an upper hub of a front wheel assembly, according to an exemplary embodiment.

FIG. 46 illustrates a close-up view of an upper hub of a front wheel assembly, according to an exemplary embodiment.

FIG. 47 illustrates a close-up view of an upper hub of a front wheel assembly, according to an exemplary embodiment.

FIG. 48 illustrates a close-up view of an upper hub of a front modular wheel assembly, according to an exemplary embodiment.

FIG. 49 illustrates a close-up view of an upper hub of a front wheel assembly, according to an exemplary embodiment.

FIG. 50 illustrates a close-up view of an upper hub of a front wheel assembly, according to an exemplary embodiment.

FIG. 51 illustrates a close-up view of an upper hub of a front wheel assembly, according to an exemplary embodiment.

FIG. 52 illustrates a front view of a front wheel assembly, according to an exemplary embodiment.

FIG. 53 illustrates an exploded front view of a front wheel assembly, according to an exemplary embodiment.

FIG. 54 illustrates a front view of a front wheel assembly, according to an exemplary embodiment.

FIG. 55 illustrates a front view of a front wheel assembly, according to an exemplary embodiment

FIG. 56 illustrates a front perspective view of a rear wheel assembly, according to an exemplary embodiment.

FIG. 57 illustrates a front perspective view of a rear wheel assembly, according to an exemplary embodiment.

FIG. 58 illustrates a front perspective view of a rear wheel assembly attached to a stroller, according to an exemplary embodiment.

FIG. 59 illustrates an exploded front perspective view of a rear wheel assembly, according to an exemplary embodiment.

FIG. 60 illustrates a front perspective view of a rear wheel assembly attached to a stroller, according to an exemplary embodiment.

FIG. 61 illustrates a front perspective view of a rear wheel assembly attached to a stroller, according to an exemplary embodiment

FIG. 62 illustrates an exploded front perspective view of a rear wheel assembly, according to an exemplary embodiment.

FIG. 63 illustrates a close-up view of a rear wheel assembly and rear locking mechanism, according to an exemplary embodiment.

FIG. 64 illustrates a close-up view of a rear wheel assembly and rear locking mechanism, according to an exemplary embodiment.

FIG. 65 illustrates a close-up view of a rear wheel assembly and rear locking mechanism, according to an exemplary embodiment.

FIG. 66 illustrates a side perspective view of a rear wheel assembly and snap mechanism, according to an exemplary embodiment.

FIG. 67 illustrates an exploded side perspective view of a rear wheel assembly and snap mechanism, according to an exemplary embodiment

FIG. 68 illustrates a front perspective view of a front wheel assembly with a hook for a pulling mechanism, according to an exemplary embodiment.

FIG. 69 illustrates a front perspective view of a flexible pulling mechanism, according to an exemplary embodiment.

FIG. 70 illustrates a close-up front perspective view of a flexible pulling mechanism, according to an exemplary embodiment.

FIG. 71 illustrates a front perspective view of a stroller with modular wheel assembly and a flexible pulling mechanism, according to an exemplary embodiment.

FIG. 72 illustrates a close-up view of a flexible pulling mechanism, according to an exemplary embodiment.

FIG. 73 illustrates a front perspective view of a stroller with modular wheel assembly and a flexible pulling mechanism, according to an exemplary embodiment.

FIG. 74 illustrates a close-up view of a flexible pulling mechanism, according to an exemplary embodiment.

FIG. 75 illustrates a front perspective view of a stroller with modular wheel assembly and a flexible pulling mechanism, according to an exemplary embodiment.

FIG. 76 illustrates a close-up view of a flexible pulling mechanism, according to an exemplary embodiment.

FIG. 77 illustrates a close-up view of a flexible pulling mechanism, according to an exemplary embodiment.

FIG. 78 illustrates a front perspective view of a stroller with modular wheel assembly and a rigid pulling mechanism, according to an exemplary embodiment.

FIG. 79 illustrates a close-up view of a rigid pulling mechanism, according to an exemplary embodiment.

FIG. 80 illustrates a front perspective view of a stroller with modular wheel assembly and a rigid pulling mechanism, according to an exemplary embodiment.

FIG. 81 illustrates a close-up view of a rigid pulling mechanism, according to an exemplary embodiment.

FIG. 82 illustrates a close-up view of a rigid pulling mechanism, according to an exemplary embodiment.

FIG. 83 illustrates a close-up view of a rigid pulling mechanism, according to an exemplary embodiment.

FIG. 84 illustrates a front perspective view of a stroller with modular wheel assembly and a rigid pulling mechanism, according to an exemplary embodiment.

FIG. 85 illustrates a close-up view of a rigid pulling mechanism, according to an exemplary embodiment

FIG. 86 illustrates an exploded close-up view of a rigid pulling mechanism, according to an exemplary embodiment.

FIG. 87 illustrates a front perspective view of a stroller with modular wheel assembly and a tow bar mechanism, according to an exemplary embodiment.

FIG. 88 illustrates a close-up view of a tow bar mechanism, according to an exemplary embodiment.

FIG. 89 illustrates an exploded close-up view of a tow bar mechanism, according to an exemplary embodiment.

FIG. 90 illustrates a close-up view of a tow bar mechanism, according to an exemplary embodiment.

FIG. 91 illustrates a close-up view of a tow bar mechanism, according to an exemplary embodiment.

FIG. 92 illustrates a close-up view of a telescopic tow bar mechanism, according to an exemplary embodiment.

### DETAILED DESCRIPTION

The following detailed description is exemplary and explanatory and is intended to provide further explanation of the present disclosure described herein. Other advantages, and novel features will be readily apparent to those skilled in the art from the following detailed description of the present disclosure.

Embodiments of the present disclosure generally relate to wheel assemblies that are configured for use on both a rigid surface and a non-rigid surface, in particular, wheel assemblies for a stroller. In one embodiment, wheel assemblies comprising at least one standard wheel and at least one modular wheel are provided. The at least one standard wheel can have a first diameter and the at least one modular wheel can have a second diameter. The first diameter can be greater than the second diameter. The at least one modular wheel can be removably attached to the at least one standard wheel. The at least one modular wheel can be fixedly attached to the at least one standard wheel. The at least one modular wheel can be attached to the at least one standard wheel via a snap-on fit mechanism. The at least one standard wheel can have a first surface area and the at least one modular wheel can have a second surface area. The first surface area can be smaller than the second surface area. The at least one standard wheel can have a first tread pattern and the at least one modular wheel can have a second tread pattern. The first tread pattern can be different than the second treat pattern. The at least one standard wheel and the at least one modular wheel can comprise at least one selected from the group consisting of plastic, rubber and synthetics. The at least one standard wheel and the at least one modular wheel can be gas-filled. The at least one standard wheel and the at least one modular wheel are solid. The wheel assembly can be at least one of a rear wheel assembly of a stroller and a front wheel assembly of a stroller.

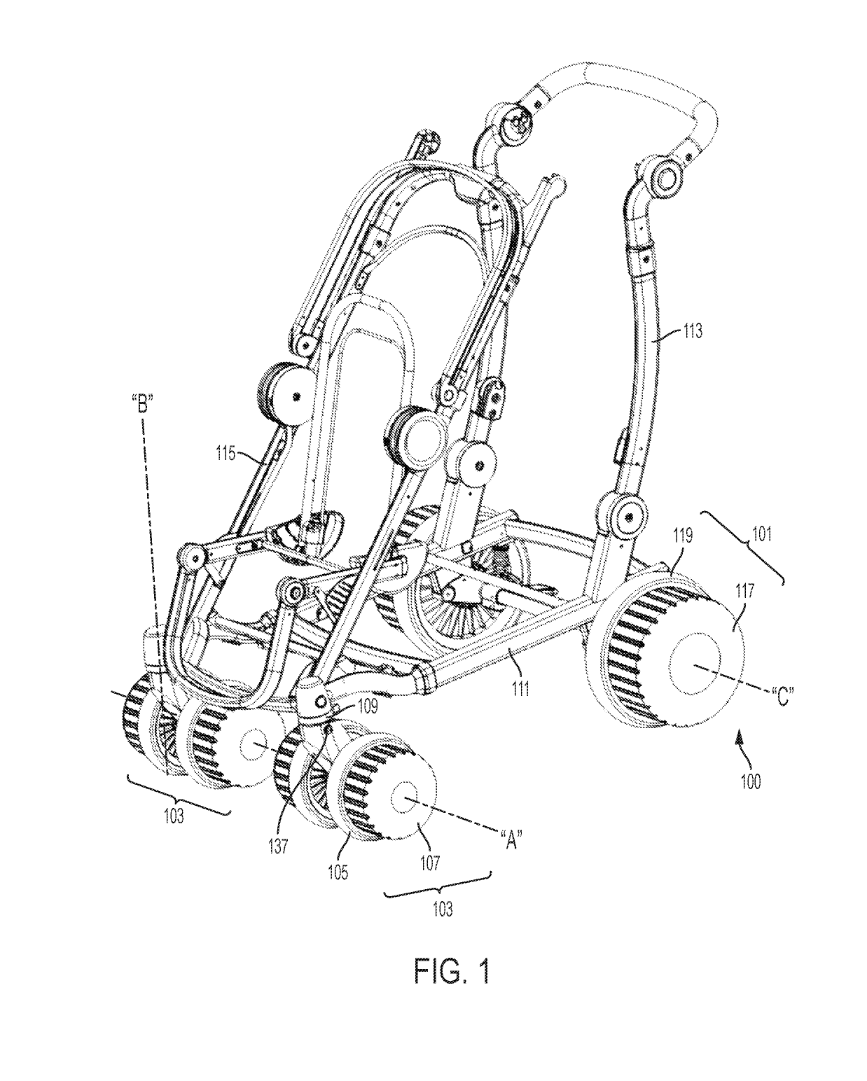

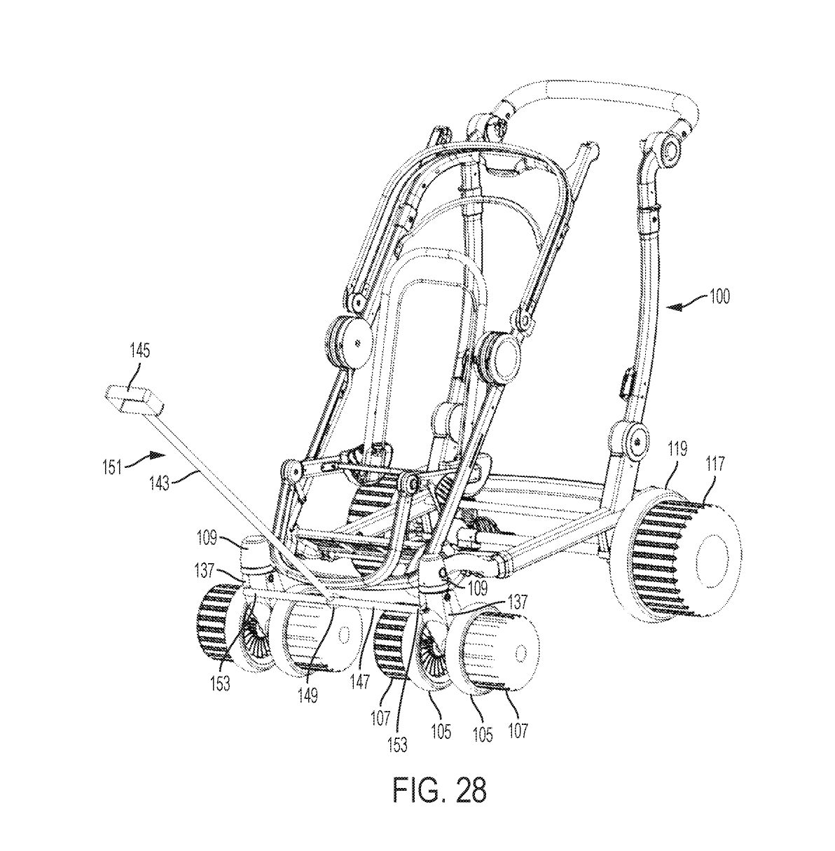

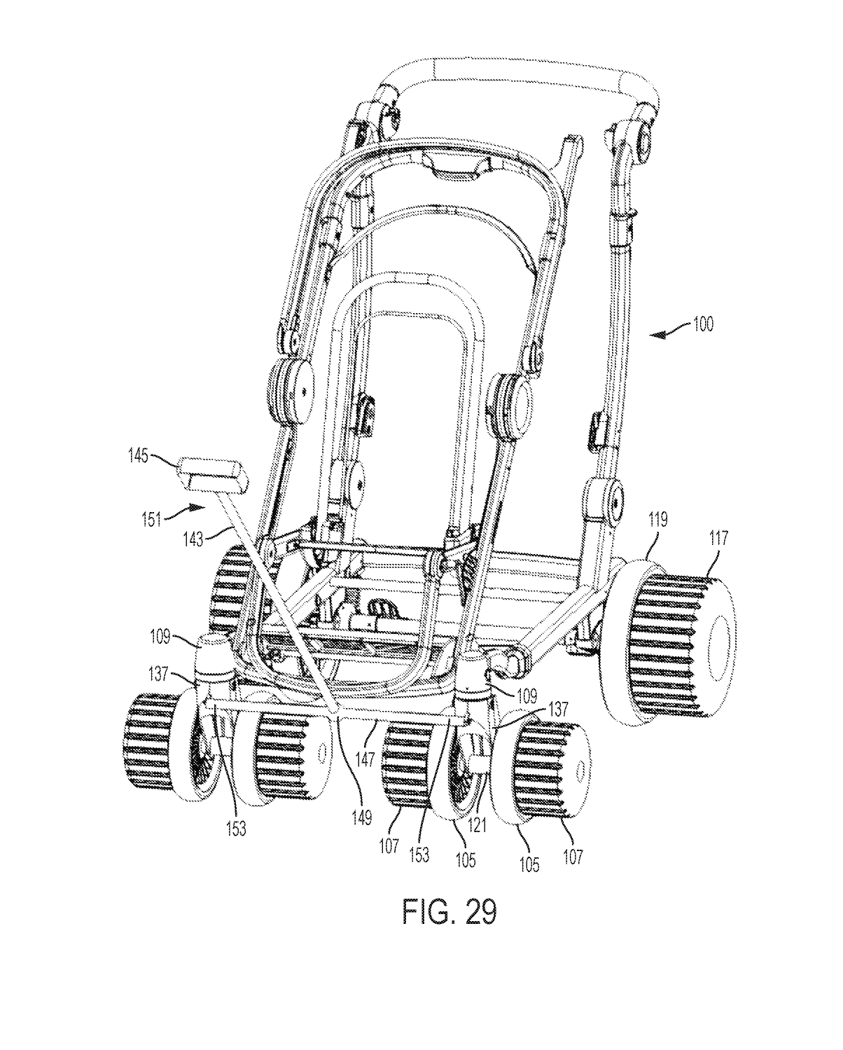

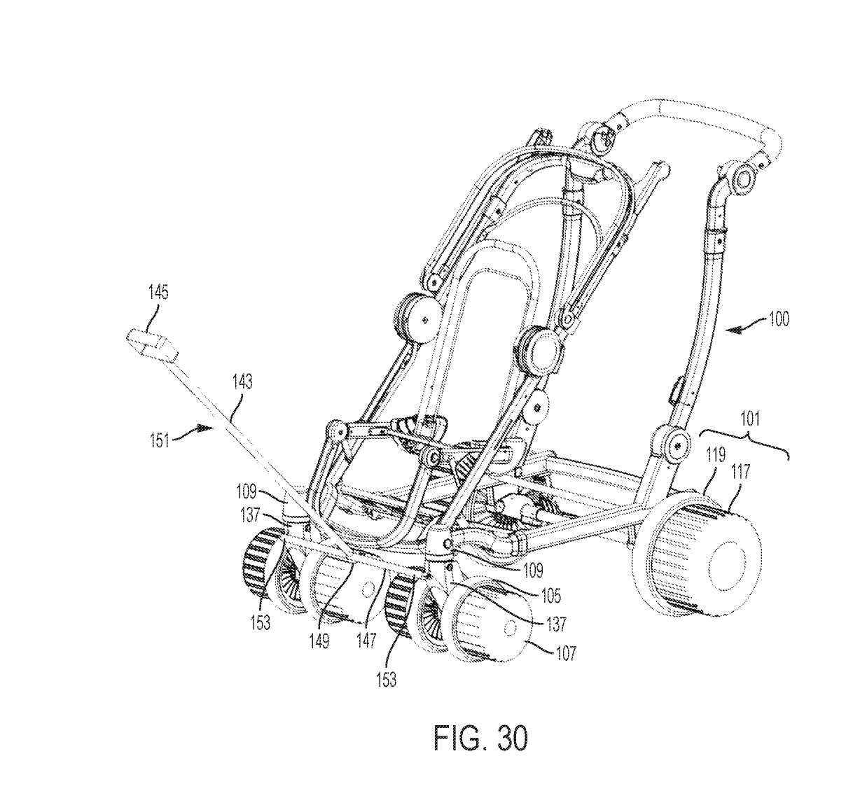

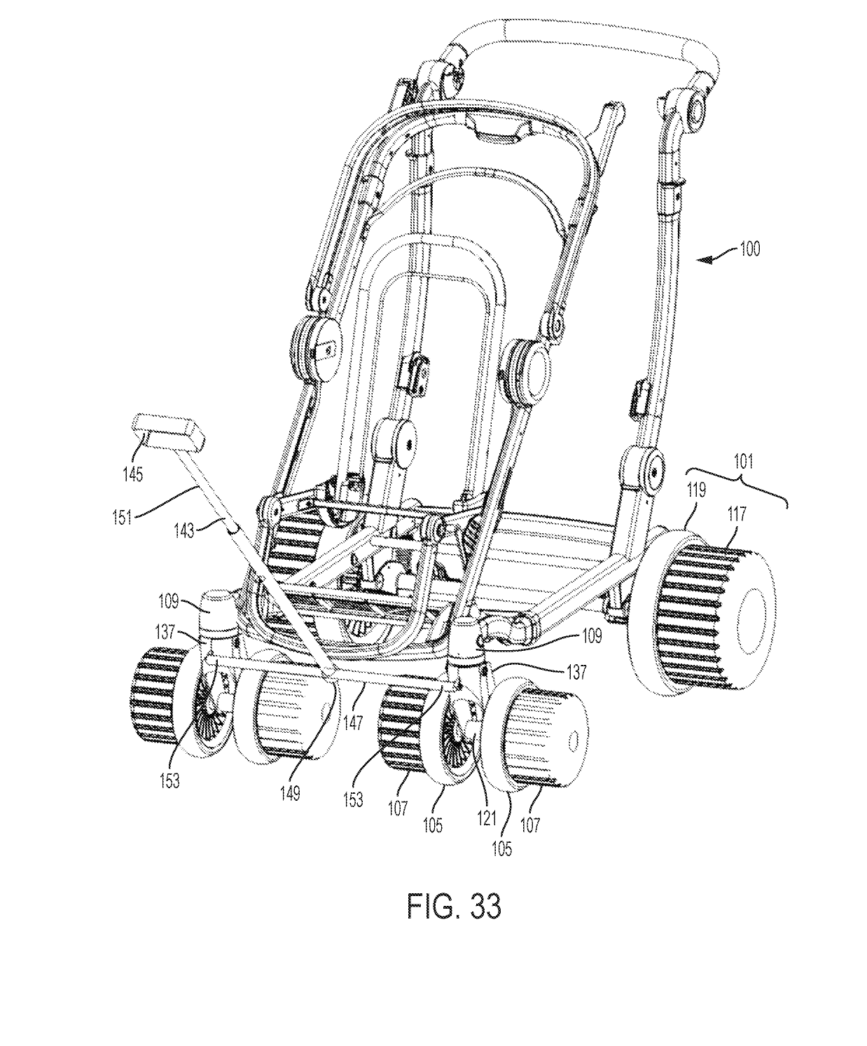

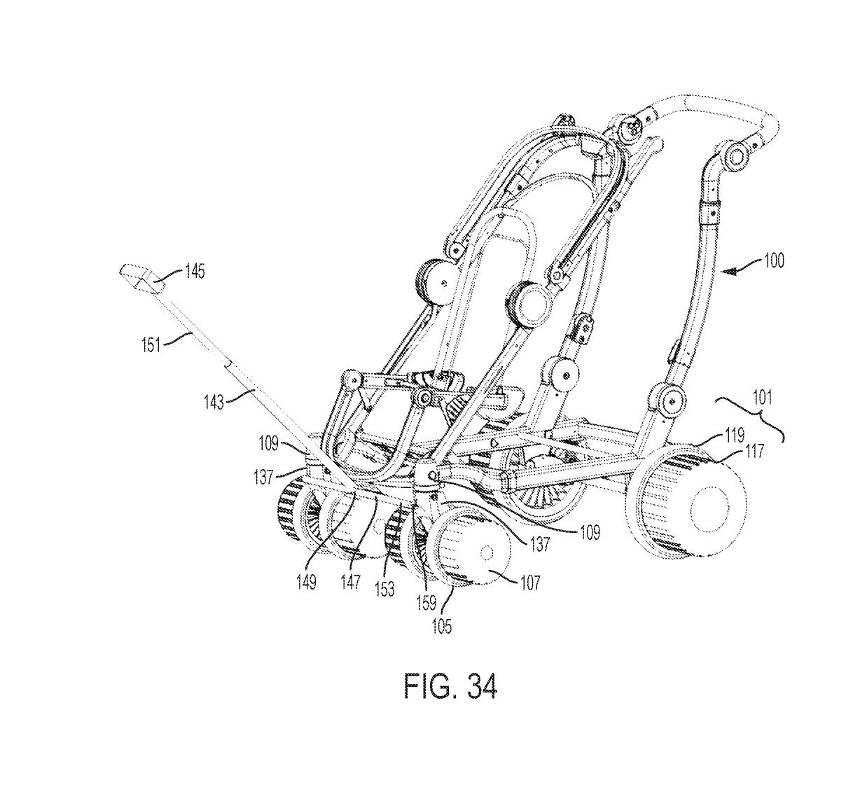

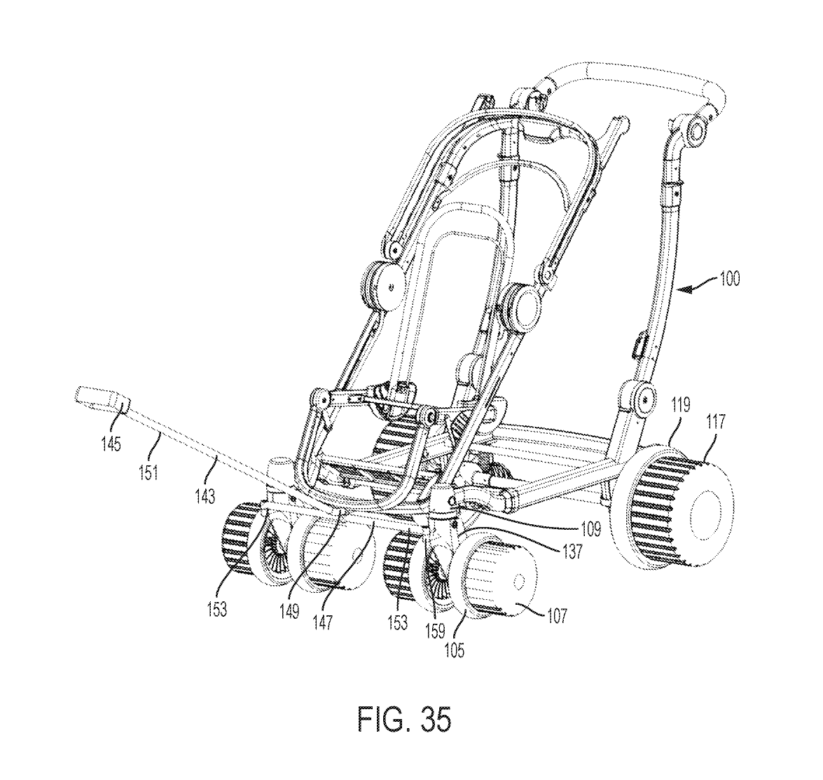

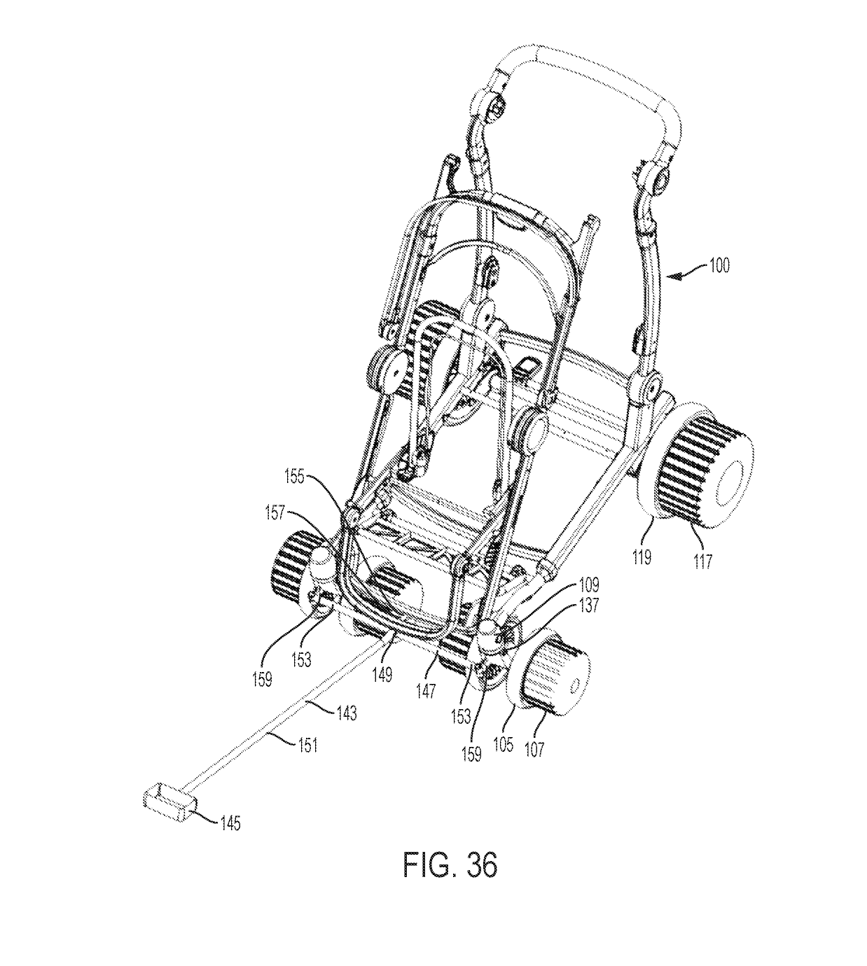

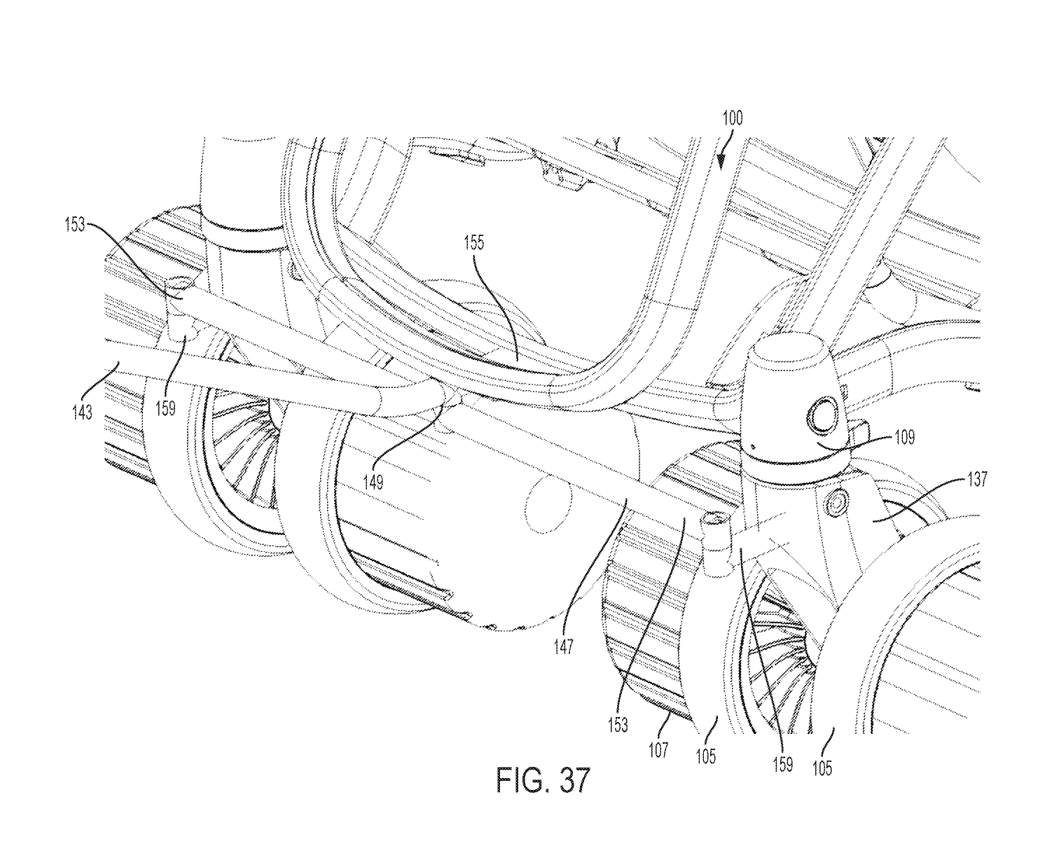

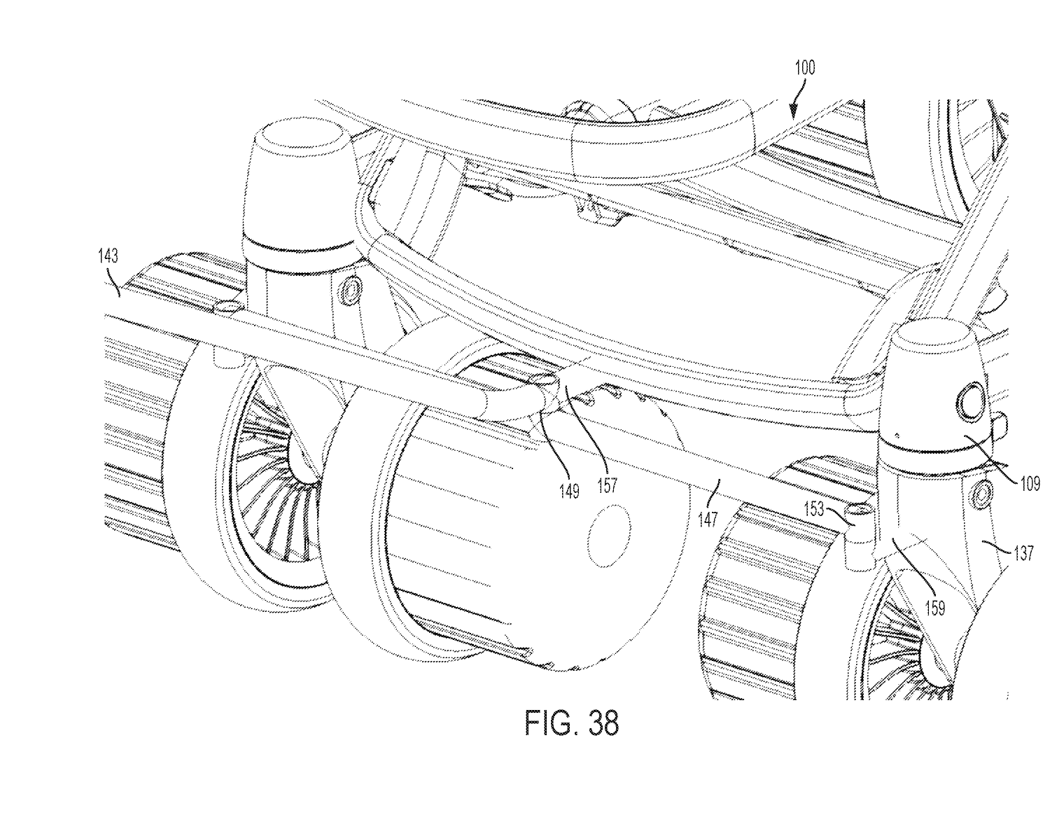

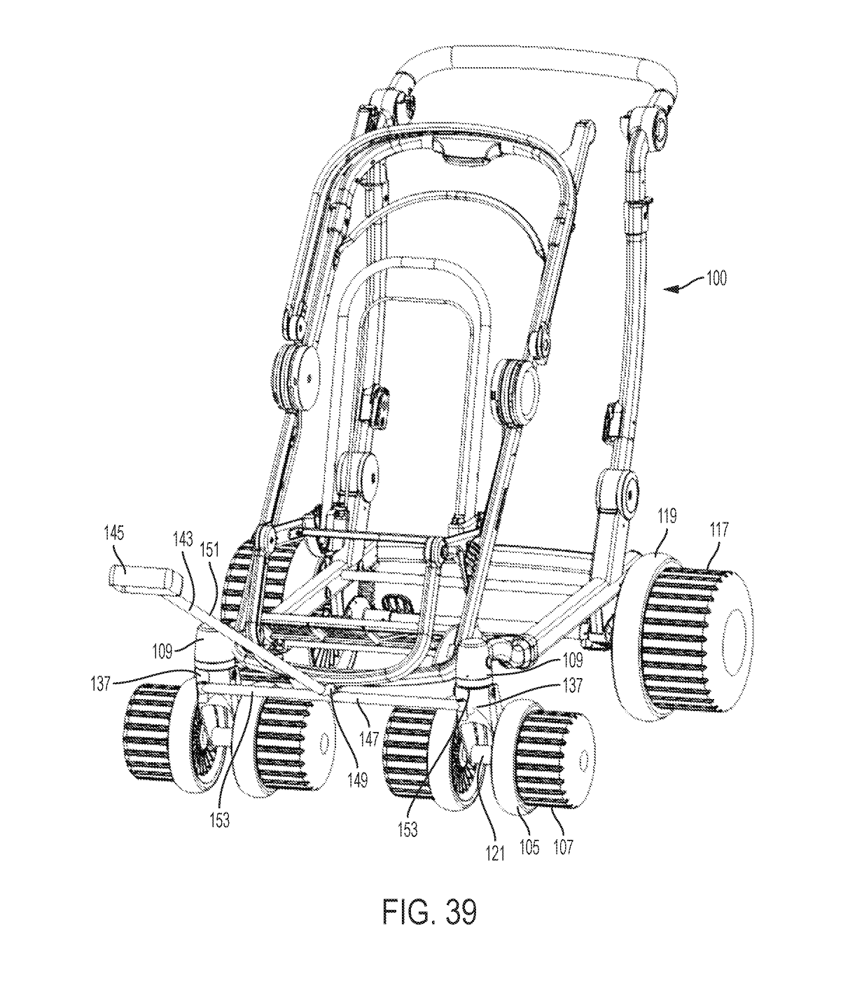

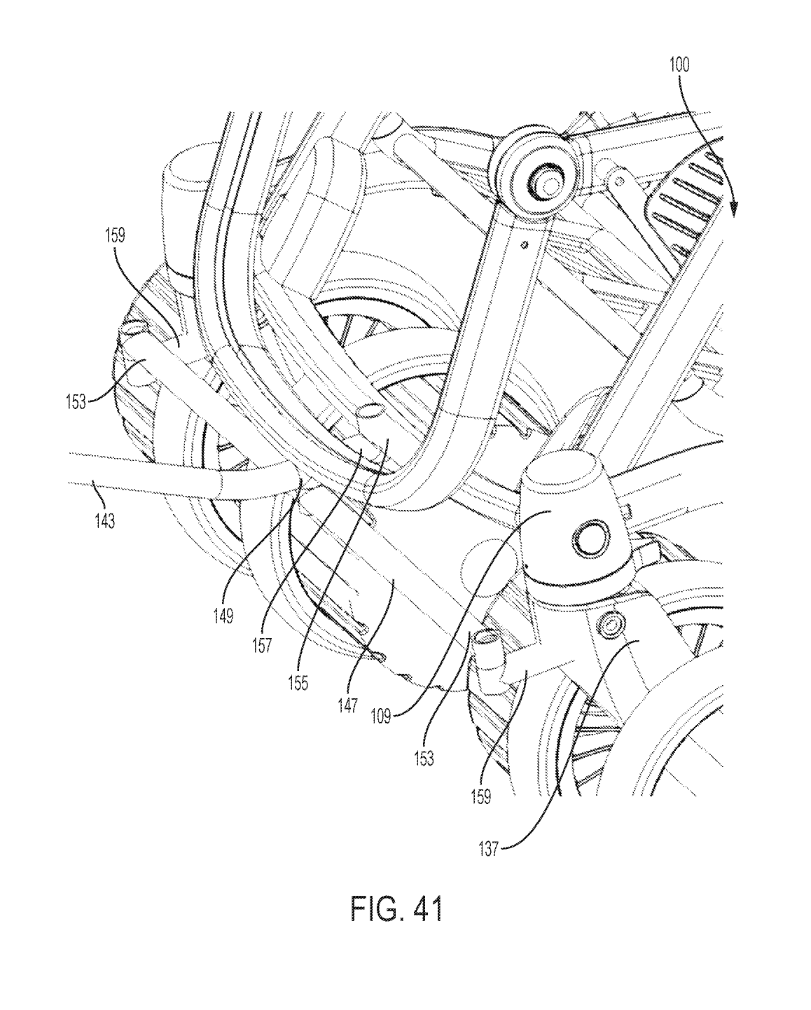

It should be understood that the wheel assemblies of the present disclosure can be used in connection with a stroller (for example as is described below with respect to FIGS. 1-41) or any other movable device, for example movable devices configured to use wheels.

Turning now to the figures, FIGS. 1-11 illustrate a stroller 100 with modular wheel assemblies, according to an exemplary embodiment. Illustrated in FIGS. 1-11 is a stroller 100 comprising a base 111, a front frame member 115, a rear frame member 113, two front wheel assemblies 103, located proximate to the front of the base 111, and two rear wheel assemblies 101, located proximate to the rear of the base. The stroller can be generally symmetric. The base 111 of the stroller may be expandable. One or both of the front frame member 115 and the rear frame member 113 may be configured to carry one or more passengers and/or goods.

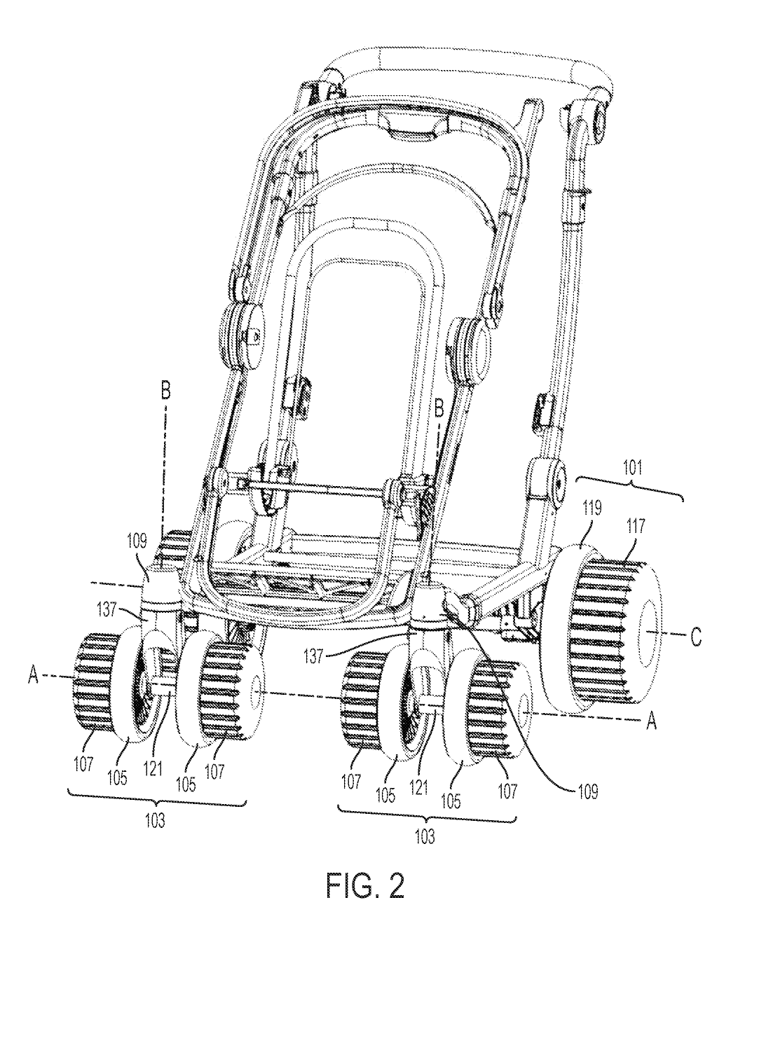

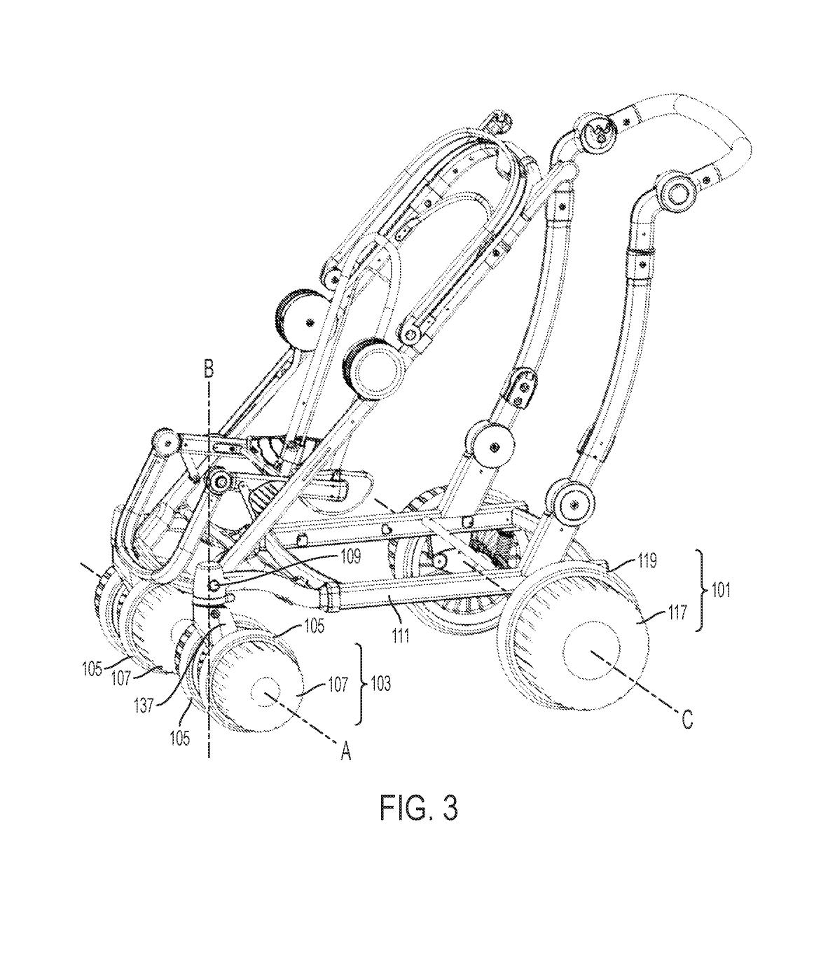

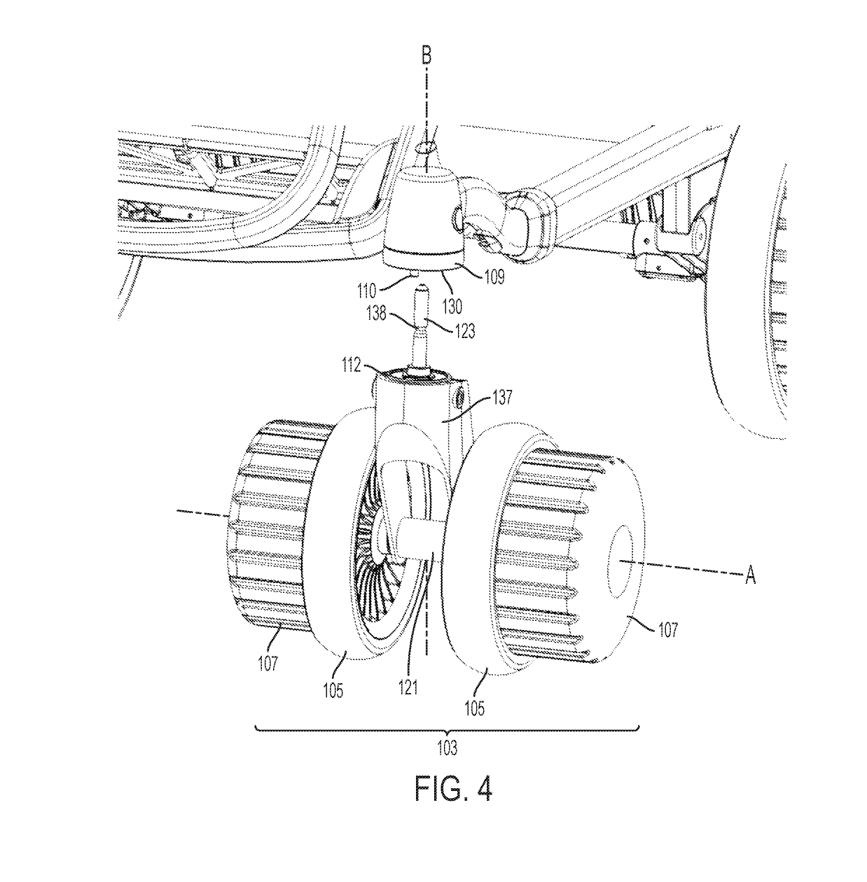

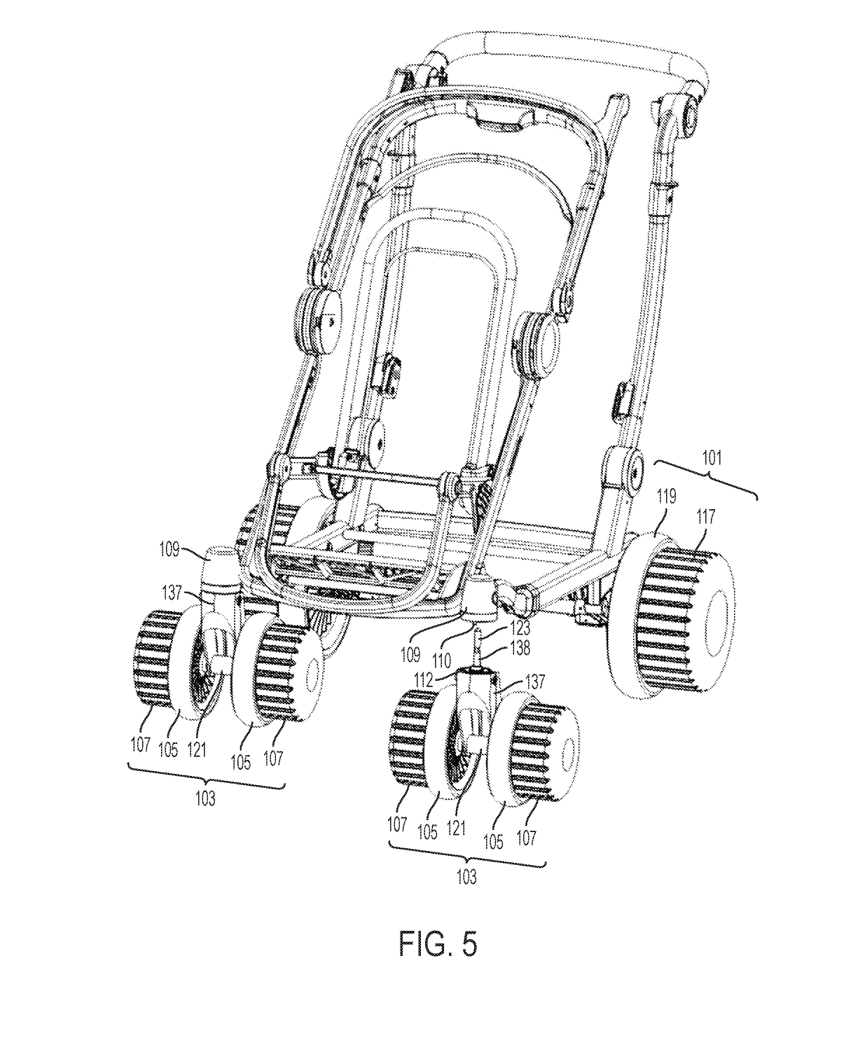

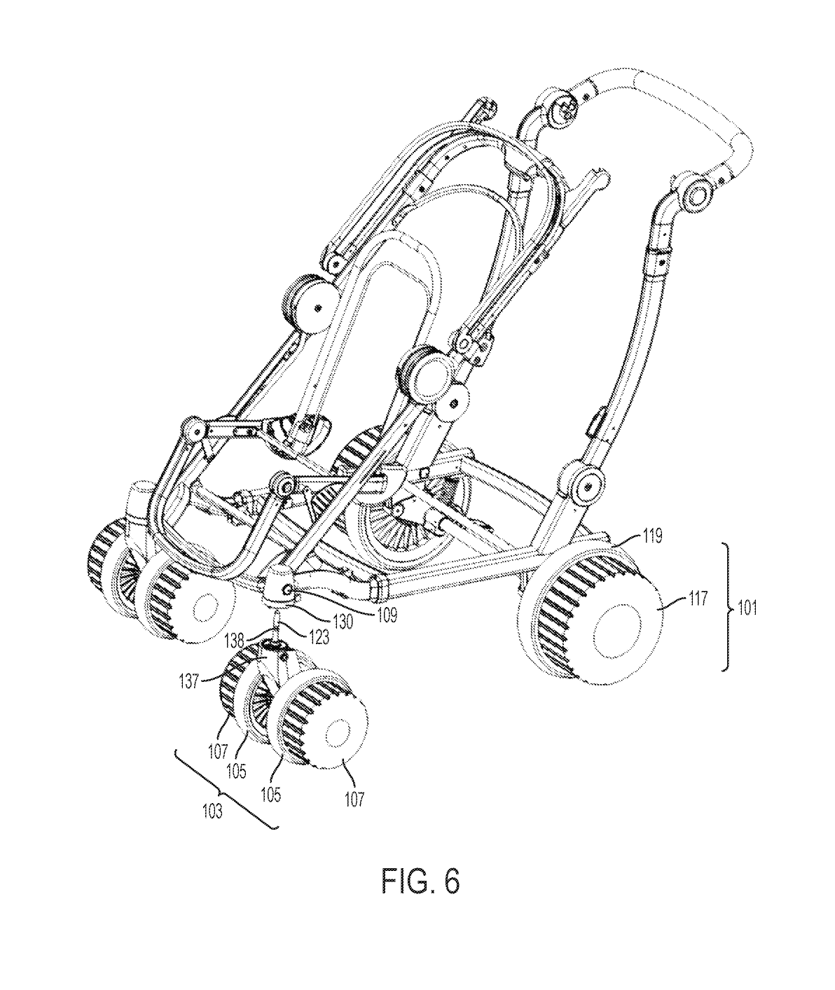

In the embodiment shown in FIGS. 1-11 each of the front wheel assemblies 103 comprises two modular wheels 107 and two standard wheels 105. In one embodiment, a wheel assembly according to the present disclosure can be detachably connected to the stroller 100. In another embodiment, a wheel assembly can be fixedly attached to the stroller 100. FIG. 1 illustrates a front side perspective view of a stroller 100 with modular wheel assembly. FIG. 2 illustrates a front perspective view of the stroller with modular wheel assembly. FIG. 3 illustrates a side perspective view of the stroller with modular wheel assembly. FIG. 4 illustrates a front perspective view of a front wheel assembly of the stroller. FIG. 5 illustrates a front perspective view of the stroller with modular wheel assembly, with the front wheel assembly detached. FIG. 6 illustrates a side perspective view of the stroller with modular wheel assembly, with the front wheel assembly detached.

As best illustrated in FIGS. 2-6, in one embodiment, front wheel assembly 103 comprises at least one standard wheel 105 that is rotatably attached to a front swivel axel 121. In this embodiment, the front wheel assembly 103 comprises two standard wheels 105. The standard wheels 105 of the front wheel assembly 103 rotate about an axis “A” via the swivel axel 121. The axis “A” is generally parallel to the supporting surface on which the stroller is configured to move (e.g., a floor). Front wheel assembly 103 further comprises at least one modular wheel 107. In this embodiment, the front wheel assembly 103 comprises two modular wheels 107. In one embodiment, each of the modular wheels 107 is concentrically mounted to each of the standard wheels 105, respectively, thus allowing the modular wheels 107 and the standard wheels 105 of the front wheel assembly 103 to rotate about the front swivel axel 121. In one embodiment, the modular wheel 107 is removably attached to the standard wheel 105. In another embodiment, the modular wheel is fixedly attached to the standard wheel 105. In one embodiment spokes or other features of the standard wheels 105 may engage with protrusions or other features of the modular wheels 107, such that the modular wheels 107 and standard wheels 105 are fixed relative to each other. Alternatively, the modular wheels 107 may be attached directly to an axle or hub, such that they are free to rotate about the swivel axis, preferably around the axis “A” independently of the standard wheels 105.

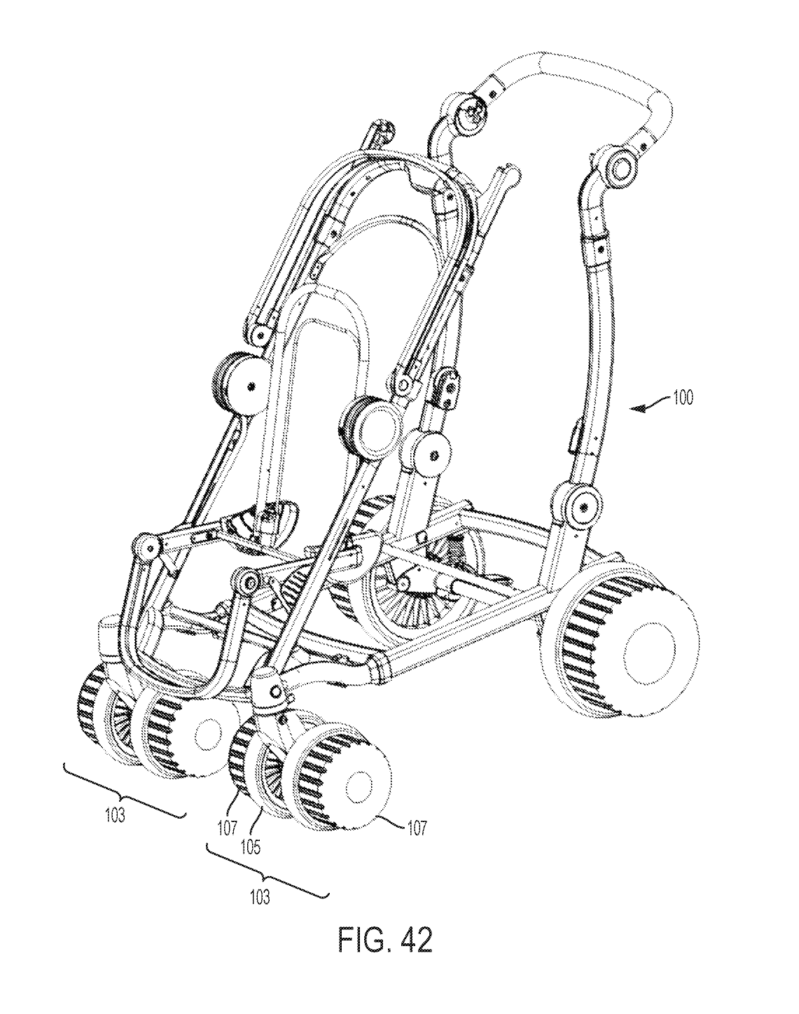

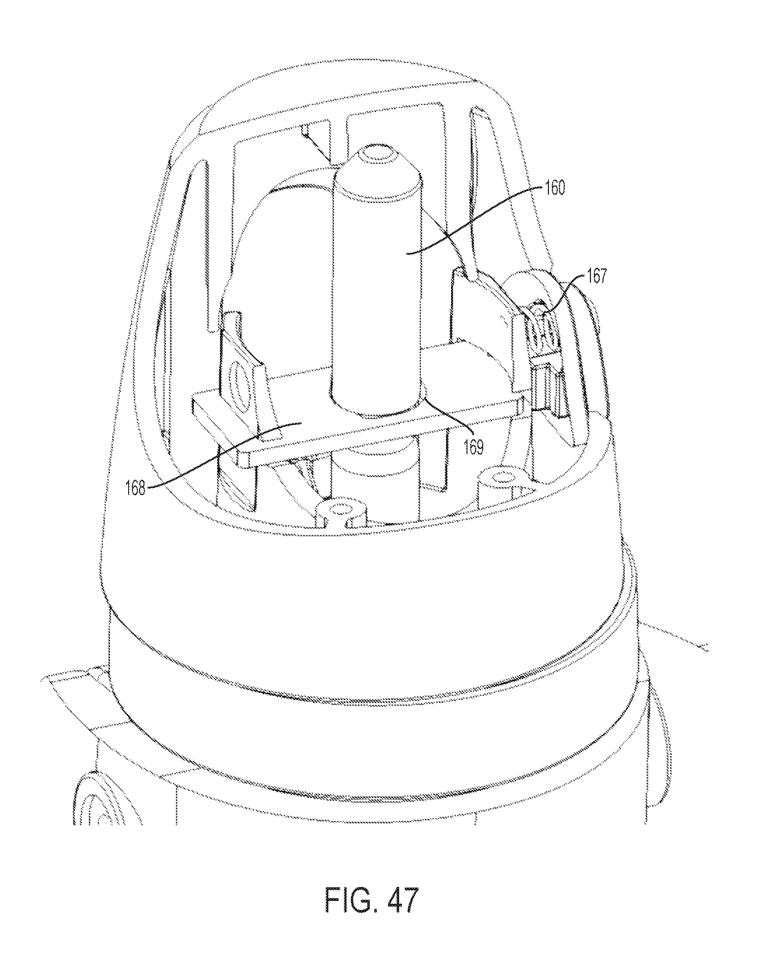

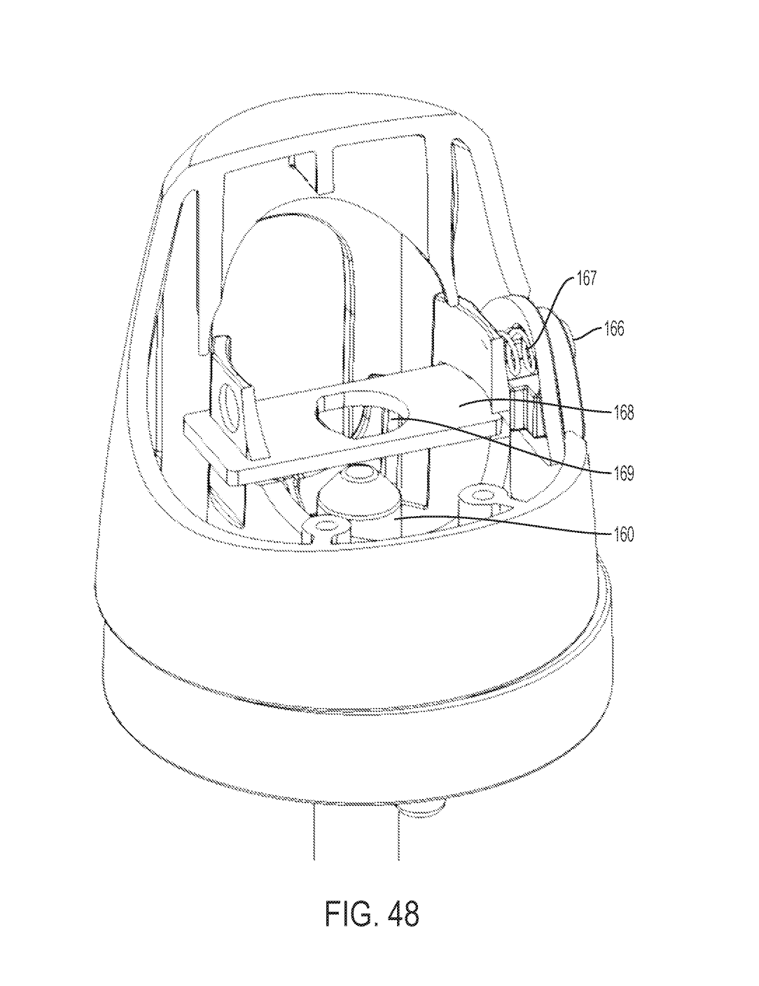

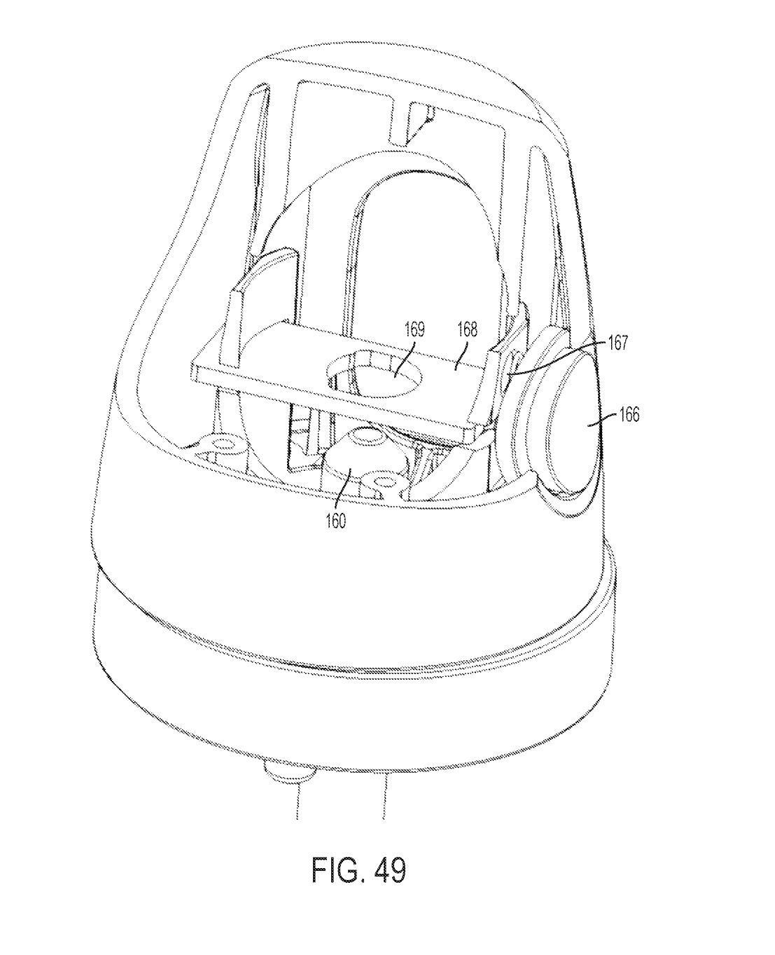

In one embodiment, the front wheel assembly 103 further comprises a hub structure having an upper hub 109 and lower hub 137. The hub structure is connected to the stroller 100, proximate to the front of the base 111. As shown in FIG. 4, the lower hub 137 comprises a bearing section 123 forming a “male” portion configured to engage with a “female” portion 130 of the upper hub 109. In one embodiment, the bearing section 123 comprises a notch 138 configured to engage with tabs (not shown) of the “female” portion 130 of the upper hub 109. When the tabs of “female” portion 130 of the upper hub 109 are engaged with the notch 138, movement between the upper hub 109 and the lower hub 137 along axis “B” may be prevented, i.e., the upper hub 109 and lower hub 137 are held in place. When viewed from the front, the lower hub 137 and upper hub 109 are generally symmetrical about the axis “B”, which is generally perpendicular to the supporting surface and, in some contemplated embodiments, axis “A”. The standard wheels 105 and the modular wheels 107 rotate in unison about the axis “B” in order to facilitate steering of stroller 100, i.e., in order to move forwards and backwards in multiple directions. In one embodiment, the tabs of the “female” portion 130 of upper hub 109 that prevents movement between the upper hub 109 and the lower hub 137 may be spring loaded, biased to hold the upper hub 109 and lower hub 137 in place, and actuated by a lever, button, or any other suitable device, including, for example, the button locking mechanism shown in FIGS. 42-51 and described herein with respect to those figures. Additionally, or alternatively, the upper 109 and lower hubs 137 could further comprise some other releasable locking mechanism.

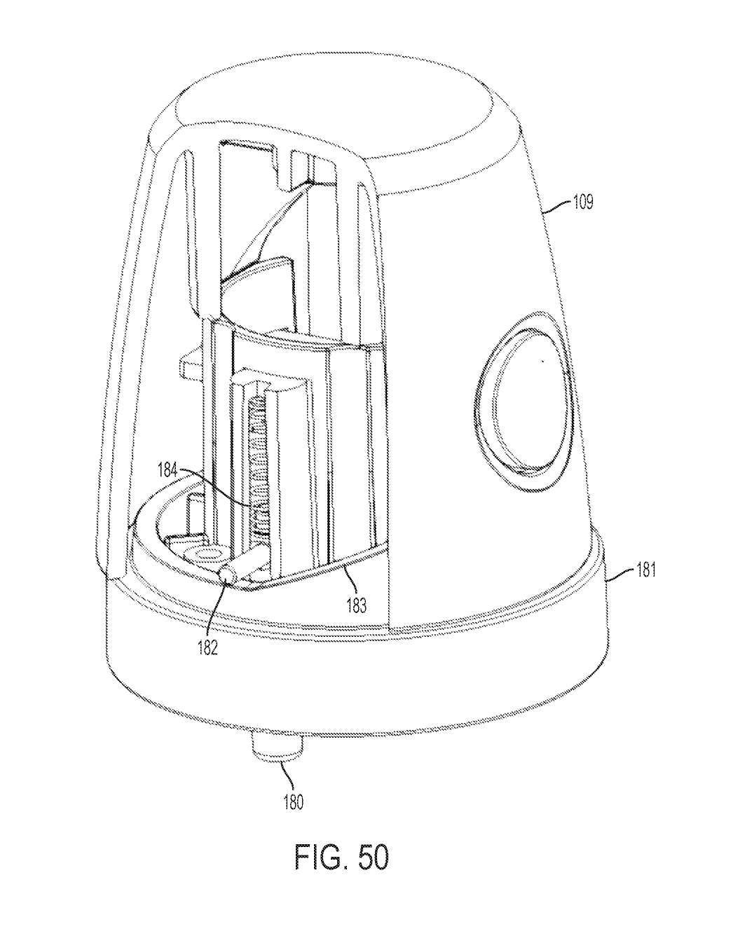

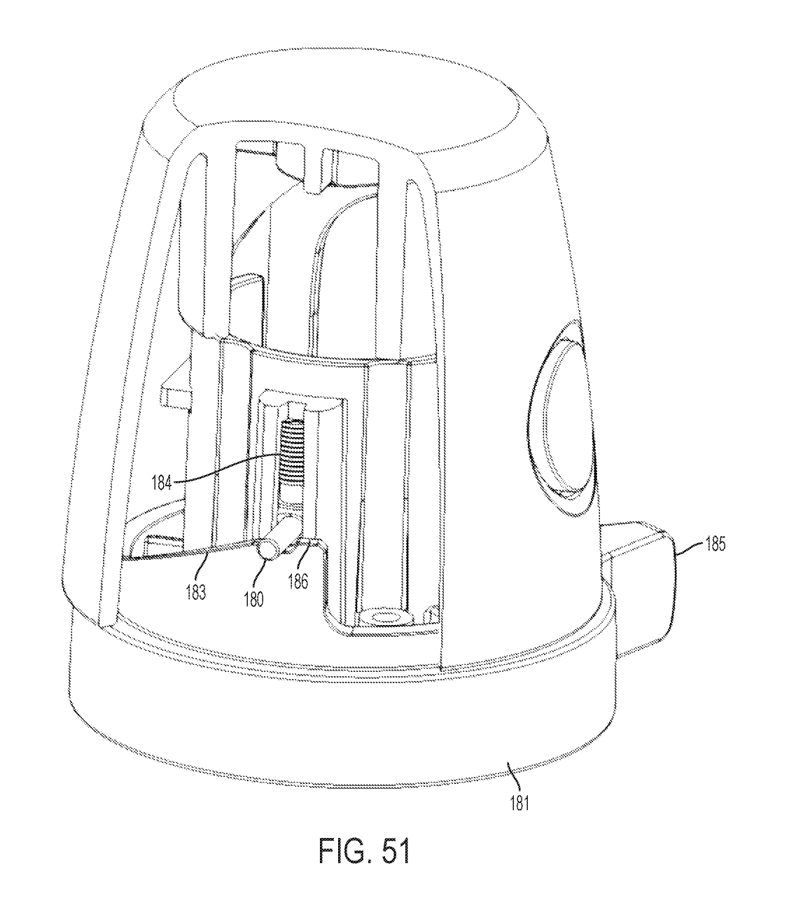

The upper hub 109 may also comprise one or more pins or other protruding members, such as a pin 110, configured to engage with one or more holes or other receiving structures located on the lower hub 137, including for example the pin mechanism shown in FIGS. 50-51 and described herein with respect to those figures. In one embodiment, the pin 110 may be configured to move downwards and selectively engage with a hole 112 on the lower hub 137. In such an embodiment, the pin 110 may provide a selective locking mechanism which prevents the lower hub 137 from swiveling or rotating with respect to the upper hub 109. For example, when the pin 110 is engaged with the hole 112 on the lower hub 137, the lower hub 137 (and the front wheel assembly 103) is prevented from rotating about the axis “B”. Engagement of the pin 110 with the hole 112 on the lower hub 137 may be mediated by one or more actuators connected to or located on or within the upper hub 109.

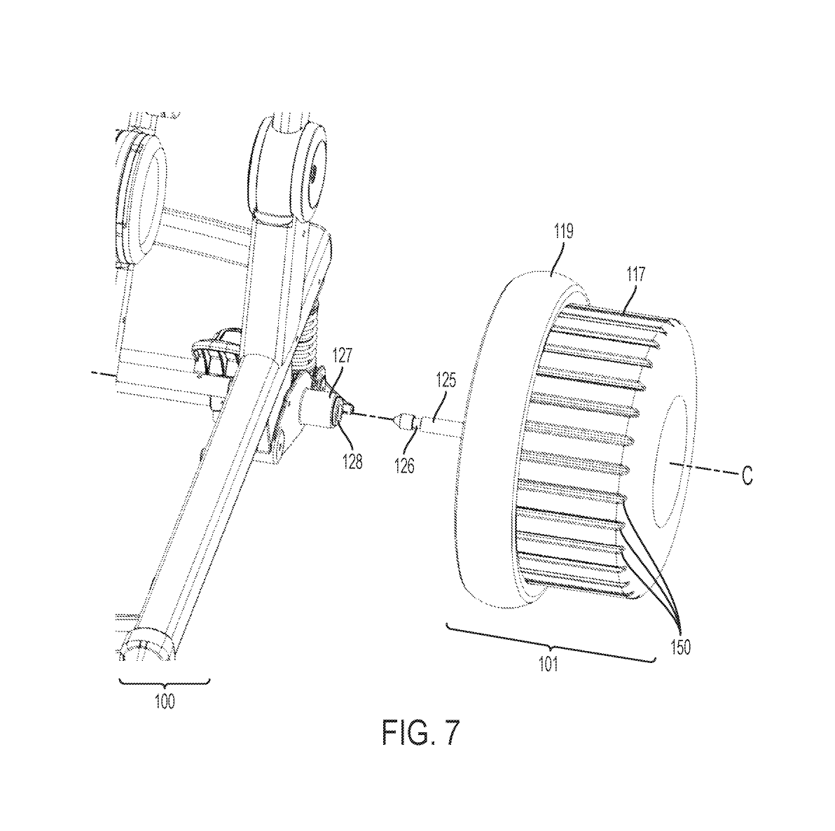

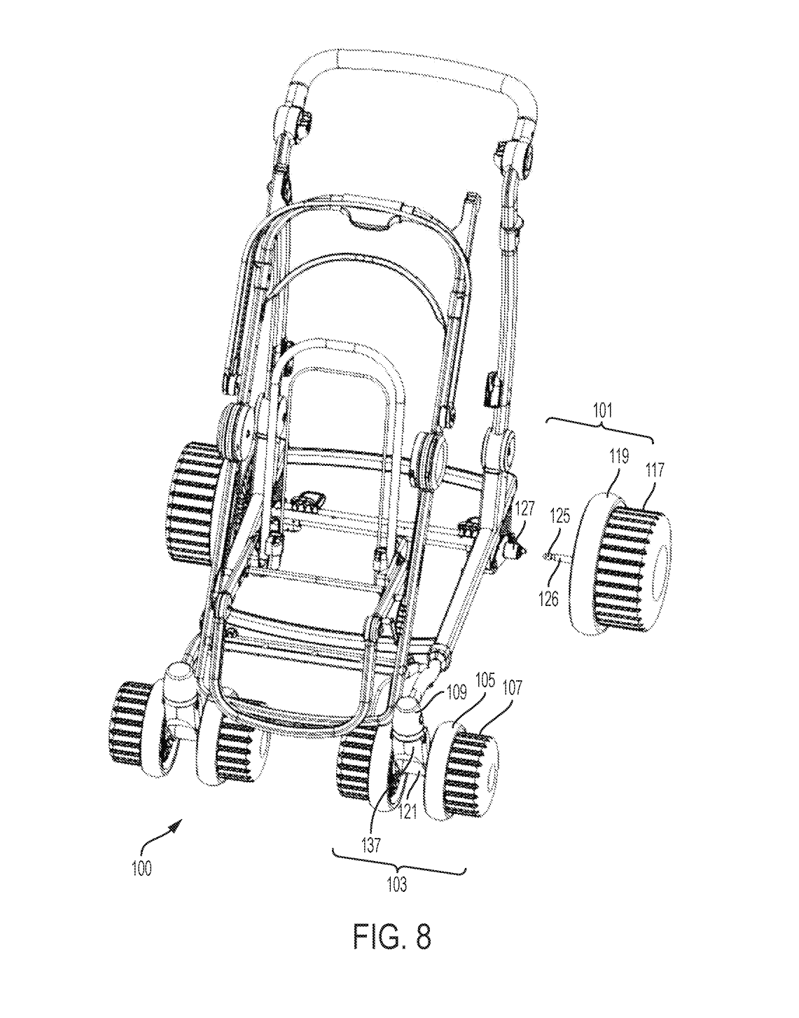

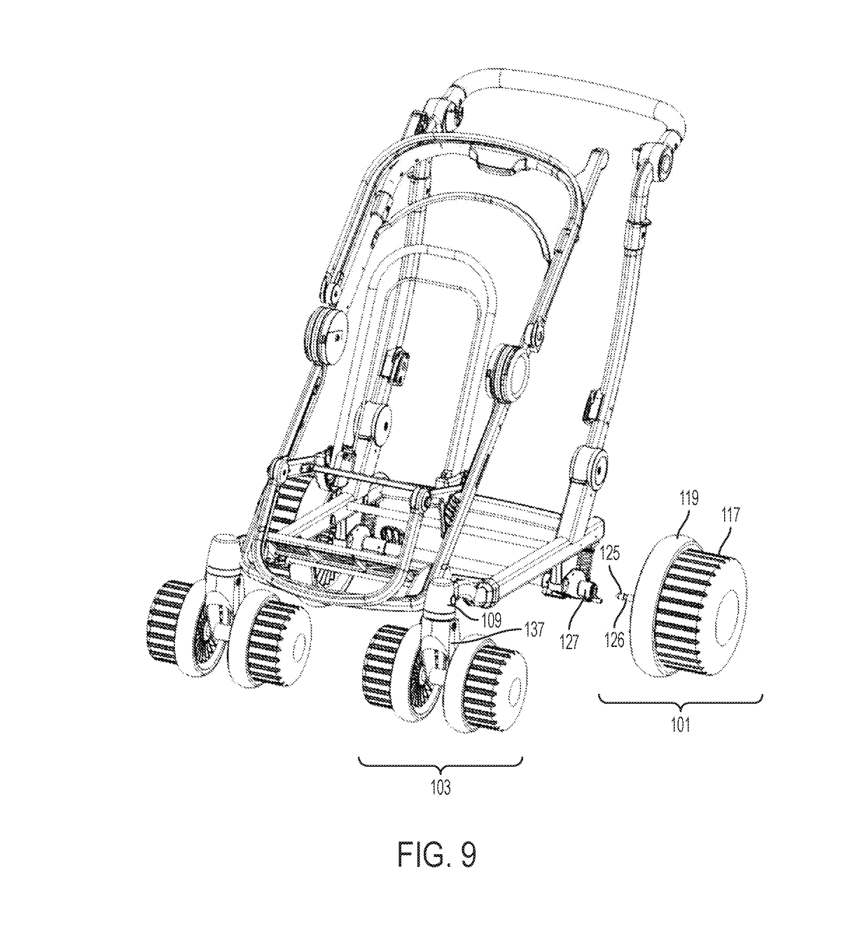

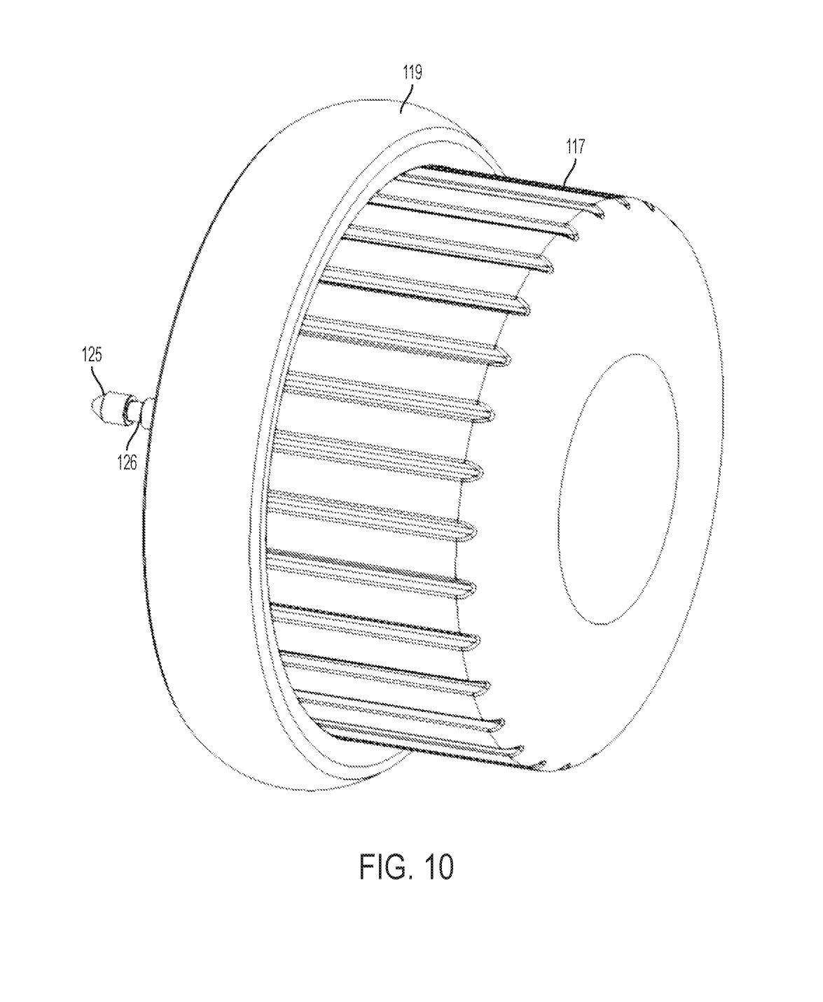

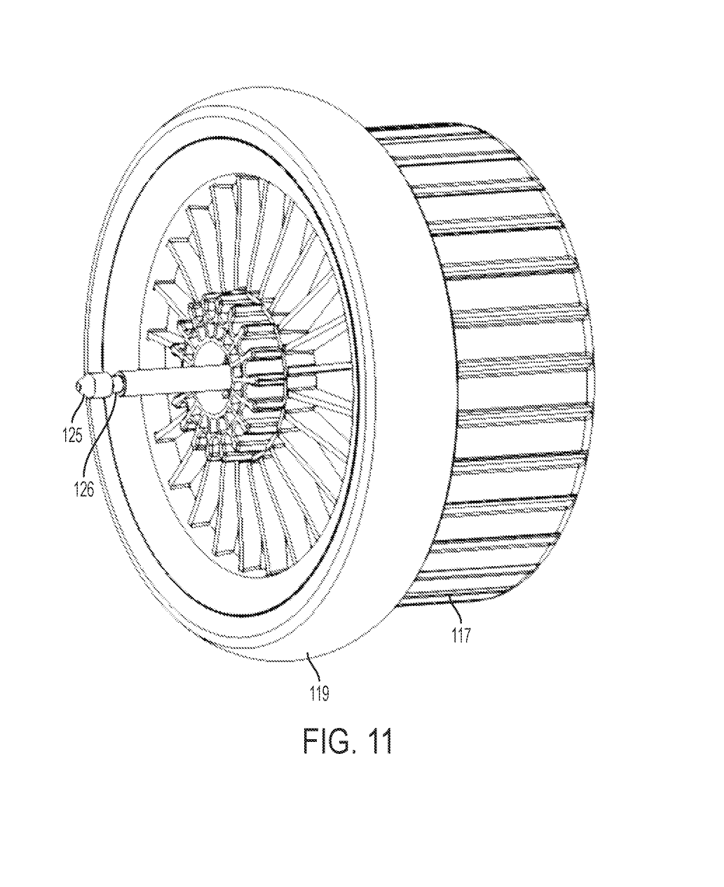

In one embodiment, stroller 100 comprises one or more rear wheel assemblies 101. The rear wheel assembly 101 is best illustrated in FIGS. 7-11. FIG. 7 illustrates a side perspective view of a portion of the stroller 100with modular wheel assembly, with a rear wheel assembly 101 shown detached from the stroller 100. FIG. 8 illustrates a front side perspective view of the stroller 100 with modular wheel assembly, with the rear wheel assembly 101 shown detached from the stroller 100. FIG. 9 illustrates a side perspective view of the stroller with modular wheel assembly, with the rear wheel assembly detached. FIG. 10 illustrates a side perspective view of the rear wheel assembly, from the exterior of the stroller. FIG. 11 illustrates a side perspective view of the rear wheel assembly, from the interior of the stroller.

As illustrated in FIGS. 7-11, the rear wheel assembly 101 comprises a rear modular wheel 117 attached to a standard wheel 119. In one embodiment, the rear modular wheel 117 can be removably attached to the standard wheel 119. In another embodiment, the rear modular wheel 117 can be fixedly attached to the standard wheel 119. In one embodiment, the standard wheel 119 comprises a bearing section 125 forming a “male” portion configured to engage with a “female” portion 128 located on a hub 127 on the frame of the stroller 100, proximate to the rear of the stroller base. The bearing section 125 comprises a notch 126 configured to be engaged by one or more tabs (not shown) on the “female” portion 128 of the hub 127. When the notch 126 is engaged by the one or more tabs of the “female” portion 128, the rear wheel assembly 101 is securely attached to the frame of the stroller, such that the rear wheel assembly 101 is unable to move along the axis “C” defined by the central axis of the rear standard wheel 119 and the rear modular wheel 117. In this embodiment, the axis “C” is generally parallel to the supporting surface (e.g., the floor). When the rear wheel assembly 101 is engaged with the hub 127, the rear standard wheel 119 and the rear modular wheel 117 are both free to rotate together about the axis

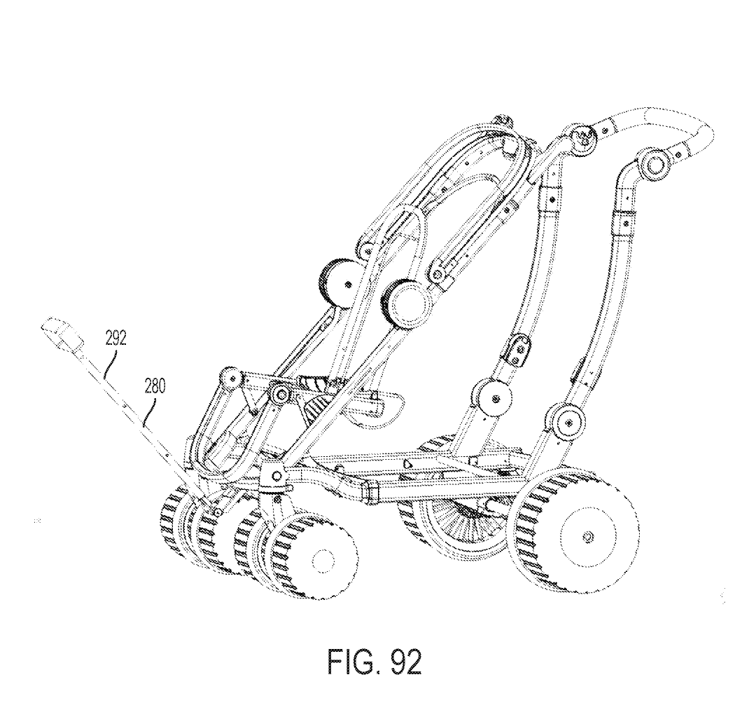

In one embodiment, the rear modular wheels 117 and the front modular wheels 107 have diameters greater than their respective rear standard wheels 119 and front standard wheels 105. In this embodiment, the standard wheels 119,105 would not make contact with a level, rigid, supporting surface (e.g., wood, concrete) when the modular wheels 117, 107 are attached. In another embodiment, and as depicted in the FIGS. 1-92, the rear modular wheels 117 and the front modular wheels 107 have diameters smaller than their respective rear standard wheels 119 and the front standard wheels 105. In this embodiment, the stroller 100 may be configured for use on both a rigid supporting surface and a non-rigid, supporting surface that is softer than materials like concrete, asphalt, wood, etc., such as sand, gravel, and the like. For example, the standard wheels 119,105 may be configured support the stroller 100 entirely on a rigid supporting surface, while the standard wheels 119, 105 may sink into a non-rigid supporting surface, e.g., sand, causing difficulty in movement of the wheel assemblies 101, 103 and/or stroller 100. The modular wheels 117, 107 improve movement of the wheel assemblies 101, 103 and/or stroller 100 by increasing the wheel surface area that makes contact with the non-rigid supporting surface. In such an embodiment, the modular wheels 117, 107 increase the supporting surface area of the stroller, and are thus able to facilitate the stroller 100 travelling by rolling along a non-rigid supporting surface. Each of the modular wheels 117, 107 may be of greater surface area than each of the standard wheels 119, 105 to which they attach, thereby preventing the stroller 100 from sinking into any non-rigid, granular or semi-fluid supporting surface. In this embodiment, the stroller 100 may also be configured for use on a rigid supporting surface. For example, on a rigid supporting surface, only the standard wheels 119, 105 which have diameters greater than the modular wheels 117, 107, make contact with the rigid supporting surface. Examples of a rigid supporting surface include asphalt, concrete, wood, tile, and the like.

In one embodiment, standard wheels 119, 105 can have a radius that is about 5 mm to about 25 mm greater than the radius of the modular wheels 117, 107, preferably about 10 mm to about 15 mm greater, and more preferably about 12.5 mm greater. This can allow for optimal performance of the standard wheels and/or tire on hard supporting surfaces and can help reduce the likelihood of the modular wheels touching the ground on hard supporting surfaces, for example to avoid the modular wheels contacting small rocks or pebble, e.g., from winter gravely spreading etc. This can also allow for some compression of the standard wheels on hard supporting surfaces (e.g., roads, sidewalks, wood floors etc.) while avoiding the modular wheels touching the supporting surface. This also allows for easier pushing or pulling of the stroller through soft, easily movable surfaces (e.g., sand, soft terrain) because the standard wheels may not dig into the soft surface as much as compared to having a large difference in radius between the standard wheels and the modular wheels, which can limit the modular wheels' contribution to the support weight and ride about the soft surface.

One or more of the modular wheels 117, 107 and one or more of the standard wheels 119, 105, may be comprised of one or more materials such as plastic, rubber, air, synthetics, and the like, and any other material suitable for wheels. In one embodiment, the modular wheels 117, 107 and/or standard wheels 119, 105 may comprise rubber air-filled wheels. In another embodiment, the modular wheels 117, 107 and/or standard wheels 119, 105 may comprise rigid, semi-rigid, and/or flexible materials such that the modular wheels 117, 107 and/or standard wheels 119, 105 generally maintain their shape when rotated along a non-rigid supporting surface. One or more of the modular wheels 117, 107 and the standard wheels 119, 105 may be hollow and gas-filled (e.g., rubber tires filled with air) or solid (e.g., plastic). Additionally, one or more of the modular wheels 117, 107 and the standard wheels 119, 105, may have a tread pattern appropriate for the supporting surface. In one embodiment, one or more modular wheels 117, 107 may have a tread pattern that is different than a tread pattern of one or more standard wheels 119, 105. For example, the modular wheels 117, 107 may have a higher tread configured for optimal use on a non-rigid supporting surface, while the standard wheels 119, 105, may have a different tread pattern than the modular wheels 117, 107, configured for optimal use on a rigid supporting surface. In one embodiment, tread for the modular wheels can be deeper than the standard wheels, to provide structural support for the modular wheels and to improve wheel rotation in non-rigid supporting surfaces (e.g., sand), and to prevent the wheels from sliding in the non-rigid supporting surface. In one embodiment, as shown in FIG. 7, the one or more modular wheels 117 have a tread pattern comprising raised parallel portions evenly spaced around the circumference of the modular wheel. In one embodiment, the modular wheels can have a paddle wheel design (i.e., rib design from left to right), which can provide a broad surface to grip the non-rigid supporting surface (e.g., sand) and to turn the wheels. In one embodiment, as illustrated in FIGS. 8-9, the rear wheel assembly 101 may have a diameter greater than the diameter of the front wheel assembly 103, for example, the rear standard wheels 119 and/or rear modular wheels 117 may have diameters greater than the diameters of the front standard wheels 105 and/or the front modular wheels 107, respectively.

In one embodiment the modular wheels may be fixedly attached to the standard wheels. In such an embodiment, users of the stroller 100 may switch between modular wheel assemblies and standard wheel assemblies by removing the respective hub assemblies. For example, the rear wheel assembly 101 can be removed from the stroller 100 by disengaging the bearing section 125 forming a “male” portion from the “female” portion 128 located on a hub 127 (shown in FIG. 7) and the front wheel assembly 103 can be removed from the stroller by disengaging the bearing section 123 forming a “male” portion from the “female” portion 130 of the upper hub 109 (shown in FIG. 4). Once disengaged, the rear wheel assembly 101 and/or the front wheel assembly 103 can be replaced with another wheel assembly, for example another rear wheel assembly, front wheel assembly, modular wheels and/or standard wheels.

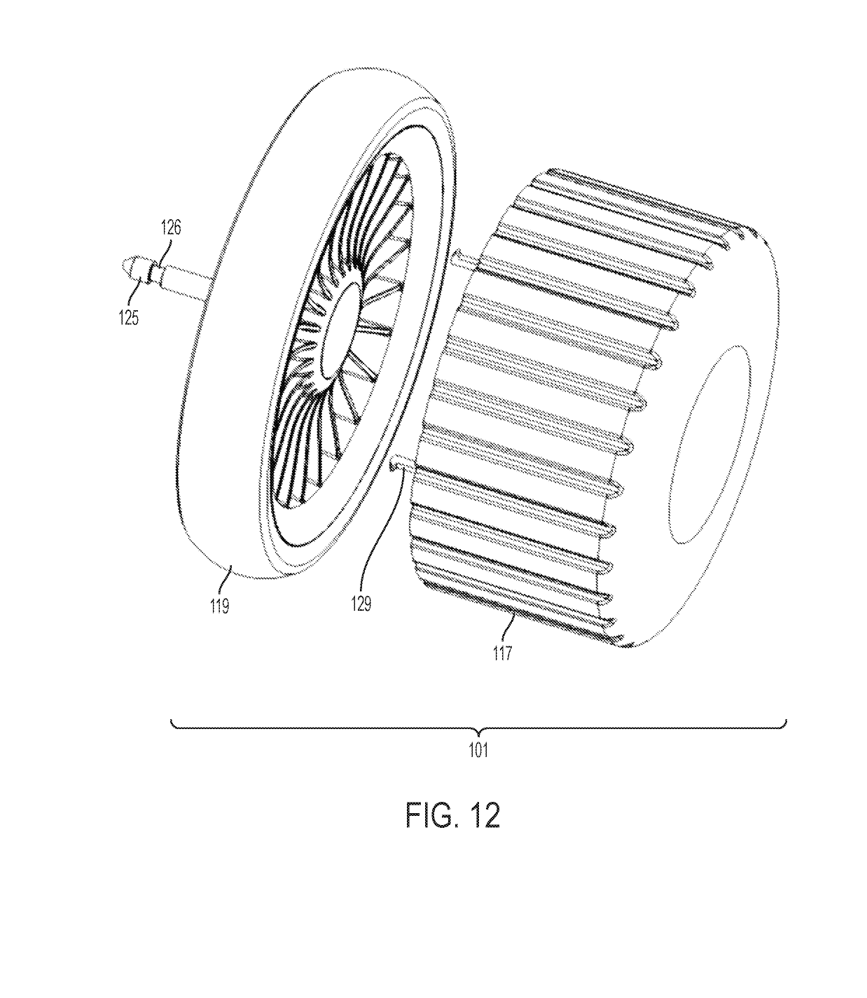

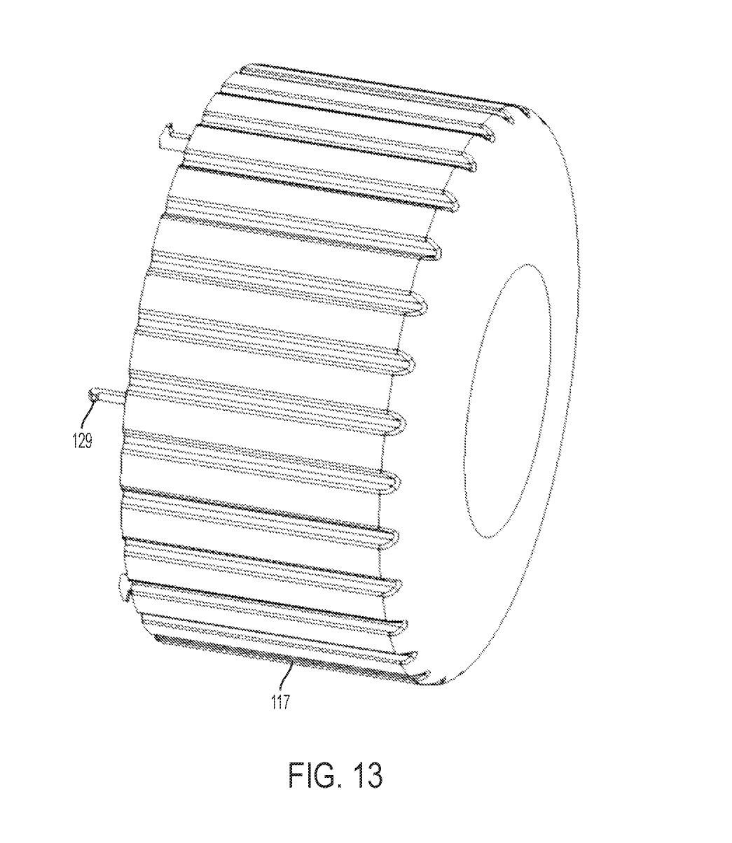

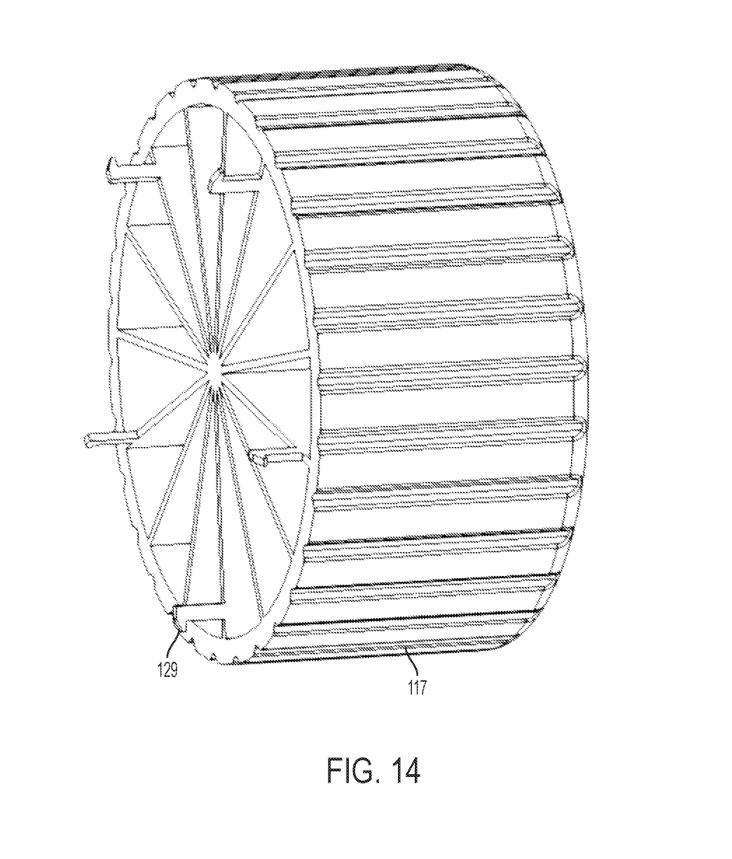

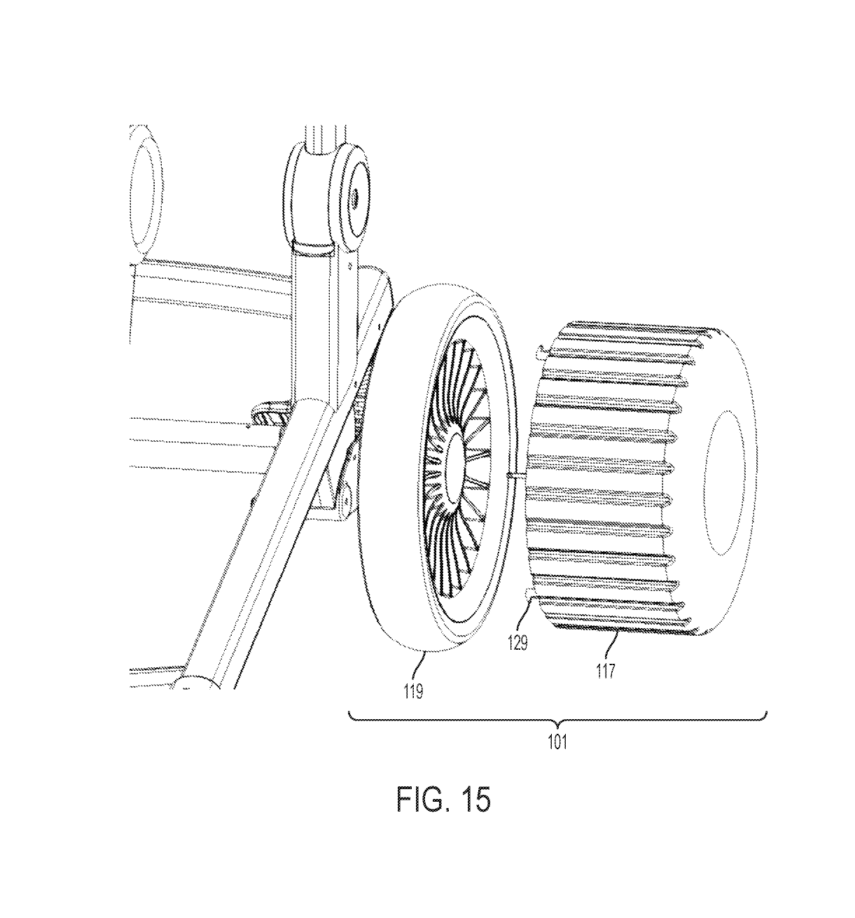

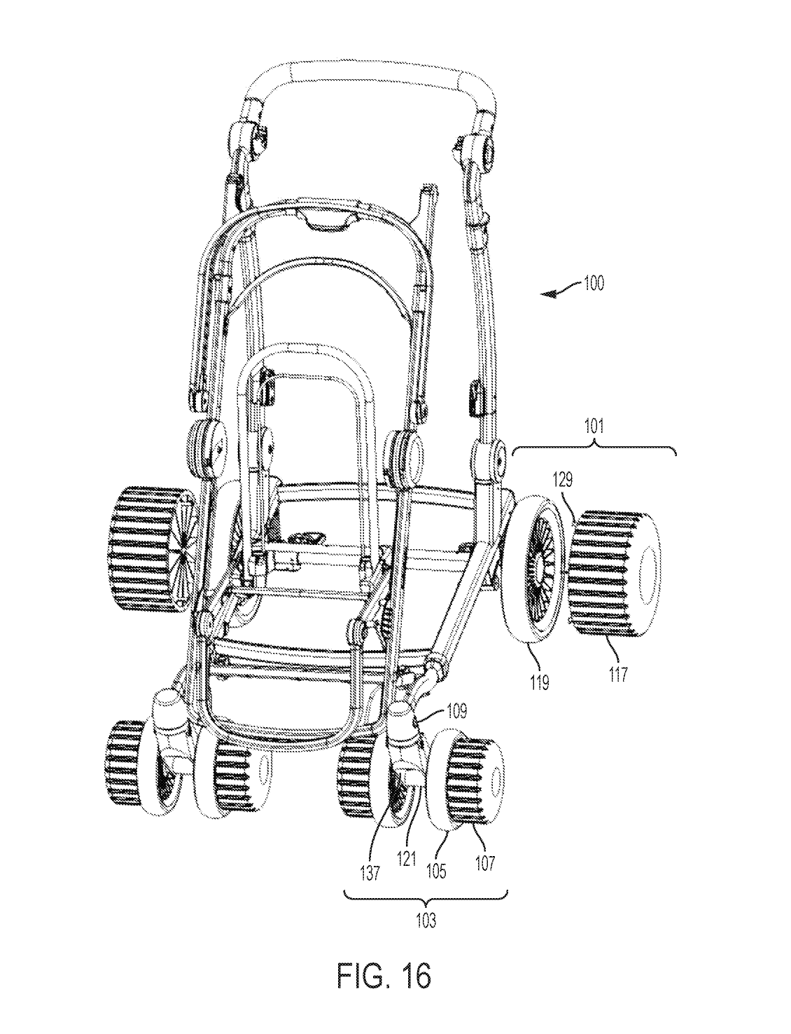

In another embodiment, the modular wheels may be removably attached to the standard wheels. The modular wheels may be removably attached via any suitable mechanism, for example with screws and/or nuts and bolts. In one embodiment, depicted in FIGS. 12-19, modular wheels may be removably attached to the standard wheels via a snap-on wheel assembly mechanism, wherein the modular wheels are attached to the standard wheels via a snap-on fit. Although the below descriptions of FIGS. 12-16 relate to a rear wheel assembly, it is understood that, in one embodiment, the descriptions may equally apply to a front wheel assembly. FIG. 12 illustrates a front perspective view of a rear wheel assembly 101 with a snap-on mechanism. FIG. 13 illustrates a front perspective view of the rear modular wheel 117 of the rear wheel assembly 101 with a snap-on mechanism (e.g., shown in FIG. 16), for example viewing the rear modular wheel 117 from the exterior of the stroller 100 (shown in FIG. 16). FIG. 14 illustrates a front perspective view of the rear modular wheel 117 of the rear wheel assembly 101 with a snap-on mechanism (e.g., shown in FIG. 16), for example viewing the rear modular wheel 117 from the interior of the stroller 100 (shown in FIG. 16). FIG. 15 illustrates a front perspective view of the rear wheel assembly 101 with a snap-on mechanism, with the rear modular wheel 117 shown detached. FIG. 16 illustrates a front perspective view of the stroller 100 with the front modular wheel assembly 103 and the rear wheel assembly 101 with a snap-on fit mechanism, with the rear modular wheel 117 shown detached. As depicted in FIGS. 12-16, in a rear wheel assembly 101, one or more snaps 129 may be located along an interior surface of the rear modular wheel 117 and configured to engage with one or more grooves (not shown) located along the rear standard wheel 119 at locations corresponding to the one or more snaps 129. In one embodiment, a user aligns the one or more snaps 129 of the rear modular wheel 117 with the grooves of the rear standard wheel 119. The one or more snaps 129 are compressed and inserted into the one or more grooves. Once inside the grooves, the one or more snaps are biased to expand within the one or more grooves in order to securely attach the rear modular wheel 117to the standard wheel rear 119. The one or more snaps 129 can comprise semi-flexible material suitable for compression and insertion into the one or more grooves as described above. Accordingly, portions of the one or more snaps 129 may be compressed in order to remove the rear modular wheel 117 from the rear standard wheel 119.

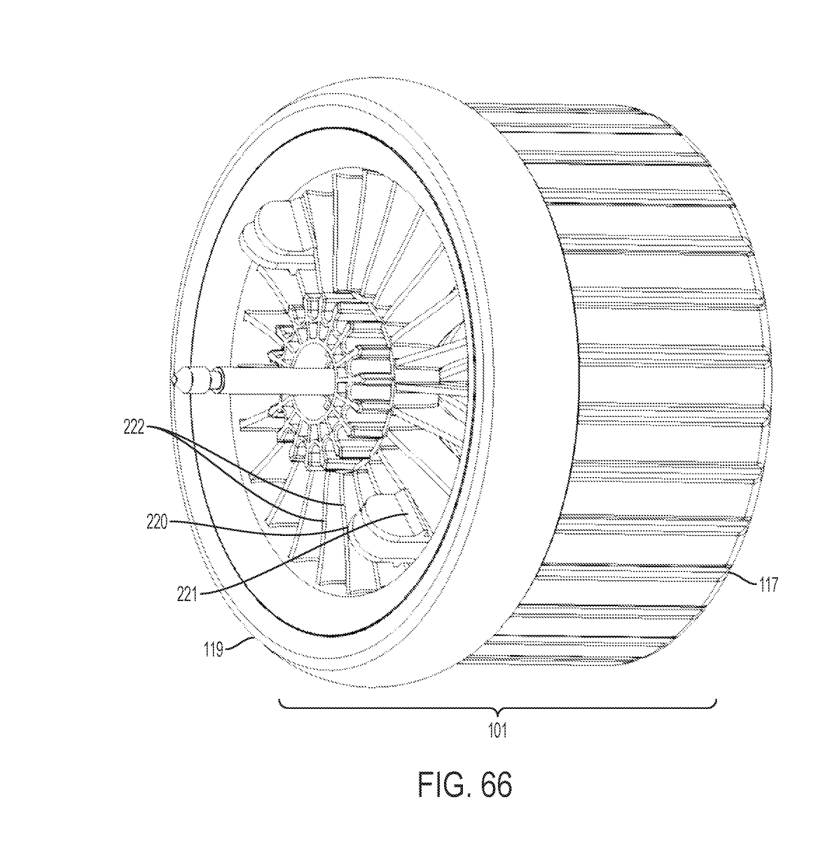

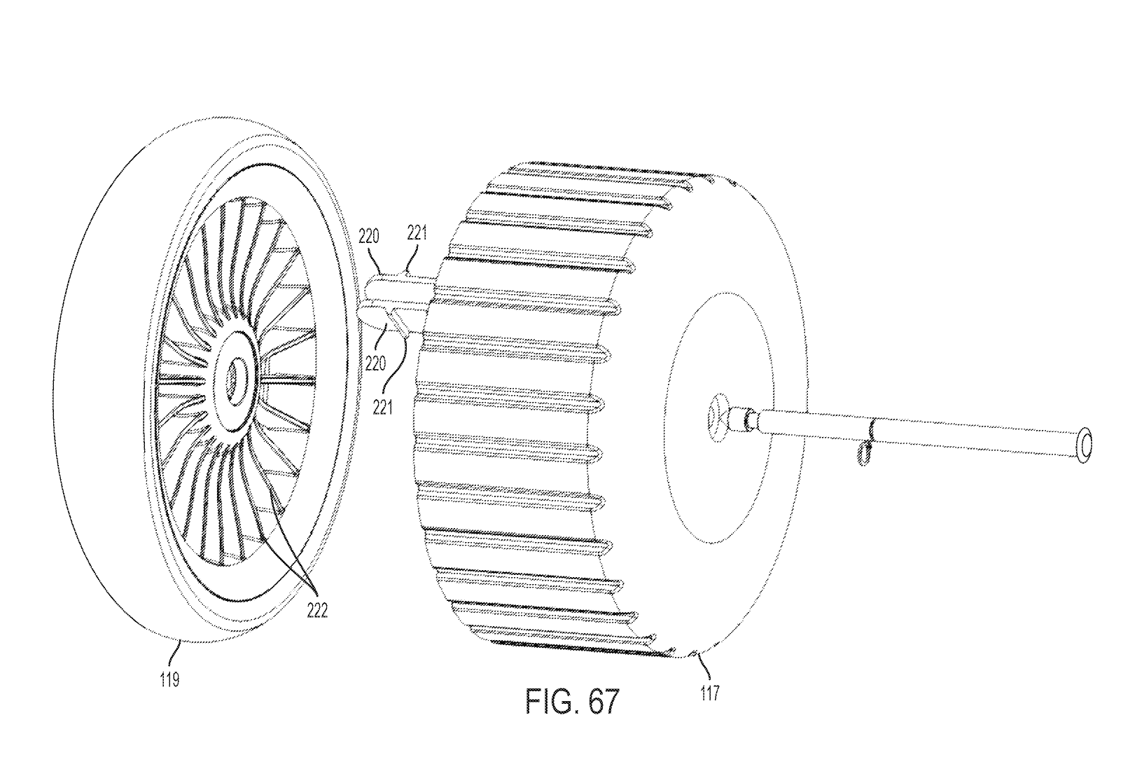

In an alternative embodiment, the rear modular wheel 117 may be irremovably or fixedly attached to the rear standard wheel 119, such that once the protruding one or more snaps 129 engage with the one or more grooves, the rear modular wheel 117is not removable from the standard wheel 119. The above-described snap-on mechanism can be used to removably or fixedly attach the front modular wheel 107 to the front standard wheel 105 (shown in FIG. 16 and also as illustrated in FIGS. 66-67).

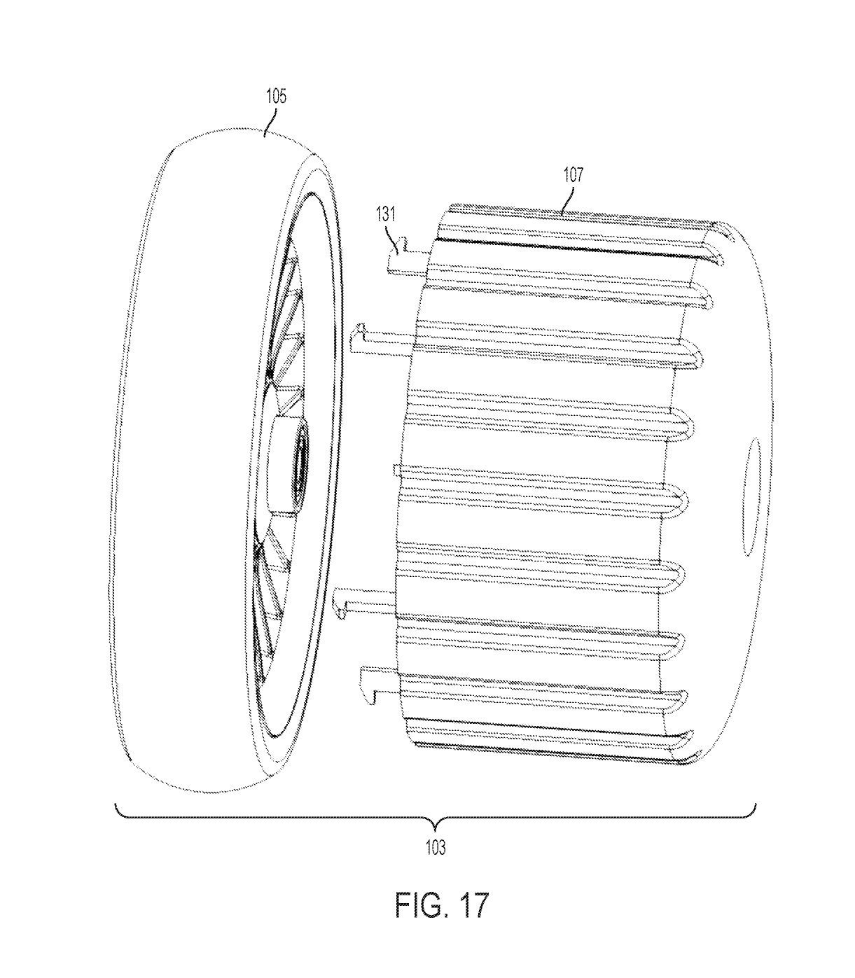

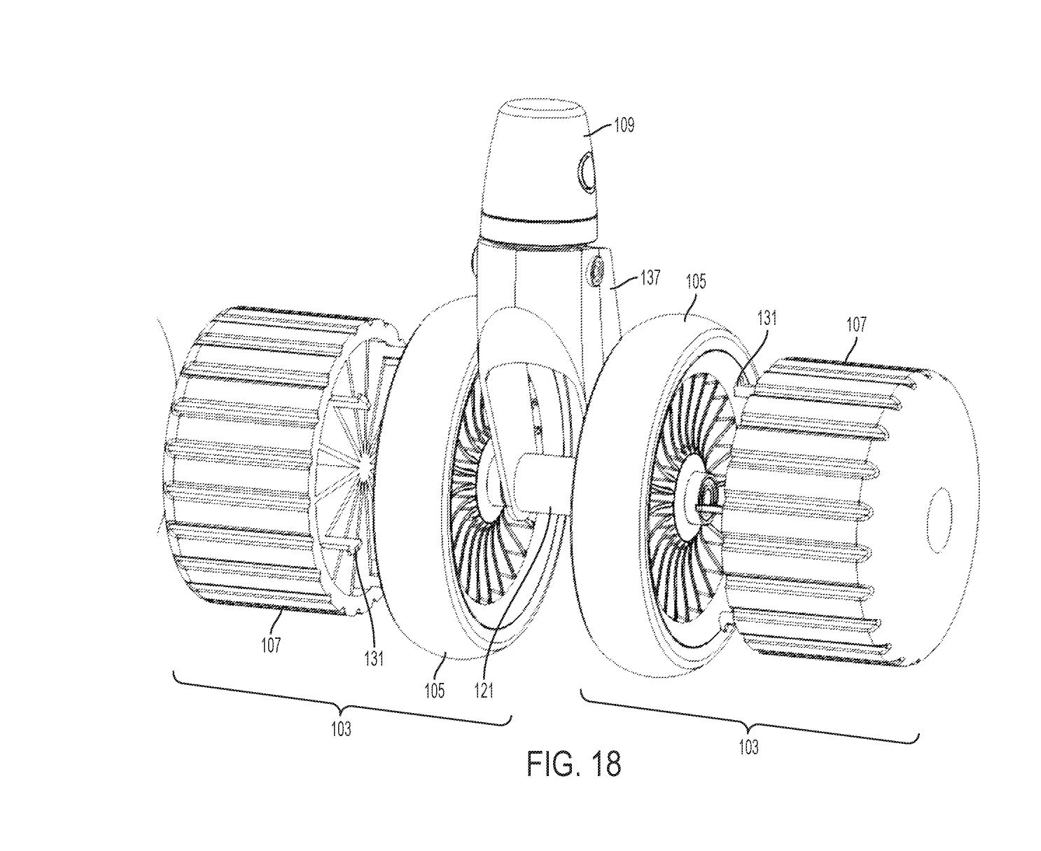

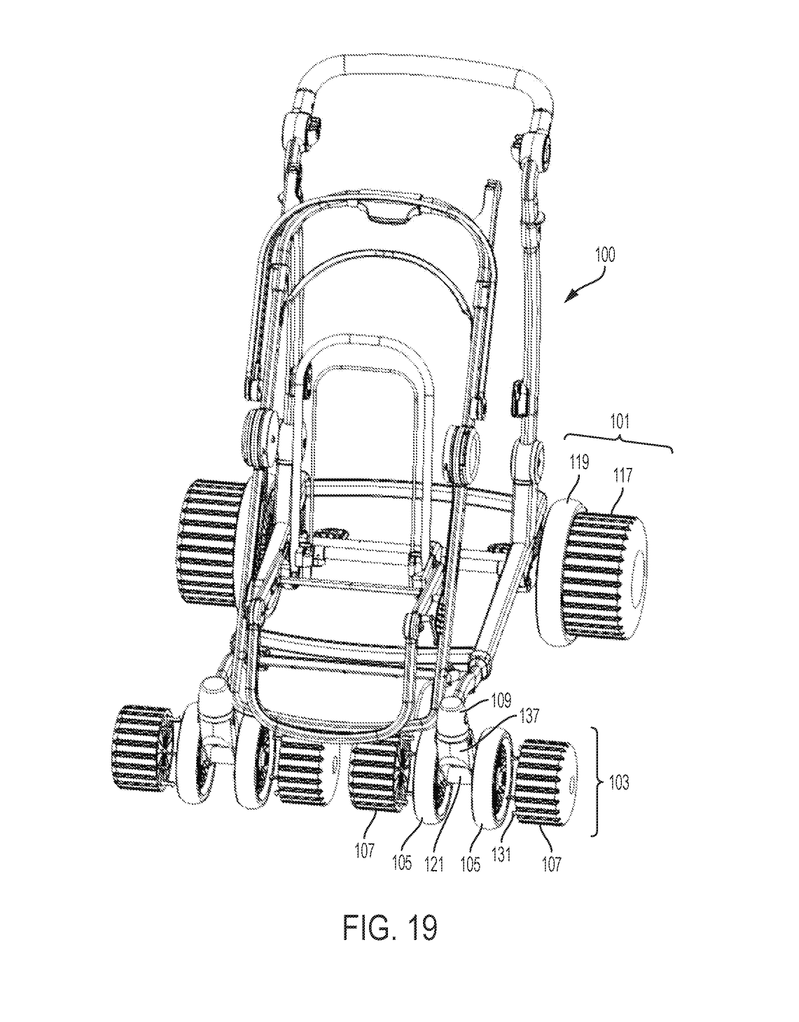

Similarly, for the front wheel assembly 103, one or more snaps 131 may be located along an interior surface of the front modular wheel 107 and configured to engage with one or more grooves located along the standard wheel 105, as shown in FIGS. 17-19. For example, the engagement and disengagement of the one or more snaps 131 and the one or more grooves for the front wheel assembly 103 are the same, or similar, as the engagement and disengagement of the one or more snaps 129 and the grooves described above with respect to the rear wheel assembly 101. FIG. 17 illustrates a front perspective view of the front modular wheel assembly 103 with a snap-on mechanism. FIG. 18 illustrates a front perspective view of front modular wheel assemblies 103 with a snap-on mechanism. FIG. 19 illustrates a front perspective view of the stroller 100 with rear wheel assembly 101 and the front wheel assembly 103 with a snap-on mechanism, with the front modular wheel 107 shown detached.

While a semi-flexible snap-on fit is described above with respect to FIGS. 12-19, in an alternative embodiment, a fixed snap-on fit can be used to attach the modular wheels 117, 107 to the standard wheels 119, 105. The fixed snap-on fit can comprise a locking mechanism comprising one or more pins located along an interior surface of the front modular wheel 107 and configured to engage with one or more grooves located along the standard wheel 105. Engagement of the modular wheels 117, 107 to the standard wheels 119,105, for example using the one or more snaps and grooves described above, may trigger a locking mechanism which prevents the modular wheels 117, 107 from moving with respect to the standard wheels 119, 105. In such an embodiment, the locking mechanism may utilize one or more pins predisposed to remain in a locked state. When the modular wheels 117, 107 align with the standard wheels 119, 105, and in particular, the one or more snaps 129 align with the one or more grooves, the one or more pins may retract slightly to allow the modular wheels 117, 107 to engage with the standard wheels 119, 105, and then the pin may snap to a locked position so as to prevent the movement of the modular wheels 117, 107 with respect to the standard wheels 119, 105. Alternative mechanisms for removably attaching one or more modular wheels to one or more standard wheels are contemplated and include threaded nuts, or some other attachment means.

In one embodiment, the stroller may be pre-configured with one or more standard wheels 119, 105. One or more of the modular wheels 117, 107 may be attached to the standard wheels using a snap-on fit, for example the semi-flexible snap-on fit or the fixed snap-on fit described above, to expand the footprint, i.e., surface area, of each wheel. In another embodiment, one or more of the front and rear wheel assemblies of the stroller pre-configured with standard wheels may be removed and modular front and rear wheel assemblies containing both standard wheels and modular wheels may be used to replace the pre-configured wheel assemblies. In a further alternative, only one of the front or rear wheel assemblies may be configured for a snap-on fit. In yet another alternative, only one of the front or rear wheel assemblies may be configured as a removable wheel assembly which is capable of being replaced by a modular wheel assembly.

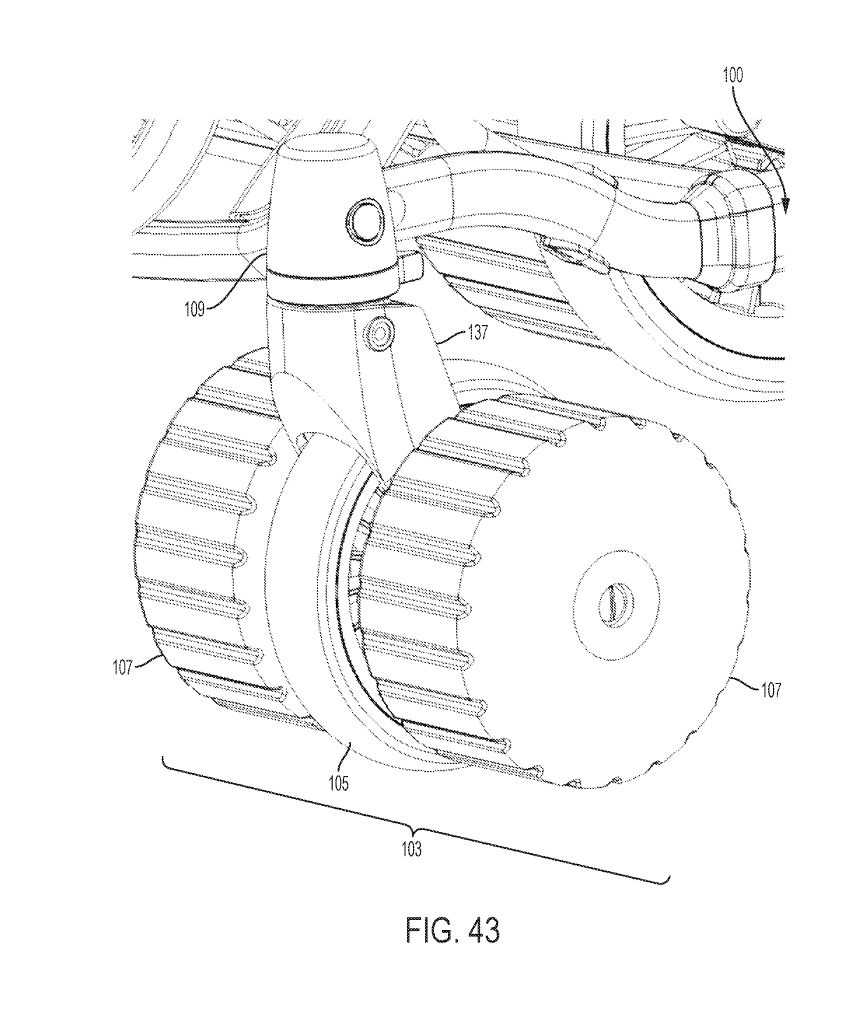

In one embodiment, the present disclosure provides a wheel assembly comprising one standard wheel and two modular wheels. Illustrated in FIG. 42 is a stroller 100 comprising front wheel assembly 103, front wheel assembly 103 comprising modular wheels 107 and standard wheel 105. FIG. 43 illustrates a close-up view of front wheel assembly 103. Front wheel assembly 103 can be attached to stroller 100 via a hub structure comprising upper hub 109 and lower hub 137. Upper hub 109 can be located on a base of stroller 100. Lower hub 137 can be part of wheel assembly 103. Wheel assembly 103 can be removably attached to stroller 100 via the hub structure.

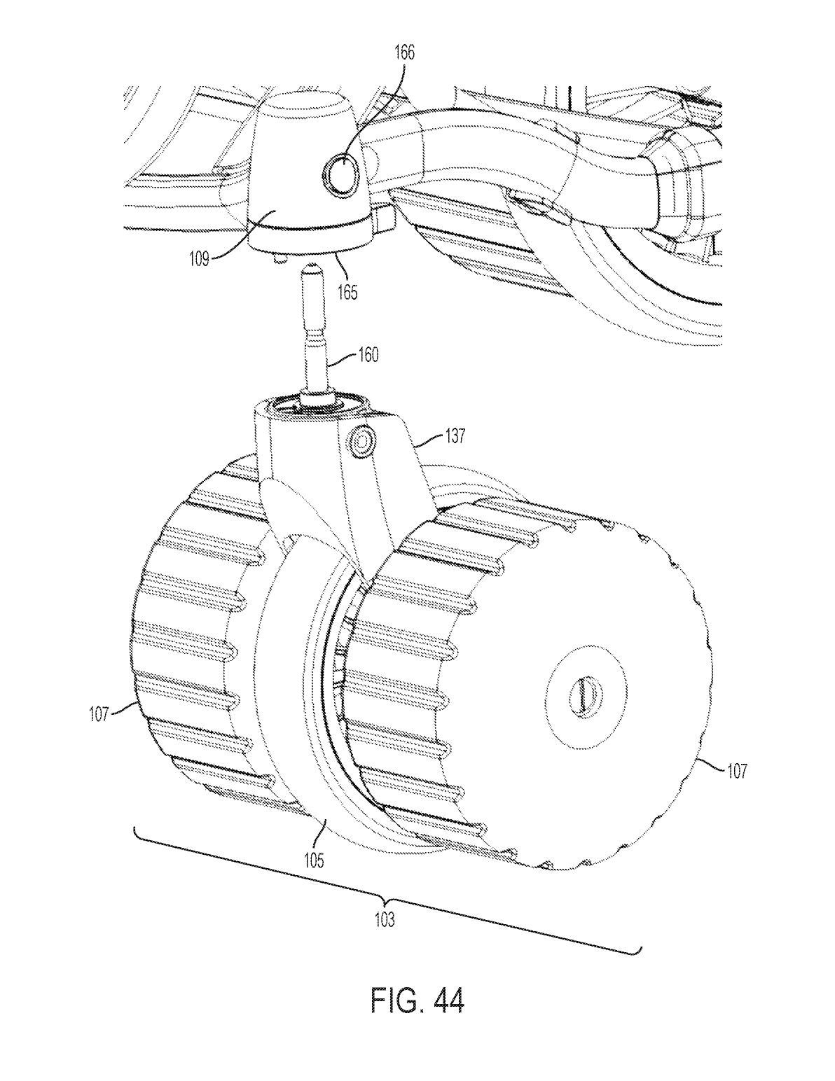

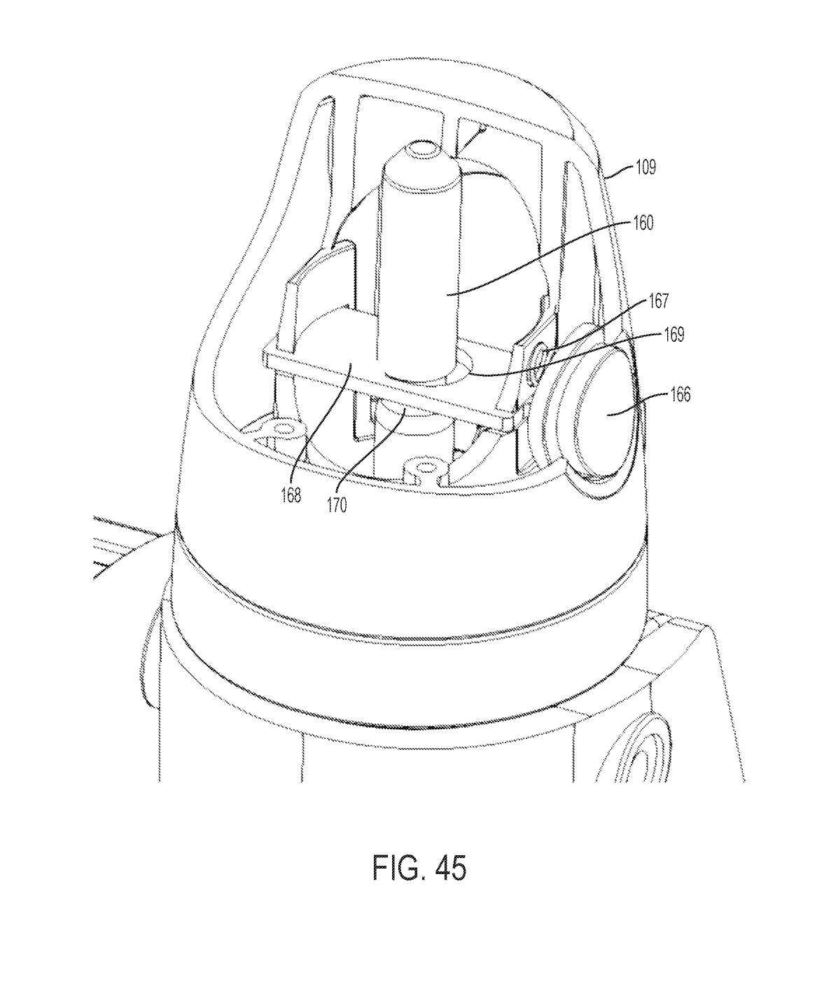

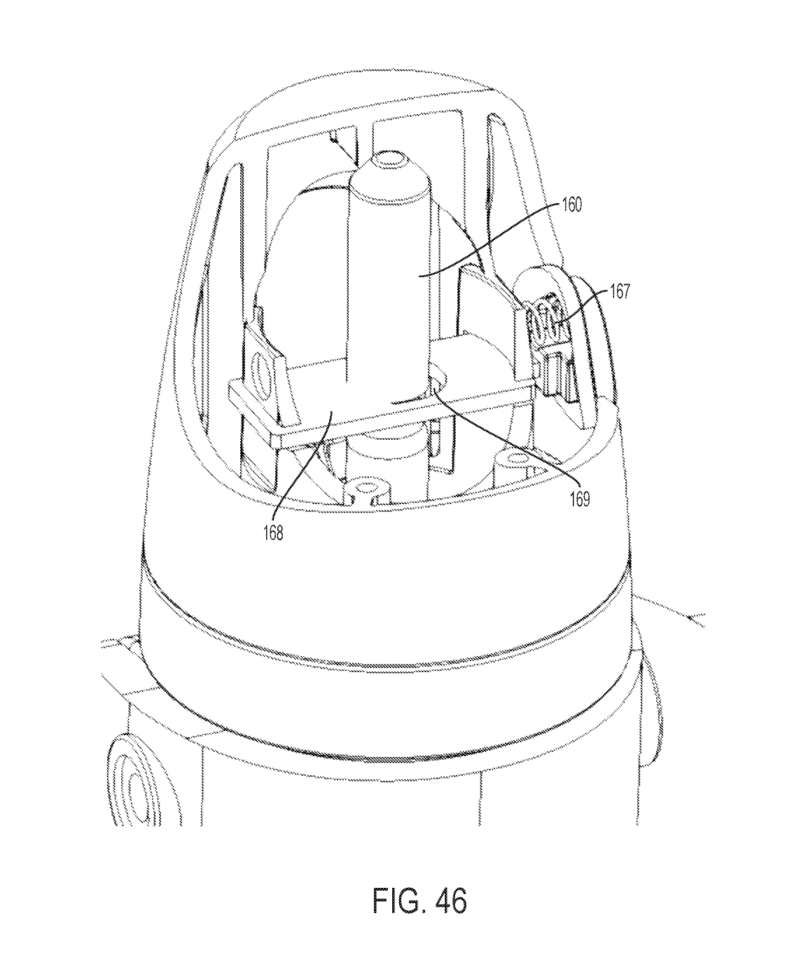

FIGS. 44 to 51 illustrate in detail a means for attaching wheel assembly 103 to stroller 100, according to an exemplary embodiment. Lower hub 137 can comprise a “male” portion 160 that is configured to fit into a “female” portion 165 of the upper hub 109. The hub structure can comprise a locking mechanism for attaching the wheel assembly 103 to the stroller 100. The locking mechanism can comprise a button 166 on the upper hub 109. As illustrated in FIG. 45, as button 166 is pushed in, spring 167 connected to button 166 and located behind button 166 is also pushed in, sliding locking plate 168 horizontally toward the middle of upper hub 109. Locking plate 168 comprises hole 169 through which “male” portion 160 of the lower hub 137 can slide through, thereby locking wheel assembly 103 to stroller 100. “Male” portion 160 is prevented from falling out of hole 169 by grooves 170 on the “male” portion 160 and the locking plate 168 is held in place by spring 167. FIGS. 46-49 illustrate spring 167 being pushed in (via button 166) such that locking plate 168 is in the appropriate position and location for “male” portion 160 can slide through hole 169.

In one embodiment, 360° rotation of the wheel assembly can be selectively prevented via a pin mechanism, for example as illustrated in FIGS. 50 and 51. Locking pin 180 located at the bottom of upper hub 109, when engaged with the lower hub 137 (not shown), can prevent rotation of bottom disc 181 of upper hub 109, preventing 360° rotation of the wheel assembly. It should be understood that when locking pin 180 is engaged, the wheel assembly has forward and backward movement, but not full rotational movement. When locking pin 180 is engaged, rotating pin 182 is at or near the bottom of pin ramp 183 and spring 184 is not compressed. To disengage locking pin 180, lever 185 (shown in FIG. 51), can be rotated such that rotating pin 182 is pulled up the pin ramp 183 into a detent area 186, compressing spring 184 and disengaging locking pin 180 (shown in FIG. 50). When locking pin 180 is disengaged, bottom disc 181 is free to rotate, allowing the wheel assembly (not shown) to fully rotate.

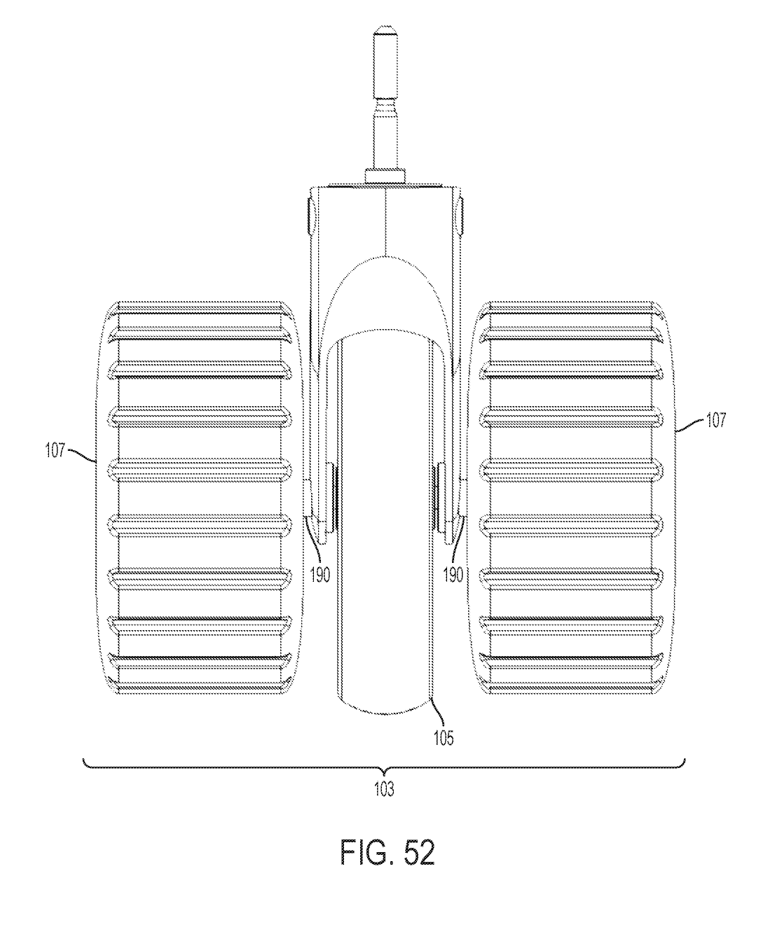

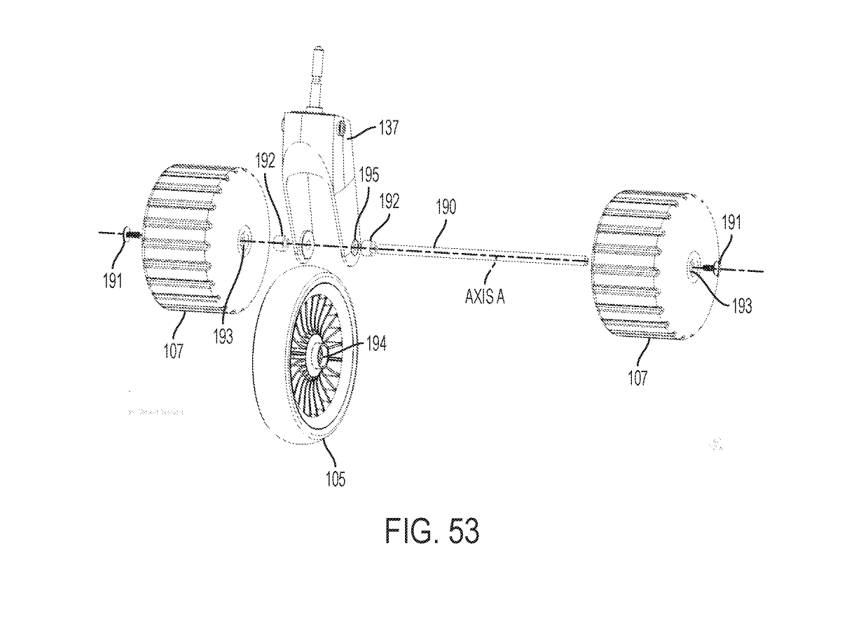

In one embodiment, modular wheel can be attached to standard wheel of the front wheel assembly via an axle. FIGS. 52-53 illustrates the attachment means, i.e., the axle 190, attaching modular wheels 107 to standard wheel 105 of the front wheel assembly 103. As shown in FIG. 52, modular wheels 107 can be spaced apart from the standard wheel 105. As shown in FIG. 53, axle 190 can be threaded through a center hole 193 of modular wheels 107, center hole 194 of standard wheel 105, and holes 195 of the lower hub 137, and can be held in place via nut/bolt assemblies 191 (or any other suitable means) such that modular wheels 107 and standard wheel 105 can rotate about axis A. Modular wheels 107 can be spaced apart from standard wheel 105 via spacers 192.

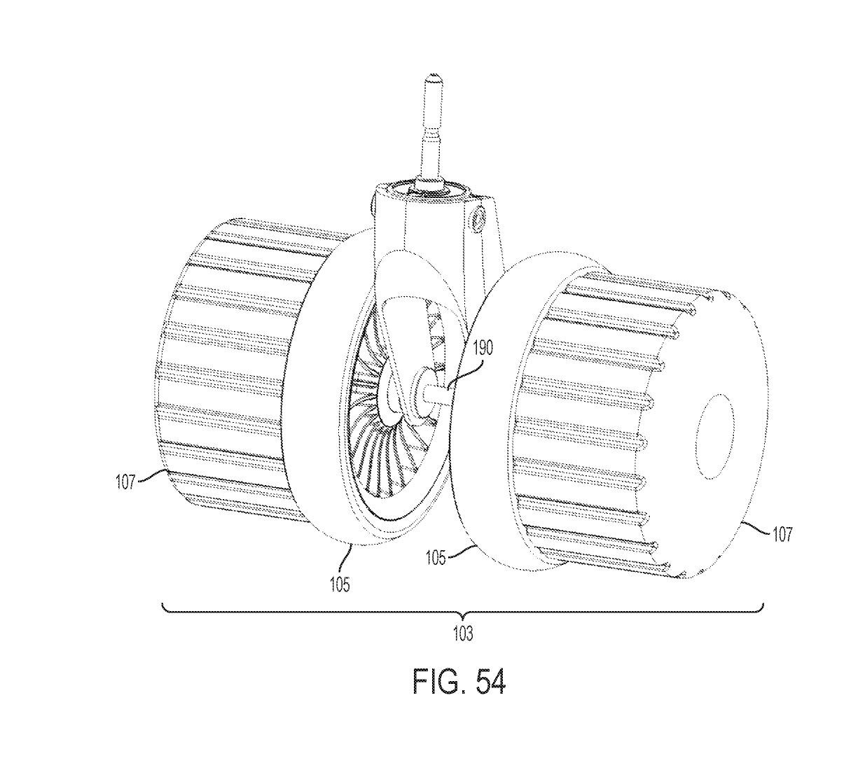

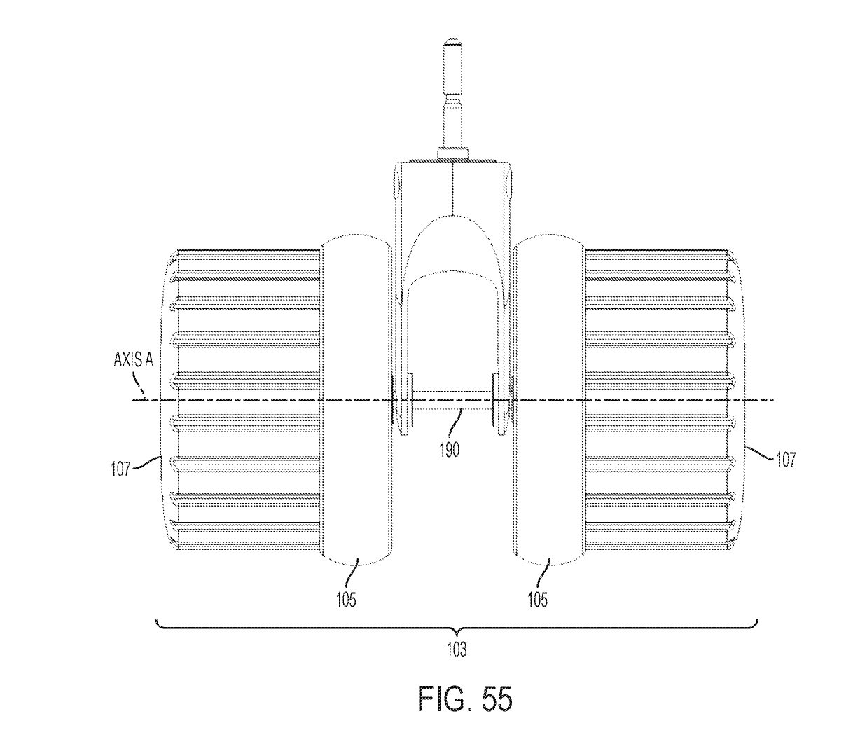

In one embodiment, front wheel assembly comprises a two modular wheels and two standard wheels (for example as described above), where the modular wheels are attached to the standard wheels via an axle. FIGS. 54-55 illustrate front wheel assembly 103 where modular wheels 107 are attached to standard wheels 105 via axle 190. Axle 190 can be threaded through center holes of the standard wheels, modular wheels and lower hub to allow for rotation of the wheels about Axis A, for example as described above.

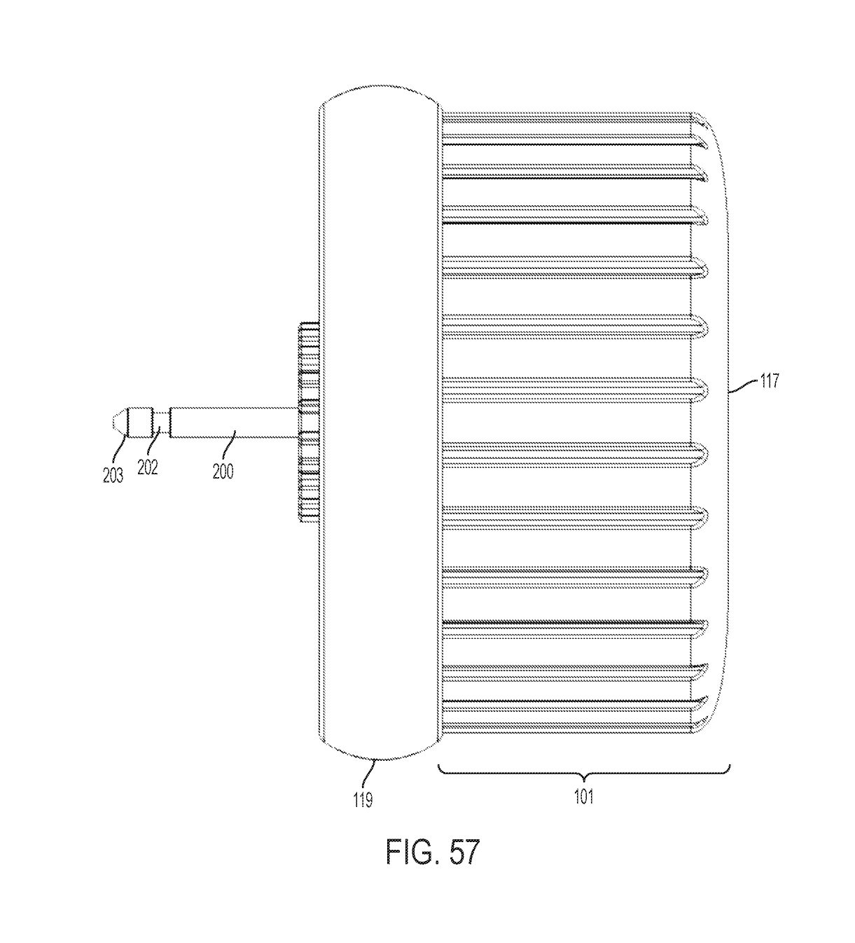

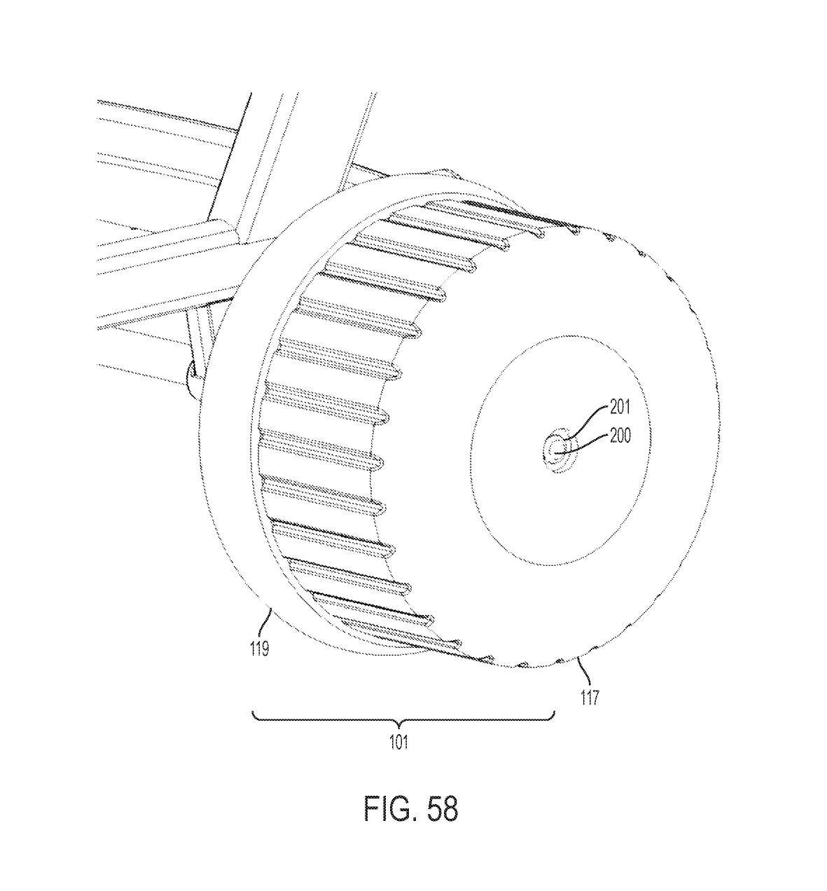

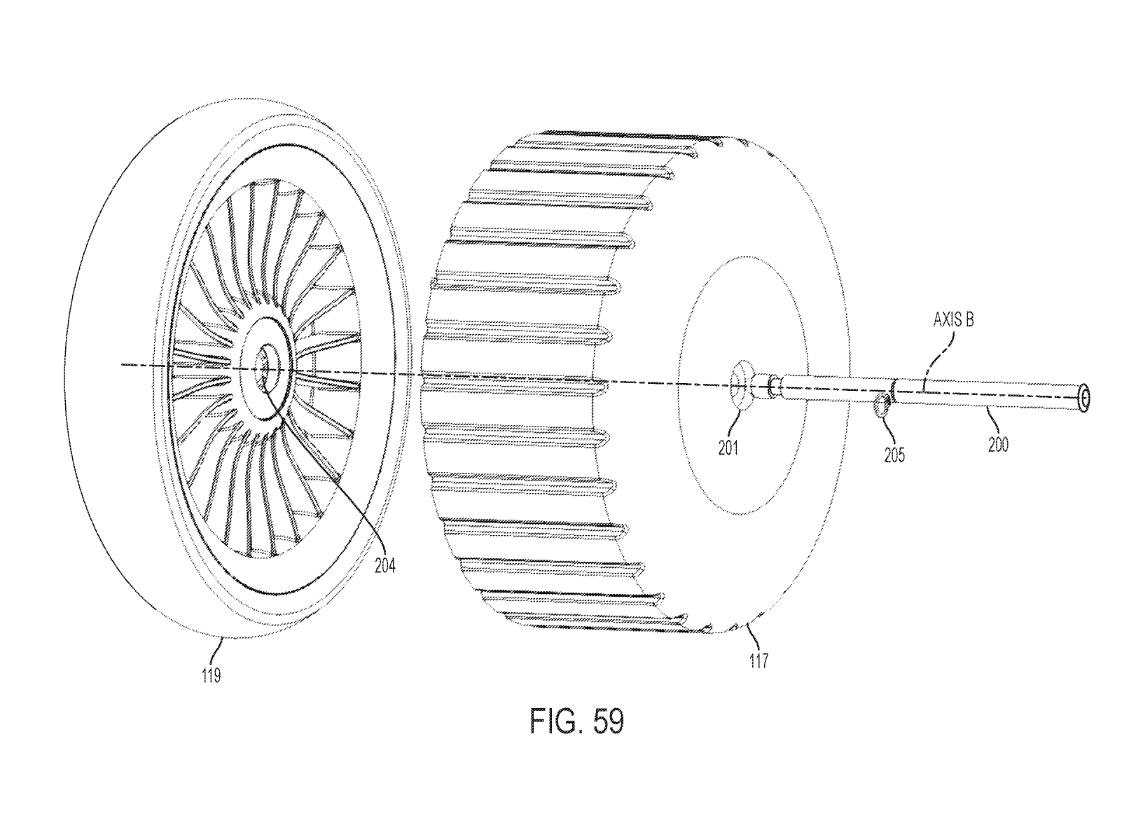

In one embodiment, rear modular wheel can be attached to rear standard wheel of the rear wheel assembly via an axle. FIGS. 55-59 illustrates the attachment means, i.e., the axle 200, attaching rear modular wheels 117 to rear standard wheel 119 of the rear wheel assembly 103. Axle 200 is threaded through center hole 201 of modular wheel 117 and a center hole 204 (shown in FIG. 59) of the standard wheel 119 and can be held in place via nut/bolt assemblies, retaining clip 205, and/or any other suitable means such that modular wheel 117 and standard wheel 119 can rotate about Axis B. Axle 200 can comprise groove 202 and end 203 that facilitates locking of the rear wheel assembly 101 to a stroller frame (described in more detail below).

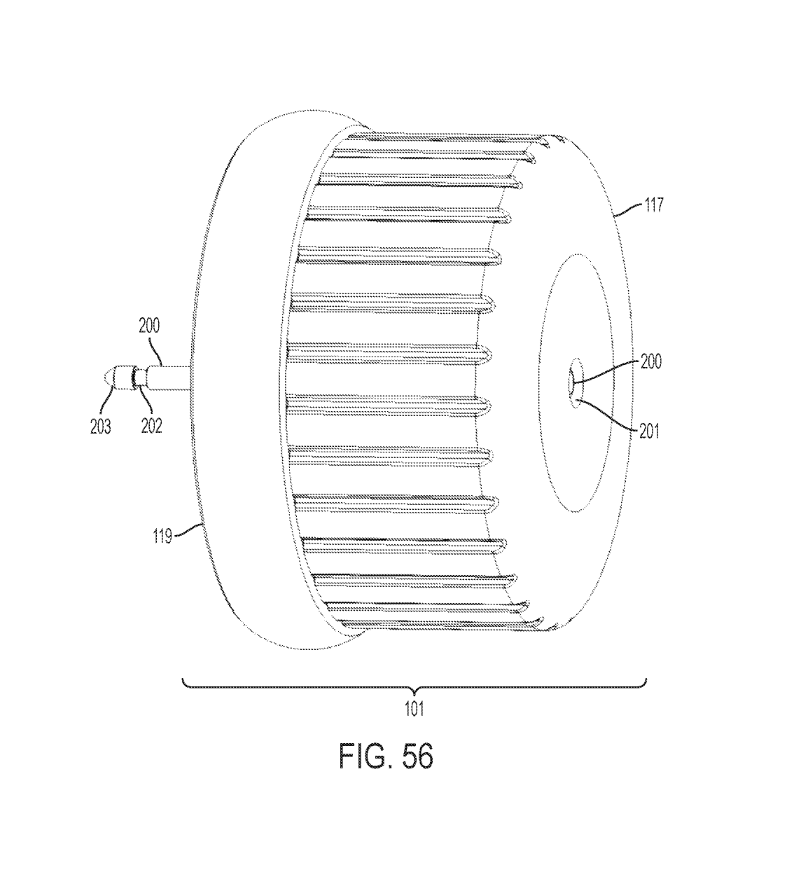

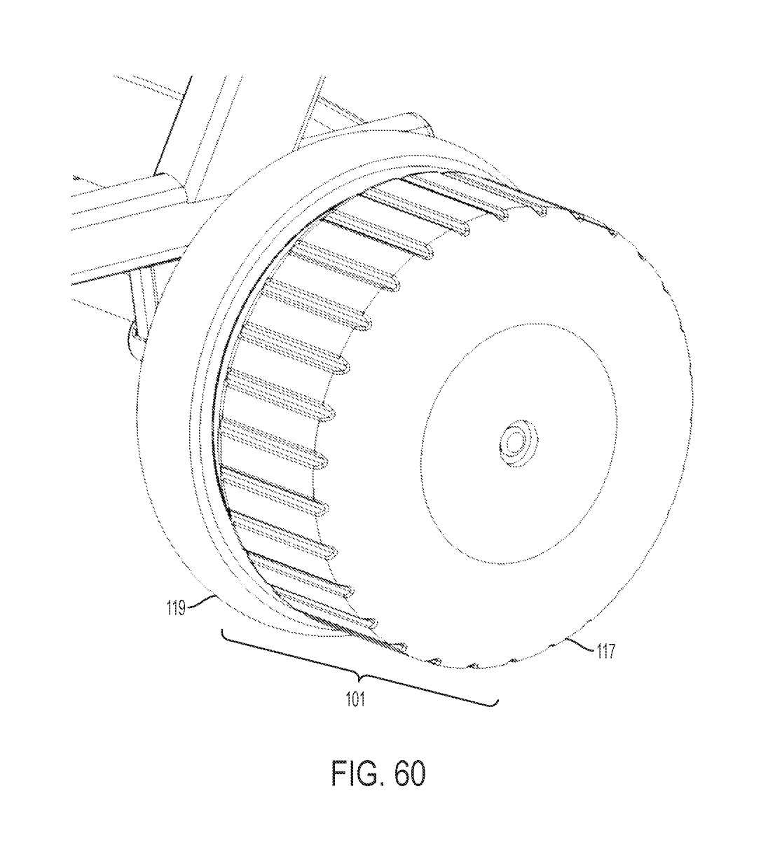

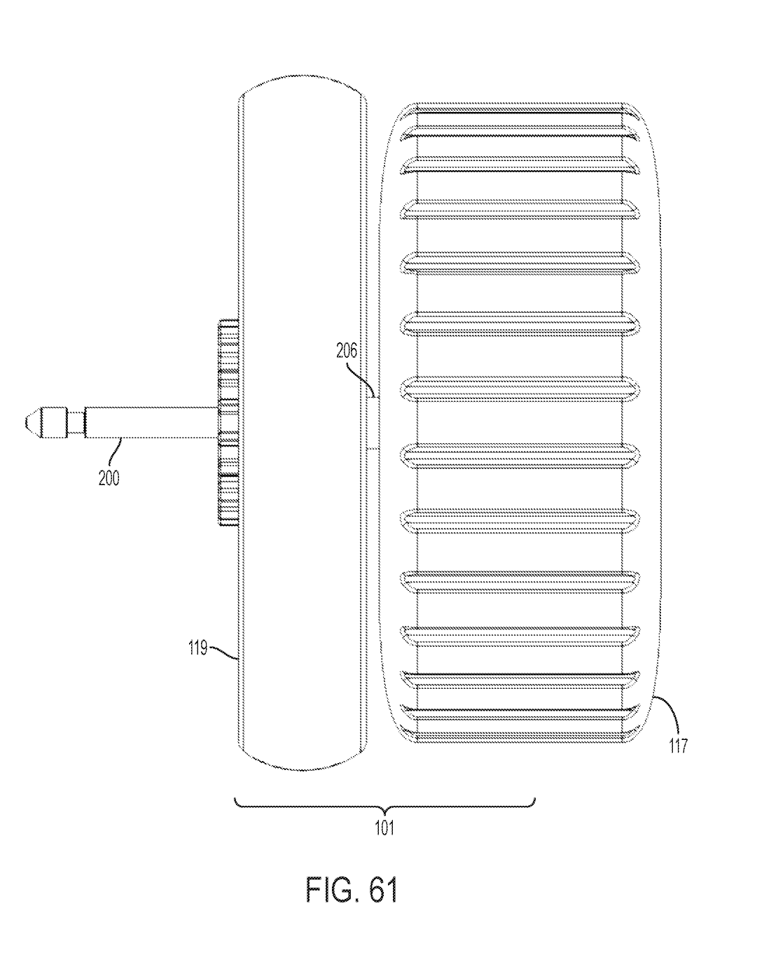

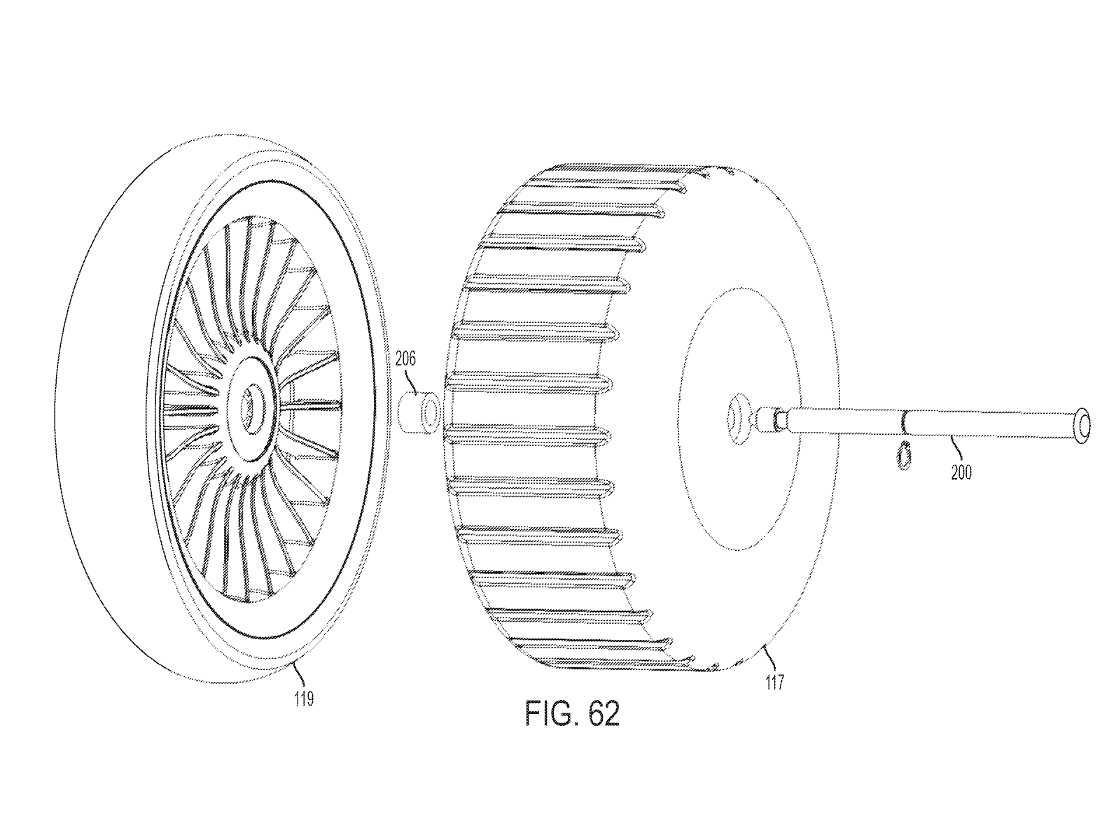

In one embodiment, rear modular wheel 117 can be held in place flush against rear standard wheel 119 of rear wheel assembly 101 (as shown in FIGS. 56-59). In another embodiment, rear modular wheel 117 can be spaced apart from rear standard wheel 119 via one or more spacers. As illustrated in FIGS. 60-62, rear modular wheel 117 can be spaced apart from rear standard wheel 119 via spacer 206 located between rear modular wheel 117 and rear standard wheel 119.

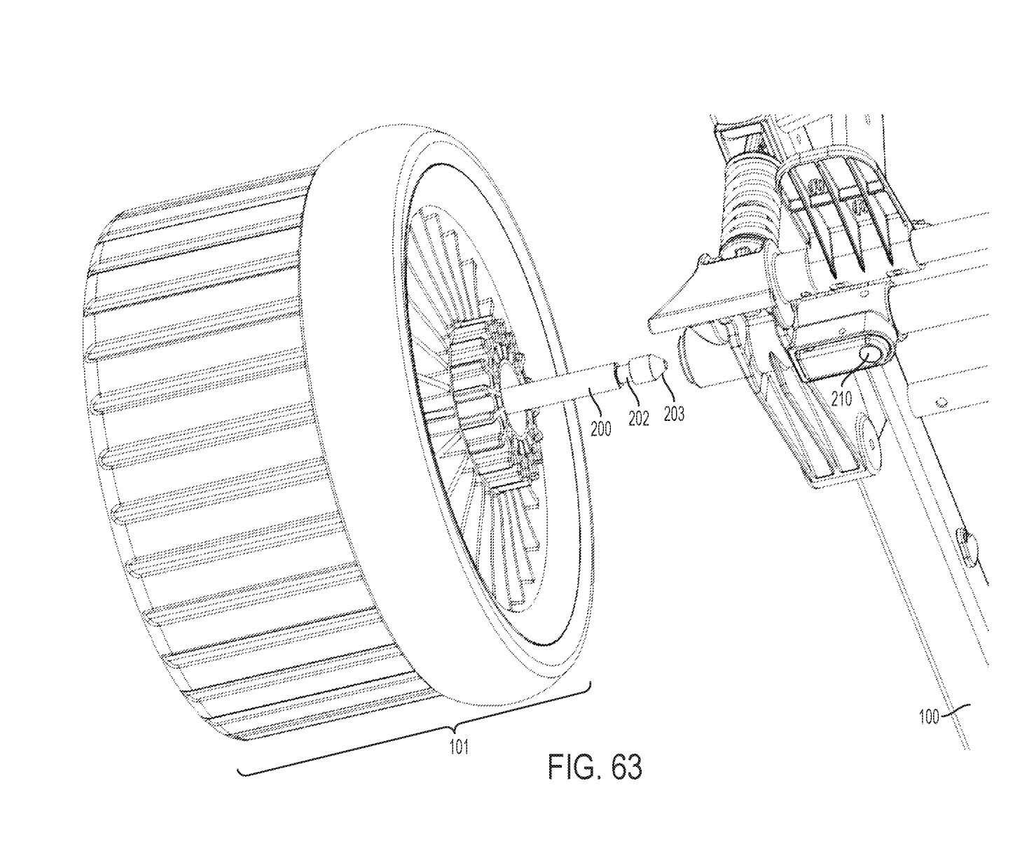

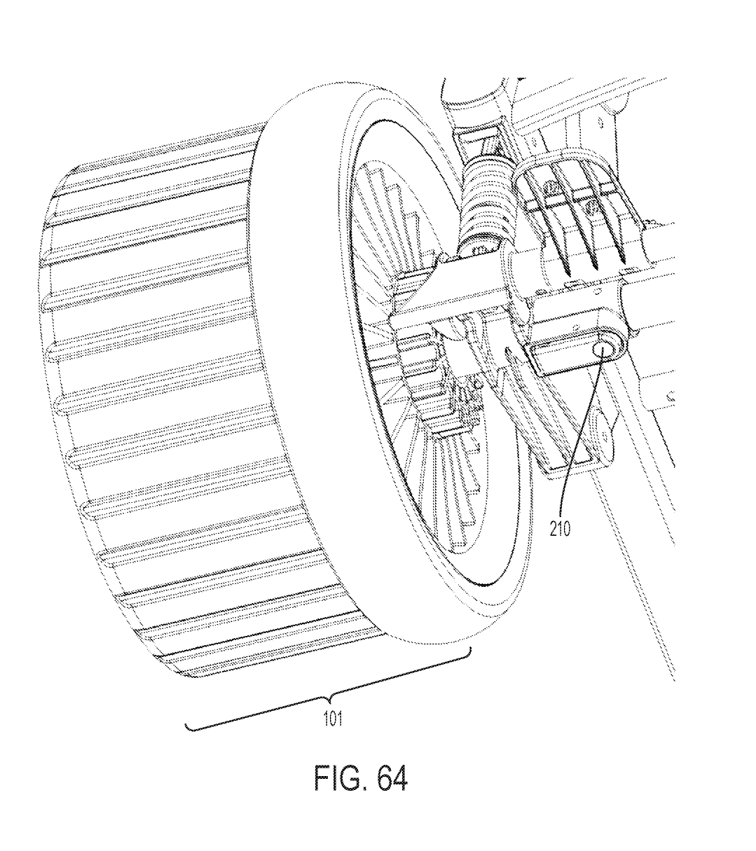

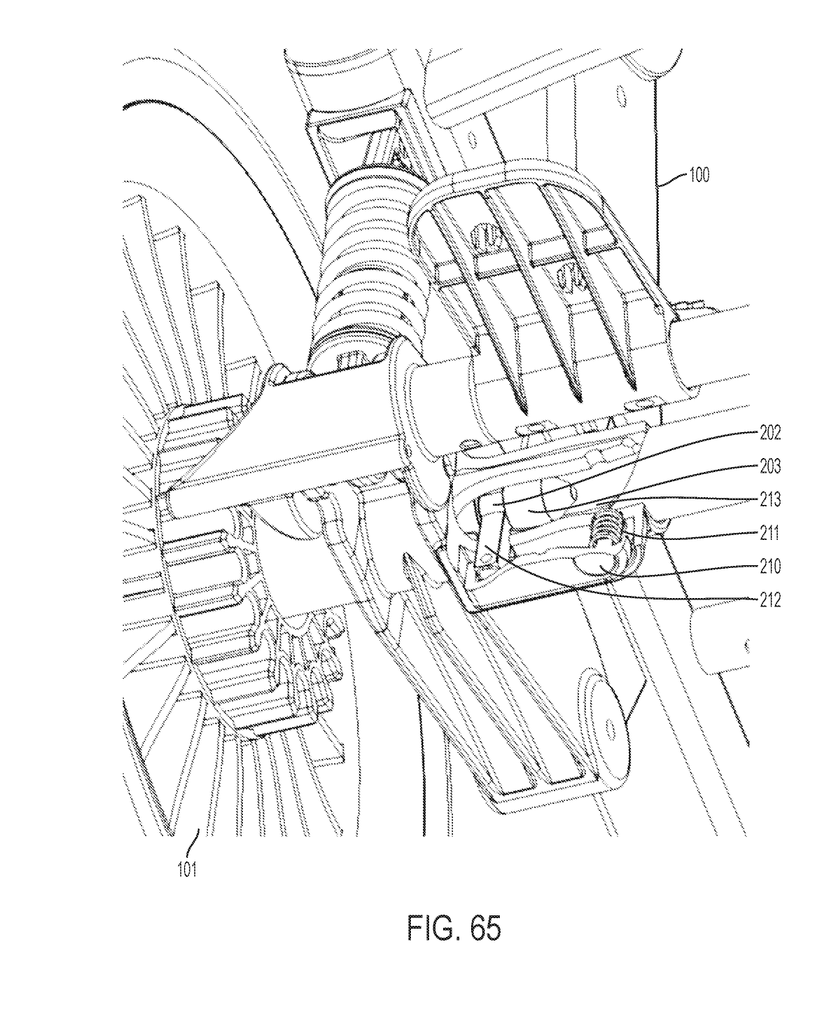

FIGS. 63 to 65 illustrate in detail a locking mechanism for attaching rear wheel assembly 101 to stroller 100, according to an exemplary embodiment. FIG. 63 shows rear wheel assembly 101 detached from stroller 100 and FIG. 64 shows rear wheel assembly 101 attached to stroller 100. Stroller 100 comprises rear button 210 that facilitates attachment of rear wheel assembly 101 to stroller 100. FIG. 65 shows a detailed cross-view of the locking mechanism for rear wheel assembly 101. The locking mechanism comprises rear button 210 that, when pushed, compresses spring 211 and lifts up notch 212, allowing end 203 of axle 200 to fit inside space 213 of the stroller 100 and axle 200 is held in place via groove 202 that prevents axle 200 from sliding out of space 213.

In one embodiment, the locking mechanisms for the front wheel assembly 103 and the rear wheel assembly 101, as described herein, allow for a user to attach and detach front wheel assembly 103 and/or rear wheel assembly 101 from the stroller 100. Modular wheels 117/107 can come pre-attached to the respective standard wheels 119/105 via respective axles 190/200. In one embodiment, a user can attach the front and/or rear modular wheel to the respective front or rear standard wheel via a snap mechanism. As illustrated in FIGS. 66 and 67, snaps 220 on rear modular wheel 117 can be inserted between spokes 222 of rear standard wheel 119. Snap grooves 221 prevent rear modular wheel 117 from detaching from rear standard wheel 119. A user can remove rear modular wheel 117 from rear standard wheel 119 by squeezing ends of snaps 220, releasing the spokes 222 of the rear standard wheel 119 from the snap grooves 221. Front modular wheels 107 can be attached to front standard wheels 105 using a similar snap mechanism. The snap mechanism described herein can be used alone or in combination with the axle mechanism to attach the modular wheels from the standard wheels.

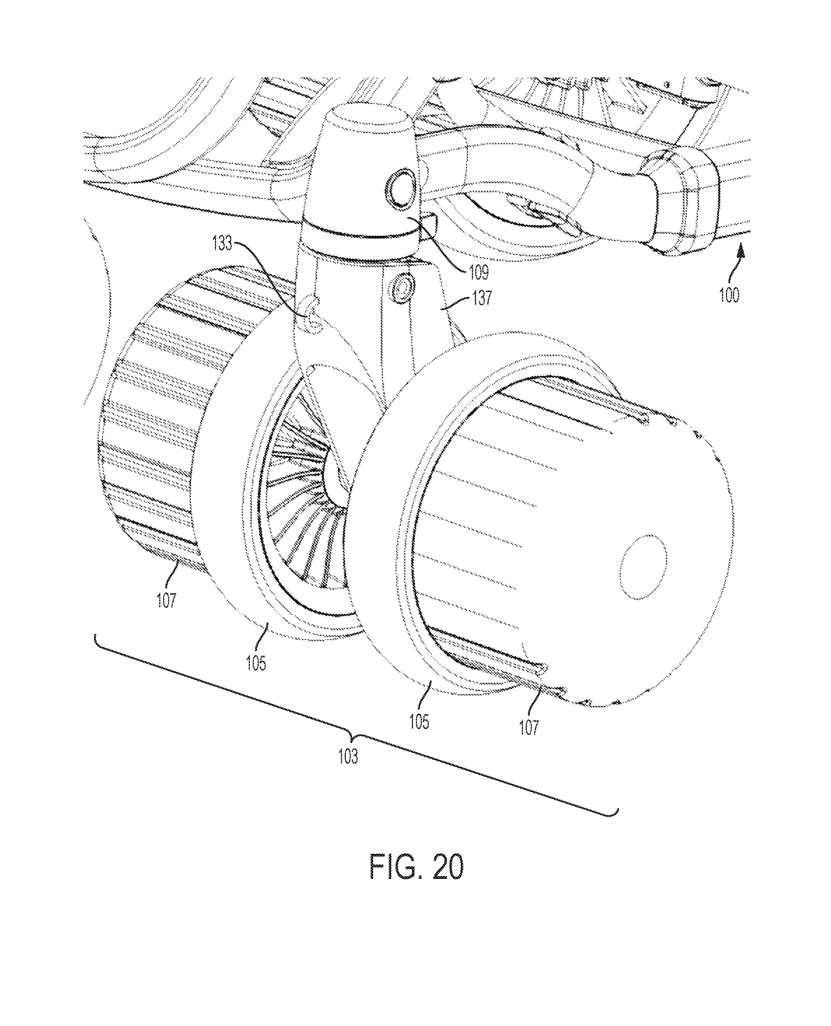

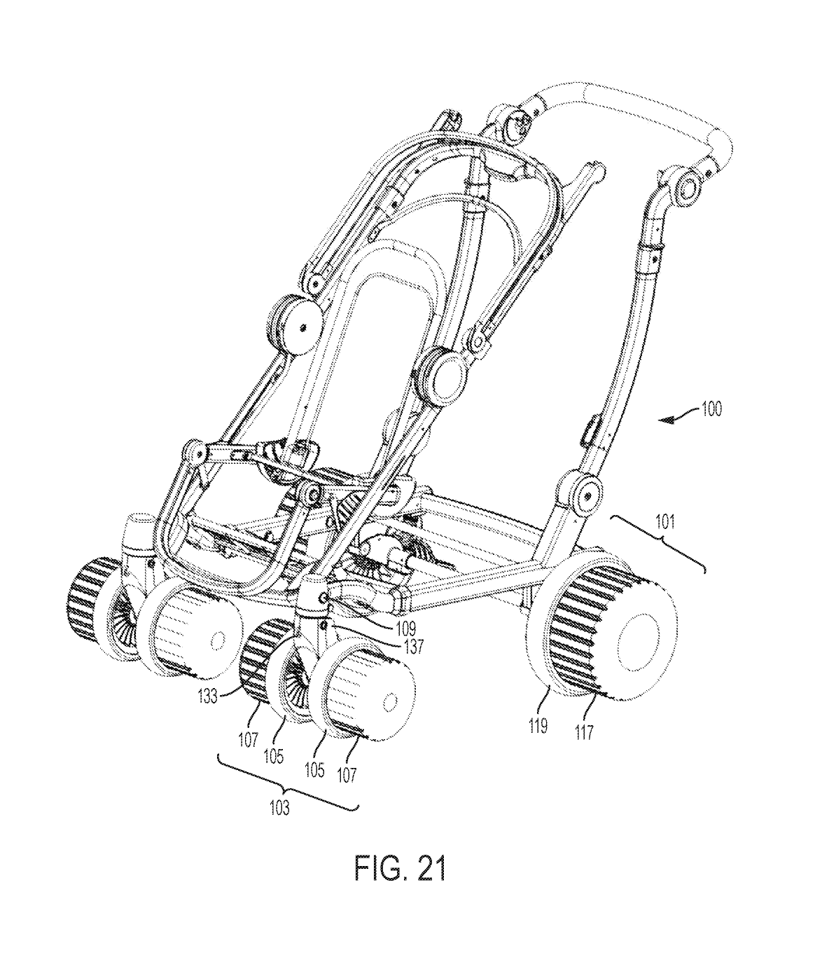

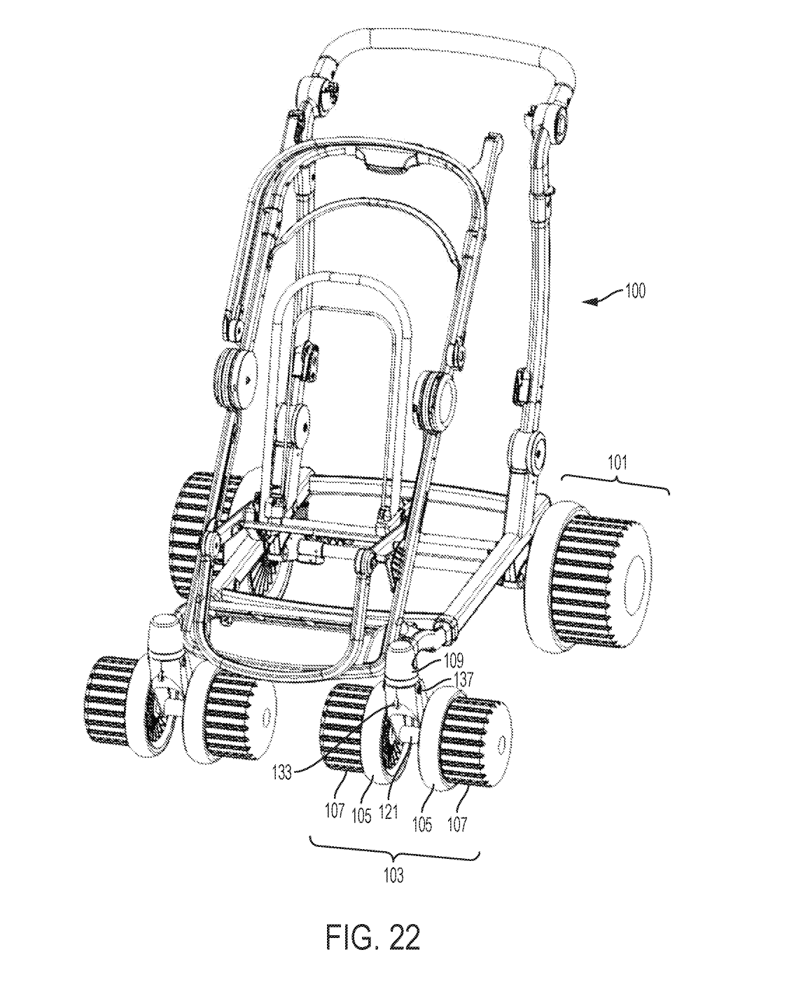

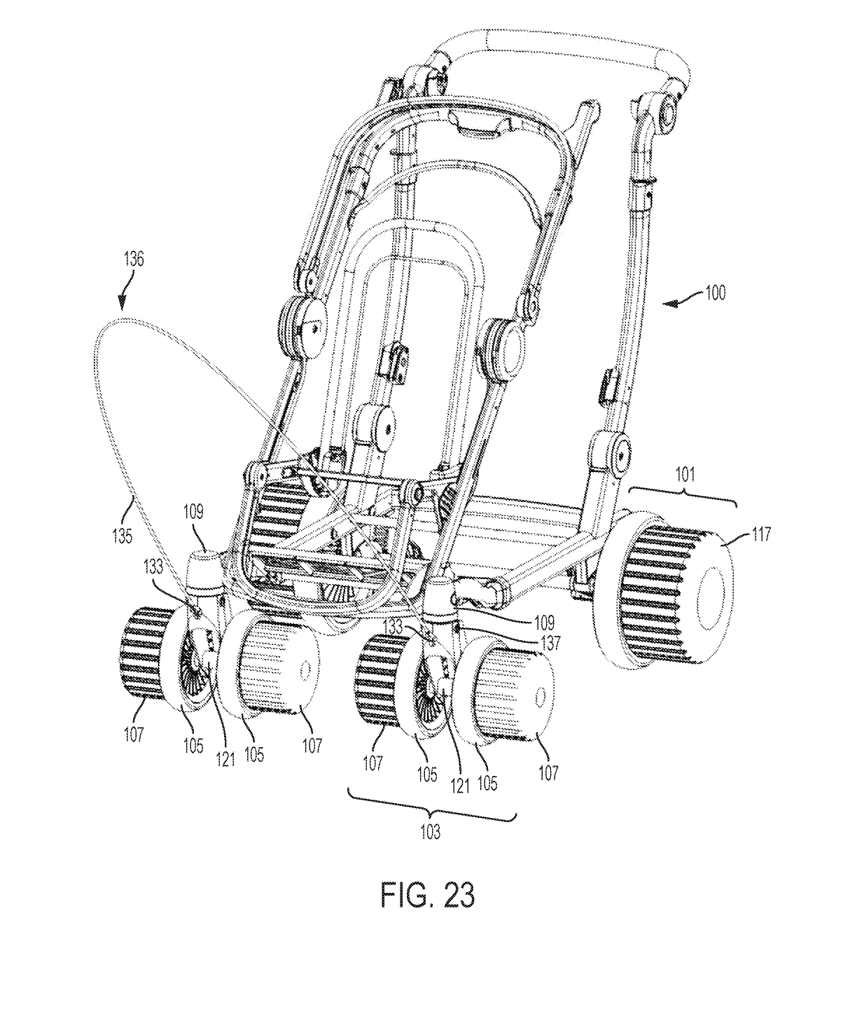

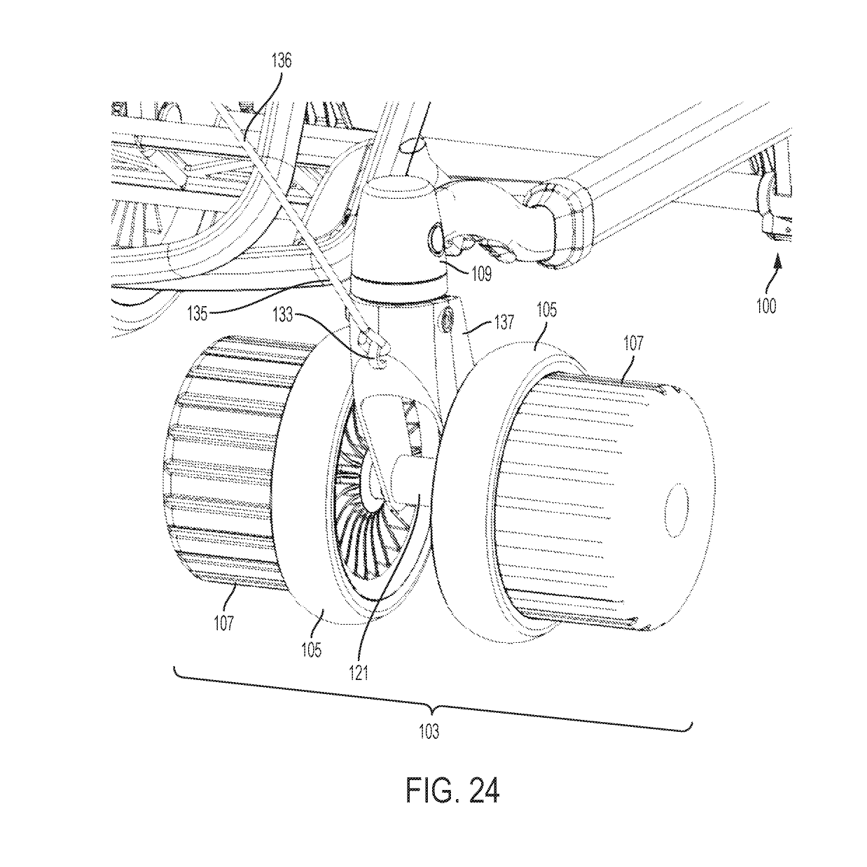

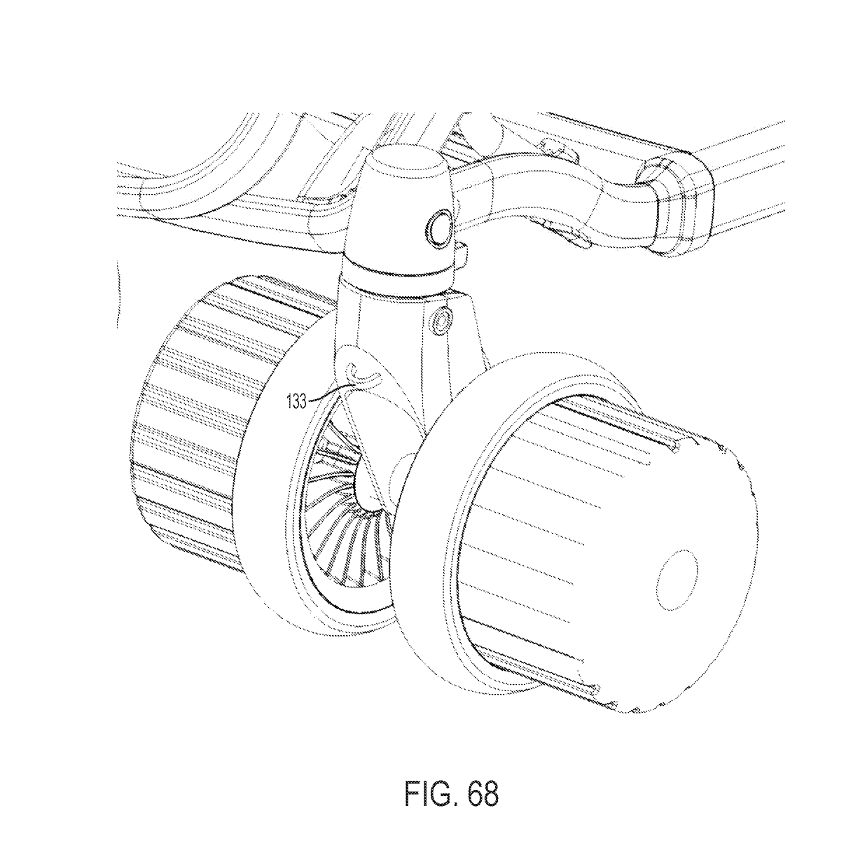

The present disclosure provides a modular pulling attachment, for example used with a stroller. In one embodiment, a stroller, for example including the various embodiments described herein, can comprise a pulling mechanism for facilitating pulling of the stroller. The pulling mechanism can be flexible, semi-flexible, or rigid. FIGS. 20-24 illustrate an embodiment of a modular stroller 100 with a flexible pulling mechanism. FIG. 20 illustrates a front side perspective view of a portion of stroller 100 comprising a front wheel assembly 103 configured to include a flexible pulling mechanism 136 (the flexible pulling mechanism 136 shown in FIG. 23). FIG. 21 illustrates a front side perspective view of the stroller 100 with modular wheel assembly, with the front and rear wheel assemblies 101, 103 attached, and the front wheel assembly 103 configured to include a flexible pulling mechanism. FIG. 22 illustrates a front perspective view of the stroller 100, with the front and rear wheel assemblies 101, 103 attached, and the front wheel assembly 103 configured to include a flexible pulling mechanism. FIG. 23 illustrates a front perspective view of the stroller 100, with the front and rear wheel assemblies 101, 103 attached, and with a flexible pulling mechanism 136. FIG. 24 illustrates a front perspective view of a portion of stroller 100 comprising the front wheel assembly 103 with a flexible pulling mechanism 136. As depicted in FIGS. 20-24, the lower hub 137 of the front wheel assembly 103 may comprise a hook 133 or similar connection means used to attach a flexible member 135 to the front wheel assembly 103. The hook 133 can be positioned vertically as shown in FIG. 24 or horizontally as shown in FIG. 68. The flexible member 135 can be used to pull the modular stroller 100. The flexible member 135 may have two ends, each of which is attached to a hook 133 located on the lower hub 137 of each of the front wheel assemblies 103 of the stroller 101. The flexible member 135 may further comprise a padded region that can be used as a handle by a user pulling the flexible member 135. The hook 133 and flexible member 135 form the flexible pulling mechanism 136. As a user pulls on a handle disposed on the flexible member 135, the flexible member 135 pulls the stroller 100 via the hooks 133. In most instances, a pulling motion exerts an upwards lifting force on the stroller 100 and allows easier movement of the front and/or rear modular wheels 107, 117 along a supporting surface. Additionally, since the hook 133 is located on the lower hub 137, the pulling motion orients the front standard and front modular wheels 105, 107 on the front swivel axle 121 and thus serves to steer the stroller 100. As depicted in FIGS. 20-24, the hook 133 is similar to an eye-bolt and the end of the flexible member 135 can form a circular end which engages with the hook 133. Although a hook 133 is described above, it is contemplated that alternative means for attaching the flexible member 135 to the lower hub 137 may be utilized.

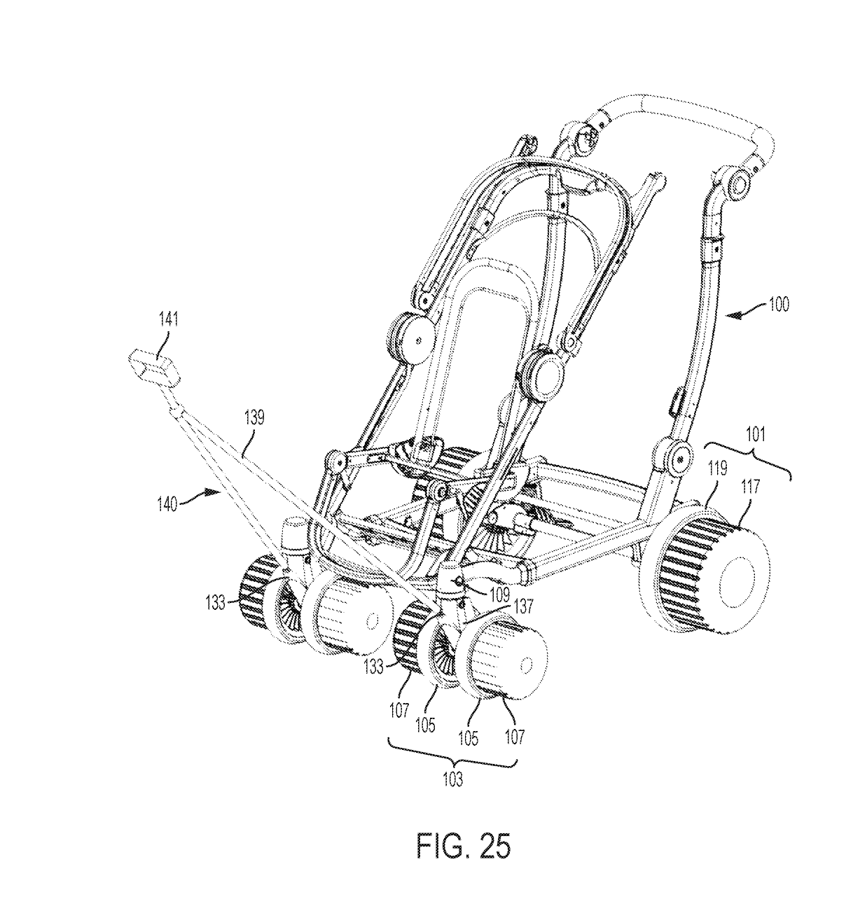

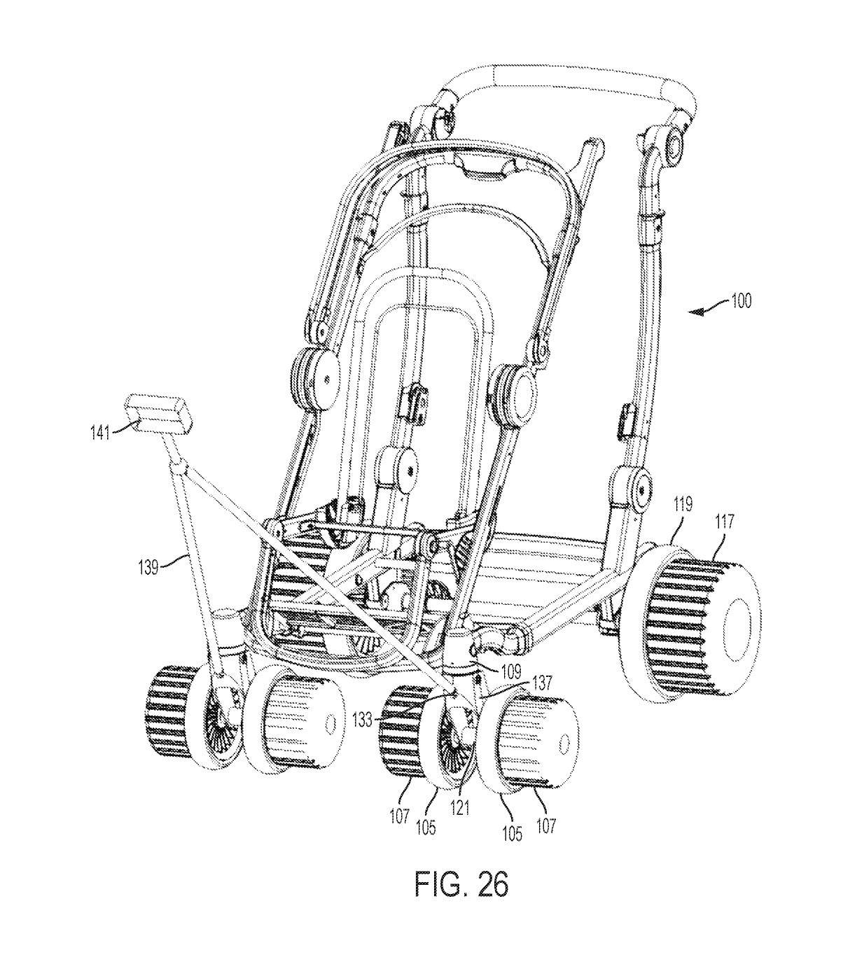

In another embodiment, the modular stroller may comprise a rigid pulling mechanism. FIGS. 25 and 26 illustrate a stroller 100, with the front and rear wheel assemblies 101, 103 attached, and further comprising a rigid pulling mechanism 140. As illustrated in FIGS. 25 and 26, the rigid pulling mechanism 140 may comprise one or more rods 139 configured to attach to the lower hub(s) 137 of the front wheel assembl(ies) 103 at hook(s) 133. In one embodiment the one or more rods 139 may be pivotally attached to the hook 133 on the lower hub 137 at one end, and attached to a handle 141 at a second end. As a user pulls on the handle 141, the one or more rods 139 pulls the stroller 100 via the hook(s) 133. The general pulling motion may also serve to exert an upwards lifting force on the stroller 100 and allows easier movement of the front and/or rear modular wheels 107, 117 along the supporting surface. Additionally, as the hook(s) 133 are located along the lower hub 137, the pulling motion orients the front standard and front modular wheels 105, 107 on the front swivel axle 121 and thus steers the stroller 100. Furthermore, in one embodiment, the length of the one or more rods 139 may be adjustable, for example via a telescopic adjustment mechanism.

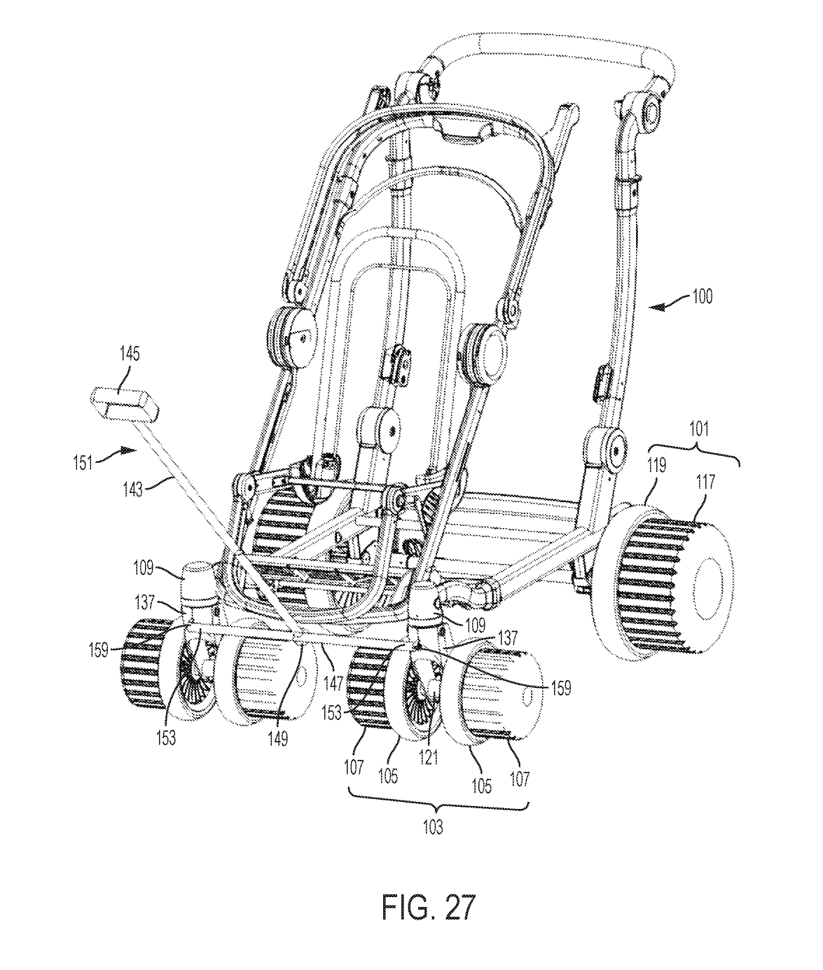

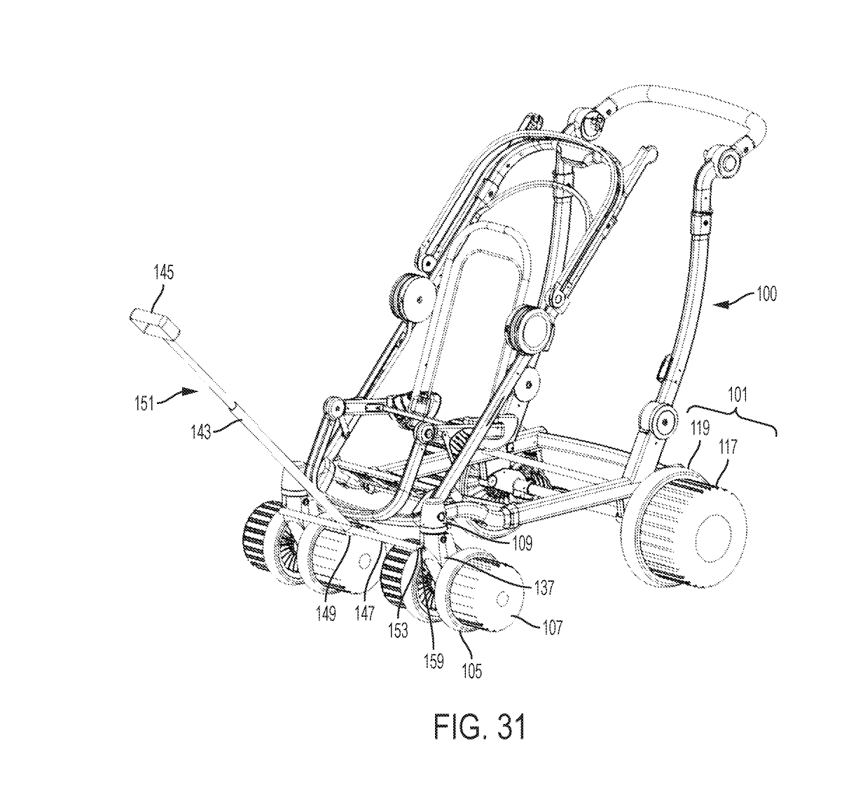

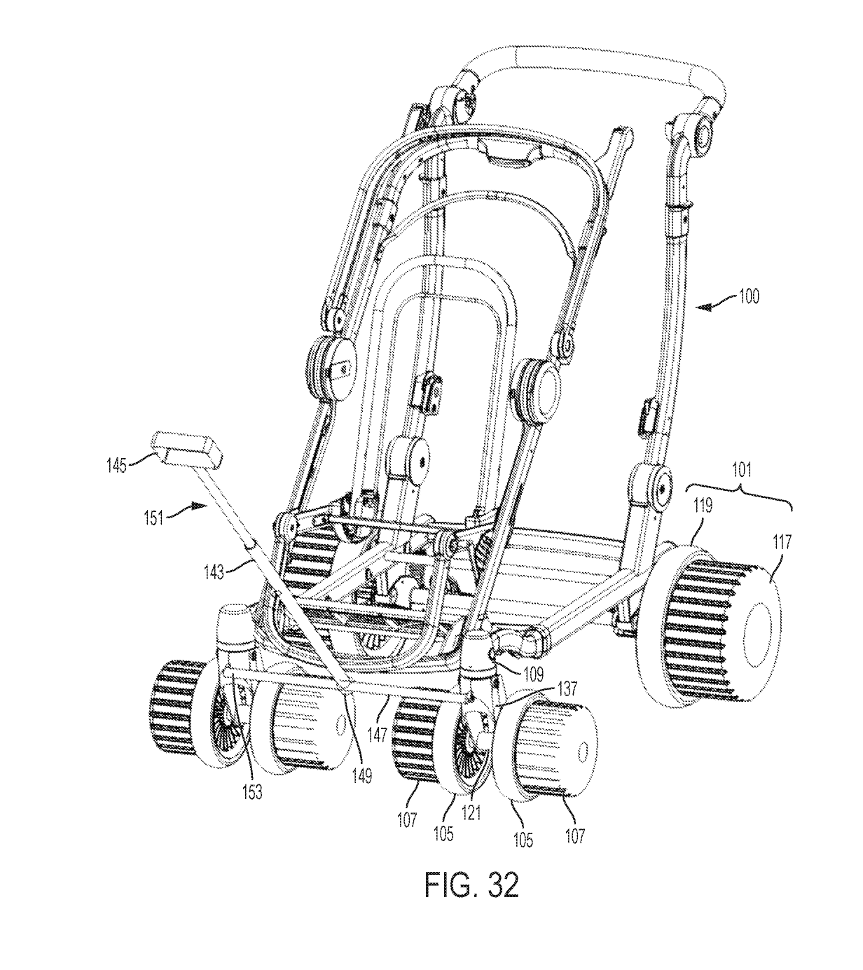

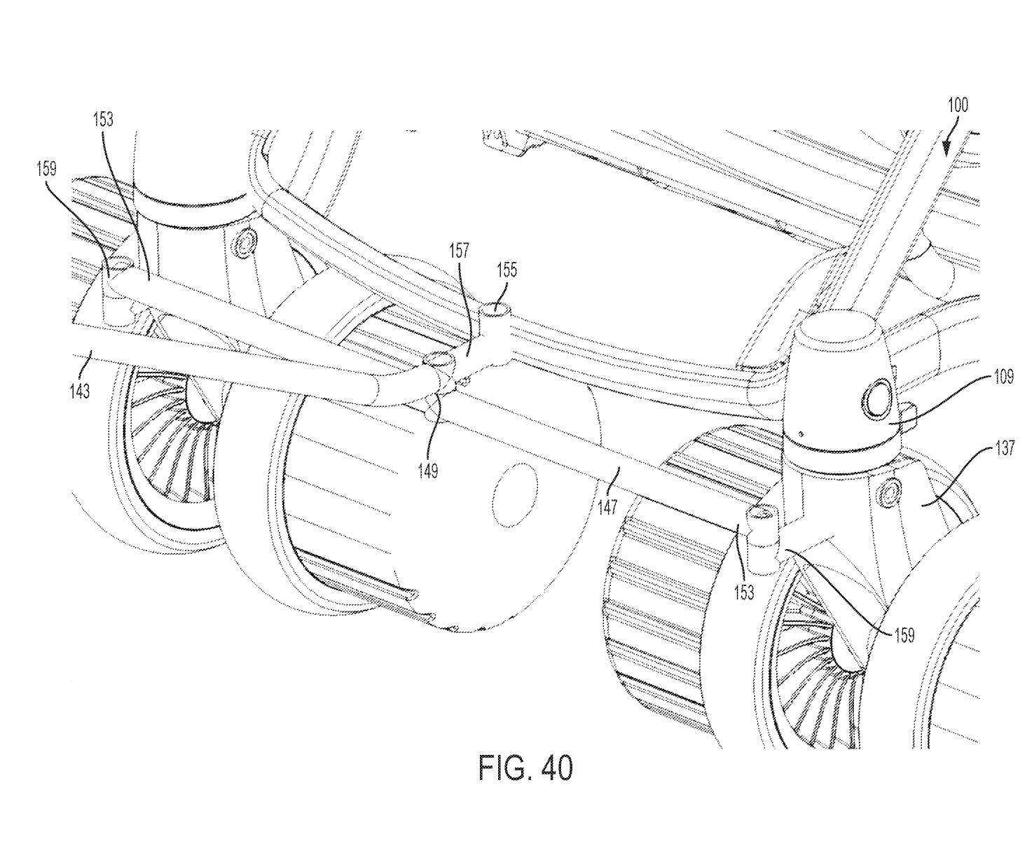

In another embodiment, a stroller may comprise a steering mechanism. FIGS. 27-41 illustrate various perspective views of a stroller 100 with the front and rear wheel assemblies 101, 103 attached, and further comprising a steering mechanism 151. The steering mechanism 151 is adapted to coordinate directional rotation of the front wheel assemblies 103. As more clearly illustrated in FIG. 40, the steering mechanism 151 comprises a steering rod 147 with a central pivot point 149. The first end and second end 153 of the steering rod 147 are pivotally attached to protruding members 159 of their respective lower hubs 137 on front wheel assemblies 103, for example pivotally attached with pins, nuts, bolts, rivets and/or other suitable parts. One end of the central pivot point 149 is connected via a linking member 157 to a frame pivot point 155 located on the frame of the stroller 100. Another end of the central pivot point 149 is connected to a rod 143 with a handle 145. In one embodiment the length of the rod 143 may be adjustable, for example via a telescopic adjustment mechanism, for example as shown in FIGS. 31-34. When a user adjusts the handle 145, the rod 143 pivots with respect to the central pivot point 149, thereby facilitating lateral movement of the steering rod 147. For example, handle 145 can be attached to the rod 143 and rod 143 embodies a pivot 155 proximate the end of the rod. Pivot 155 can be fixedly or removably attached to the stroller frame. Pivoting of the rod 143 about pivot 155 results in lateral movement of steering rod 147 through central pivot point 149. Since the ends 153 of the steering rod 147 are attached to the lower hubs 137, the front wheel assemblies 103 swivel (e.g., rotate about axis “B” as shown, for example, in FIG. 1) with respect to the upper hub 109 and stroller frame in response to the lateral movement of the steering rod 147. Additionally the frame pivot point 155 pivots with respect to the moved central pivot point 149 via the link 157. This steering mechanism 151 allows for more controlled movement of the stroller 100 along a supporting surface when pulled. FIGS. 32-36 show the rod 143 at various angles for pulling by a user, for example depending on the height of the user.

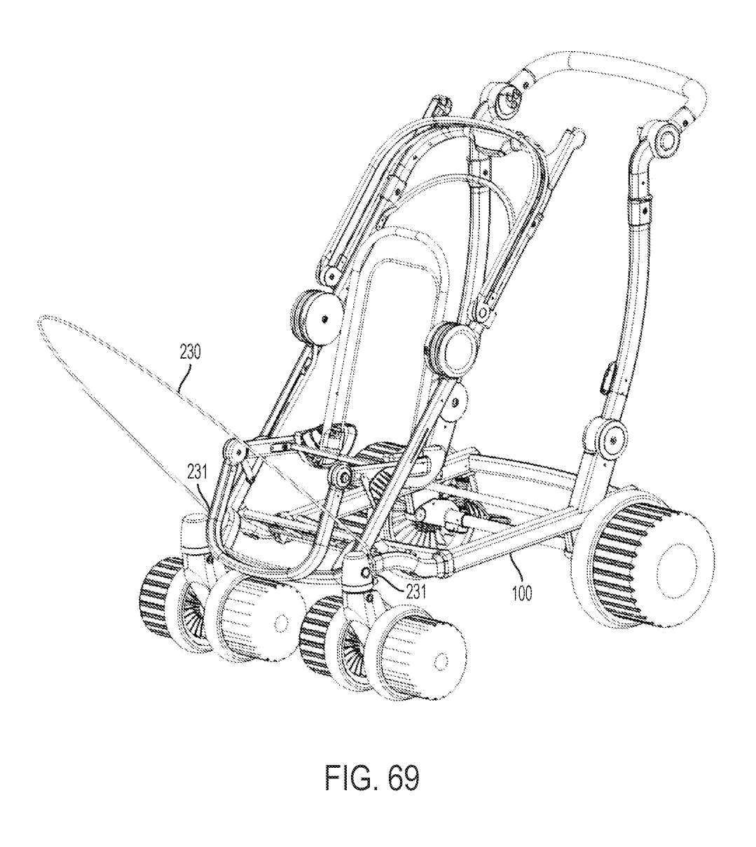

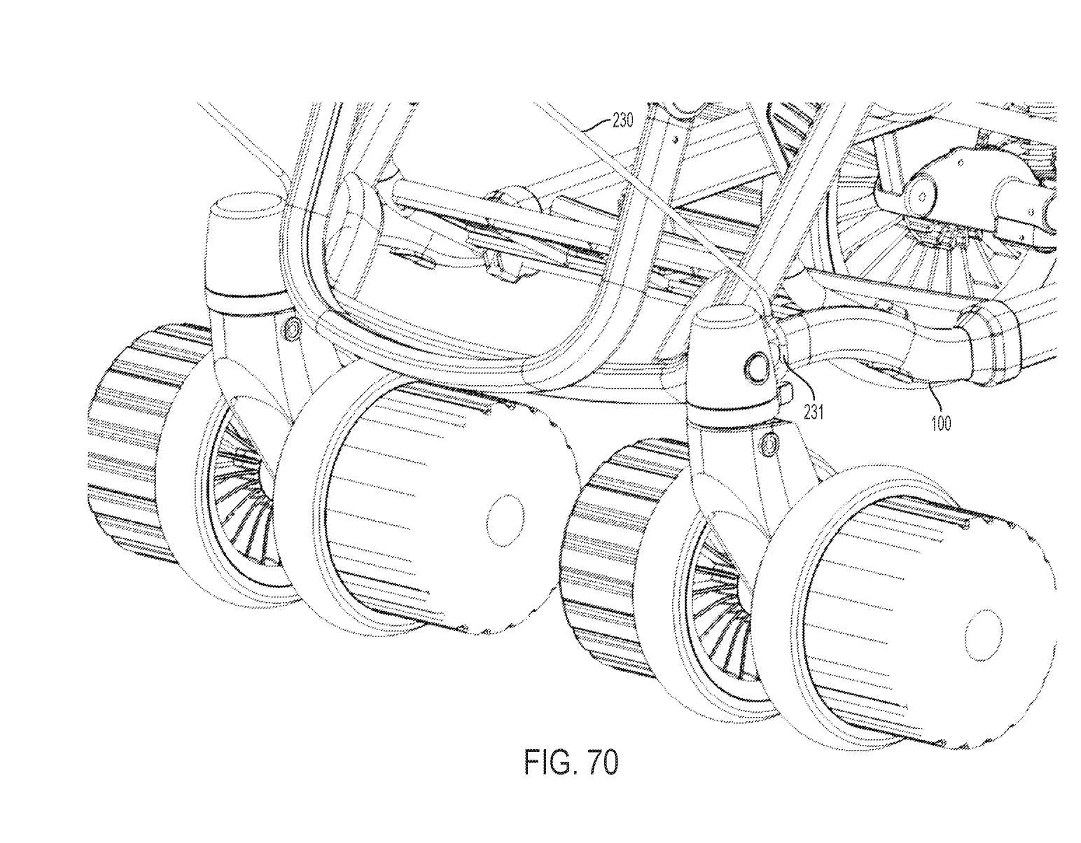

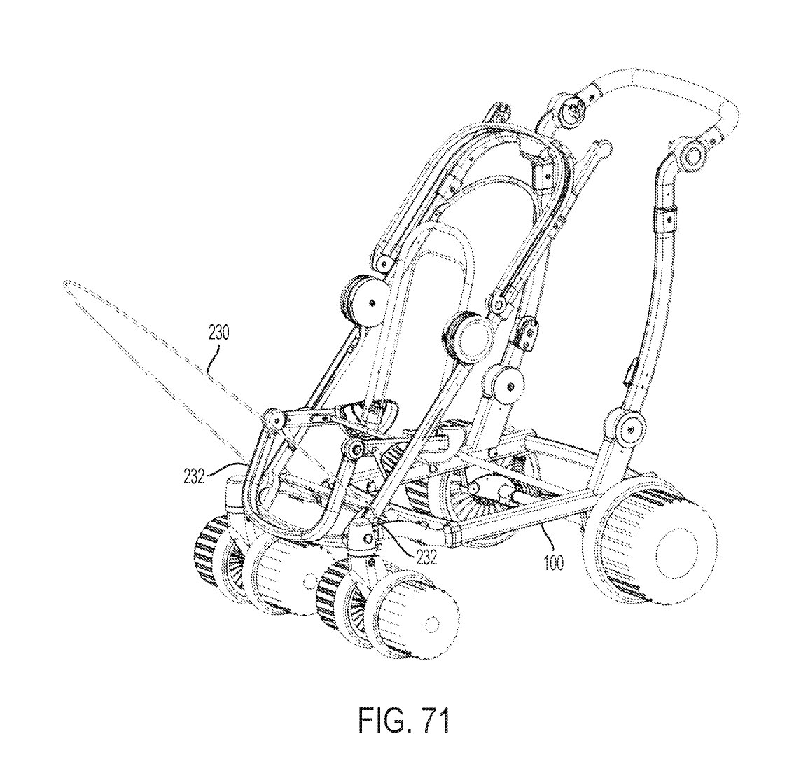

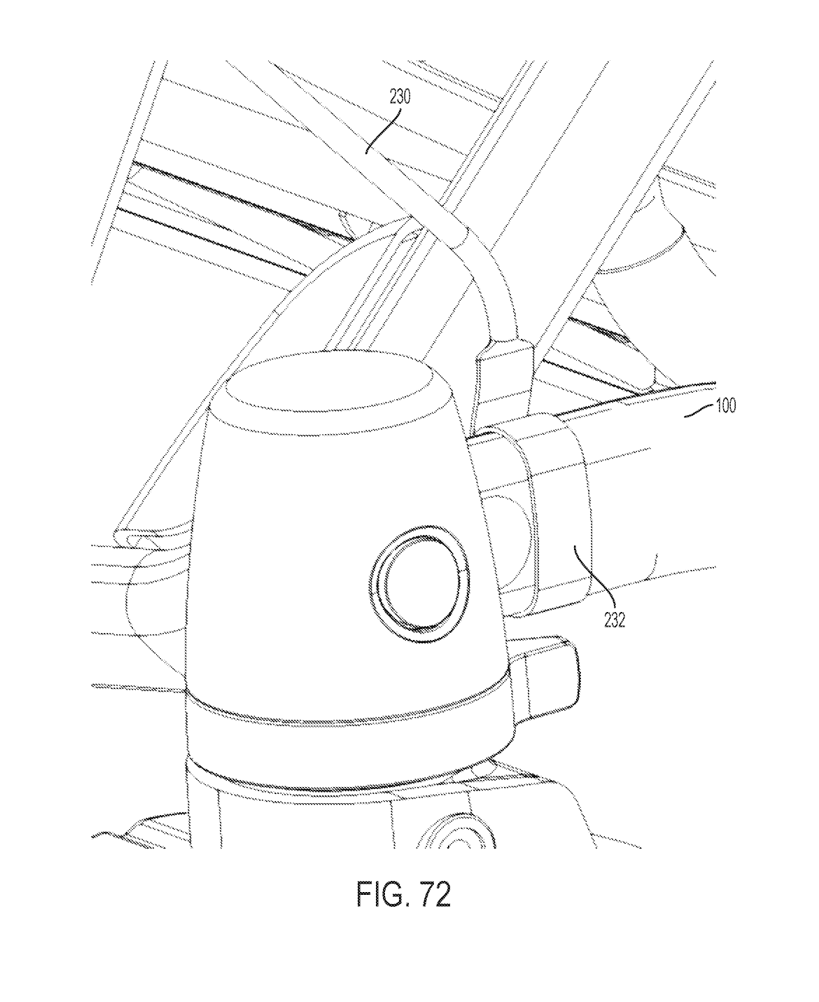

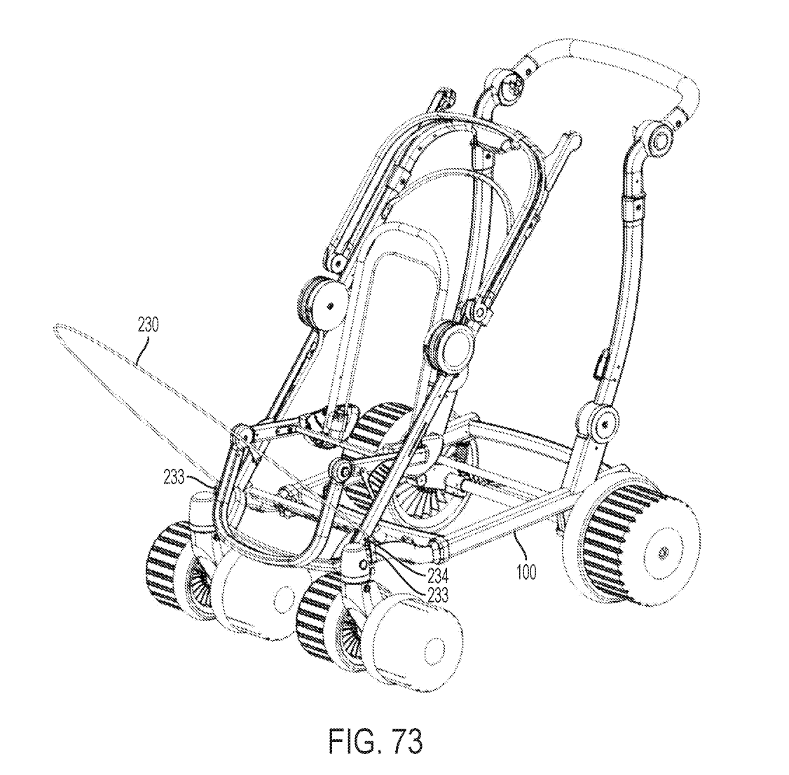

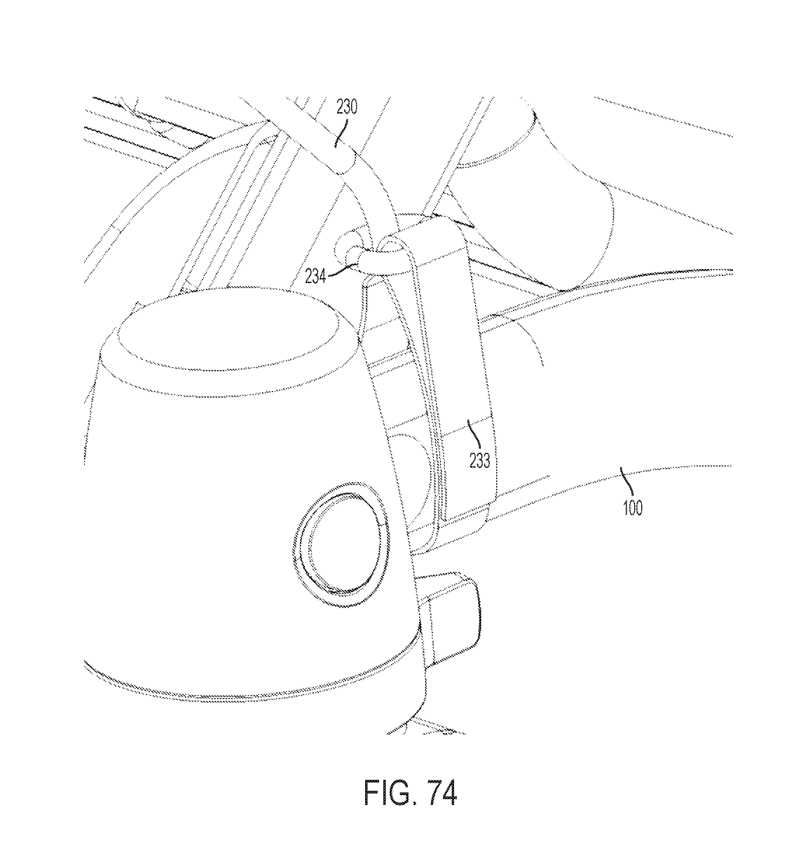

In one embodiment, as illustrated in FIGS. 69-70, a flexible pulling mechanism 230 can be attached to a frame of stroller 100 via knots 231 tied onto the stroller frame on opposite sides of the frame. In one embodiment, as illustrated in FIGS. 71-72, a flexible pulling mechanism 230 can be attached to a frame of stroller 100 via hook and loop fastener ends 232 wrapped around the stroller frame on opposite sides of the frame, for example via a buckle, loop or custom adapter loop. In one embodiment, as illustrated in FIGS. 73-74, a flexible pulling mechanism 230 can be attached to a frame of stroller 100 via hook and loop fastener ends 233 wrapped around the stroller frame and inserted through ring 234 such that hook and loop fastener end 233 sticks to itself, on opposite sides of the frame. In other embodiments, flexibly pulling mechanism 230 can be attached to the frame of stroller 100 via any suitable attachment mechanism, including for example (without limitation) buttons, snaps, ties, buckles and/or any other suitable means.

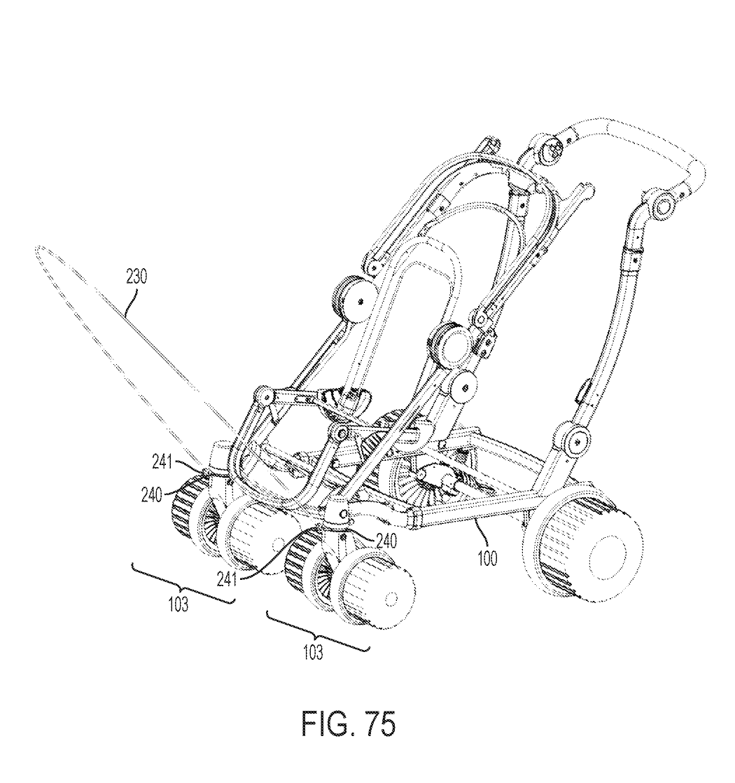

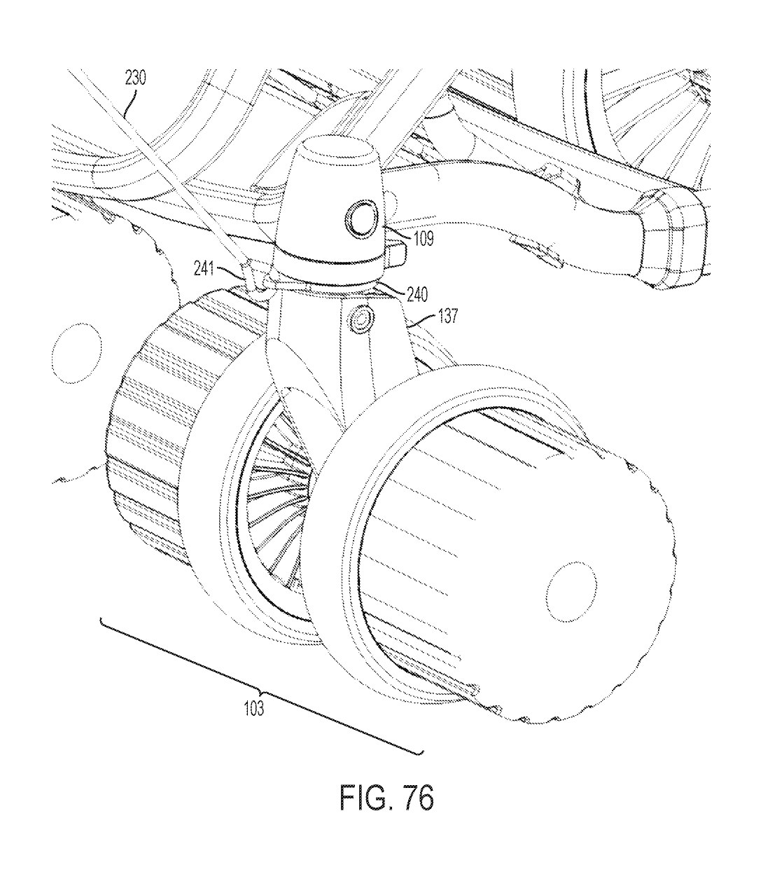

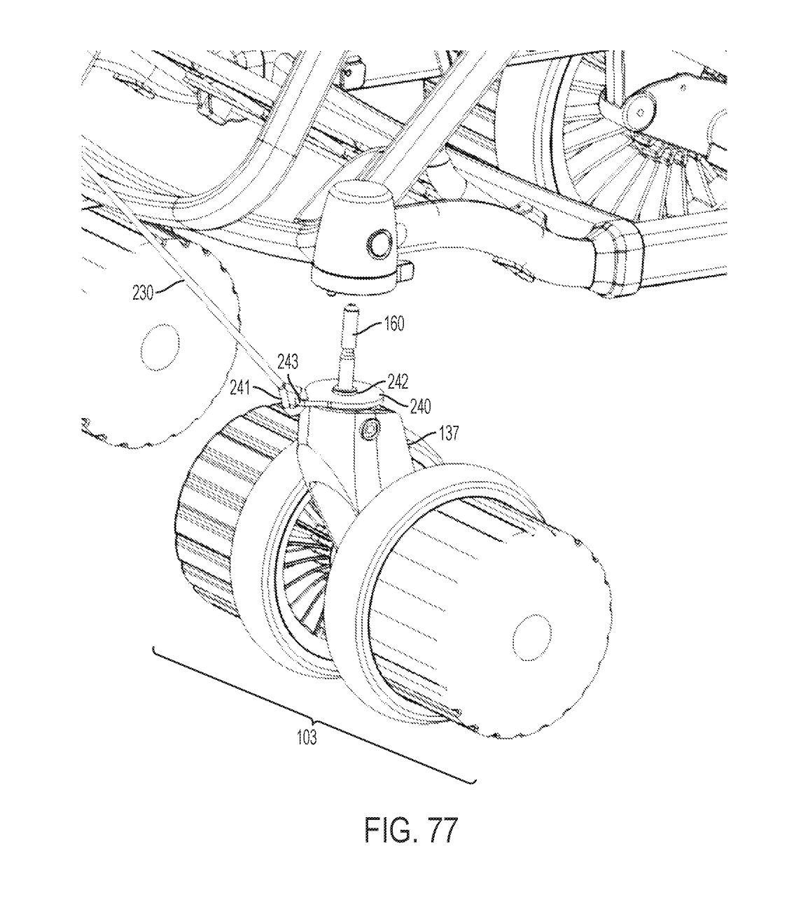

In one embodiment, as illustrated in FIGS. 75-77, a flexible pulling mechanism 230 can be attached to the front wheel assemblies 103 of stroller 100 via disc 240. Disc 240 can be metal, plastic or any suitable material and can be inserted over the “male” portion 160 of lower hub 137 of front wheel assembly 103 via center hole 142 of the disc. Disc 240 can be snapped onto lower hub 137 and can comprise hole 243 through which flexible pulling mechanism 230 can be threaded through via loop 241. Upper hub 109 can be locked into lower hub 137, for example via the locking mechanisms described herein.

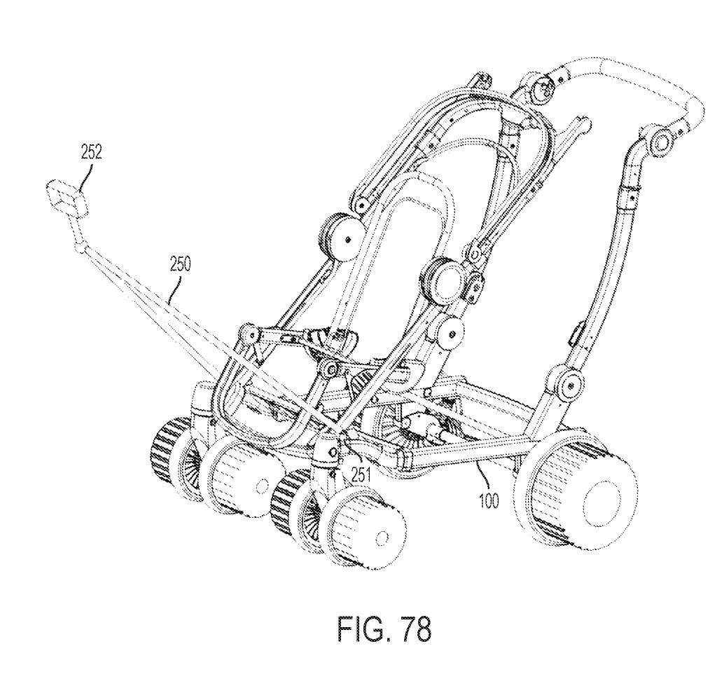

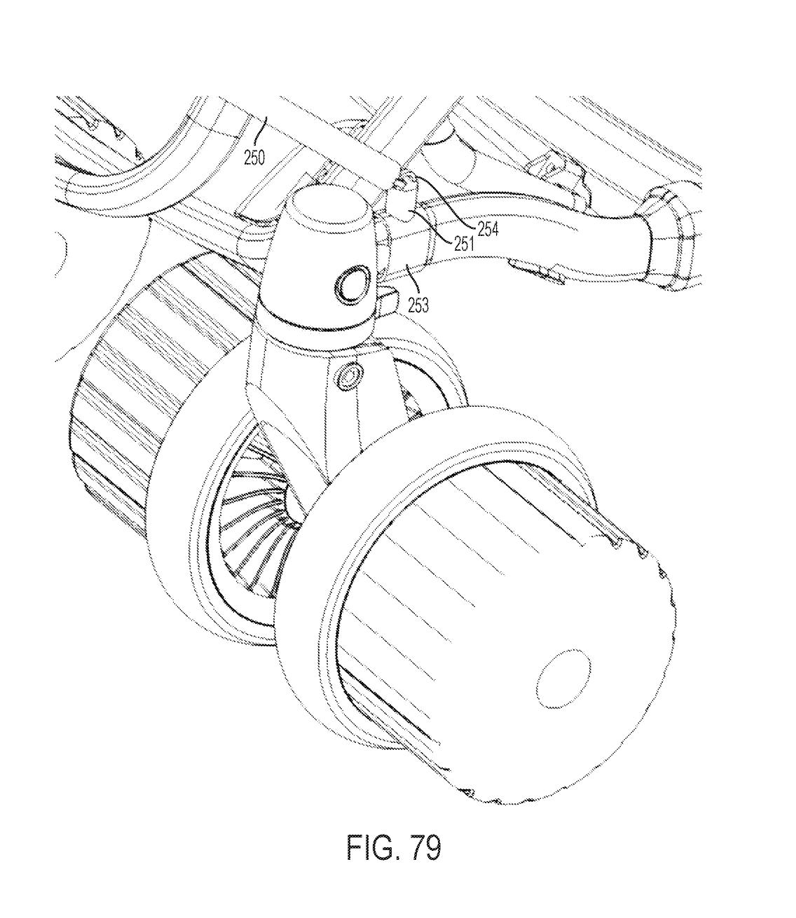

In one embodiment, as illustrated in FIGS. 78-79, a rigid pulling mechanism 250, e.g., a tow bar, can be attached to a frame of stroller 100 via top attachments 251, on opposite side of the stroller frame. Top attachment 251 can clamp onto a frame of stroller 100 via clamp 253 and can comprise a hook 254 onto which rigid pulling mechanism 250 can attach. Rigid pulling mechanism 250 can comprise a handle 252.

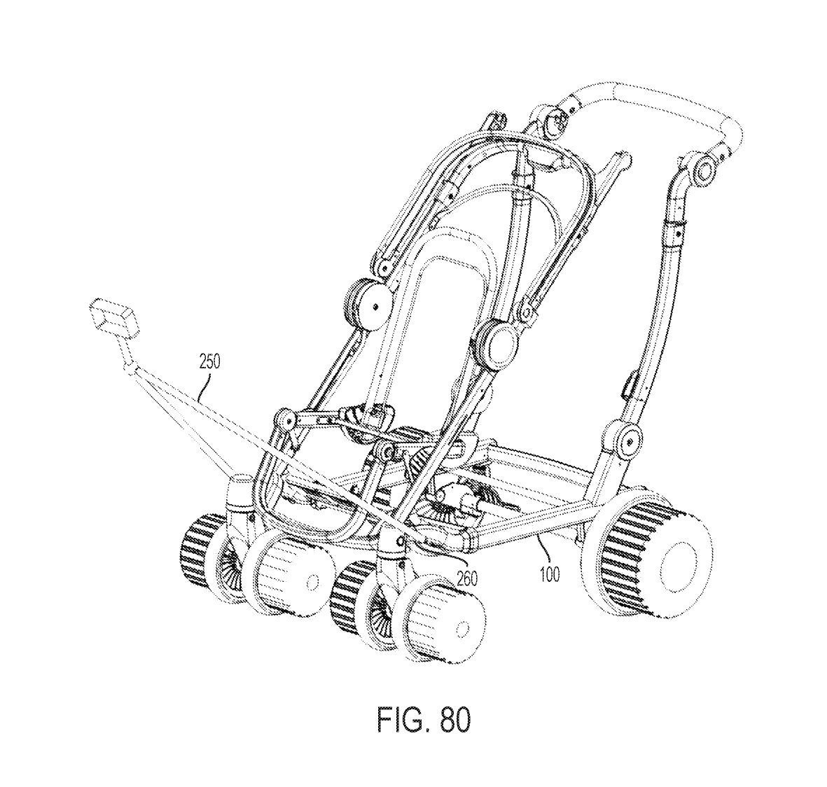

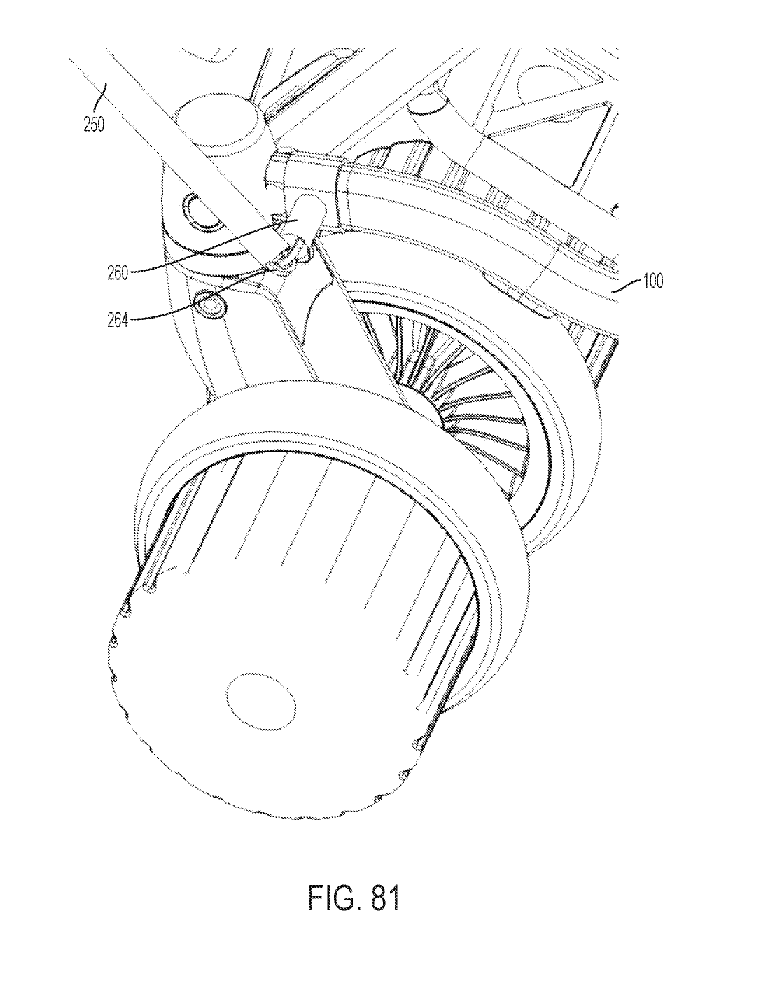

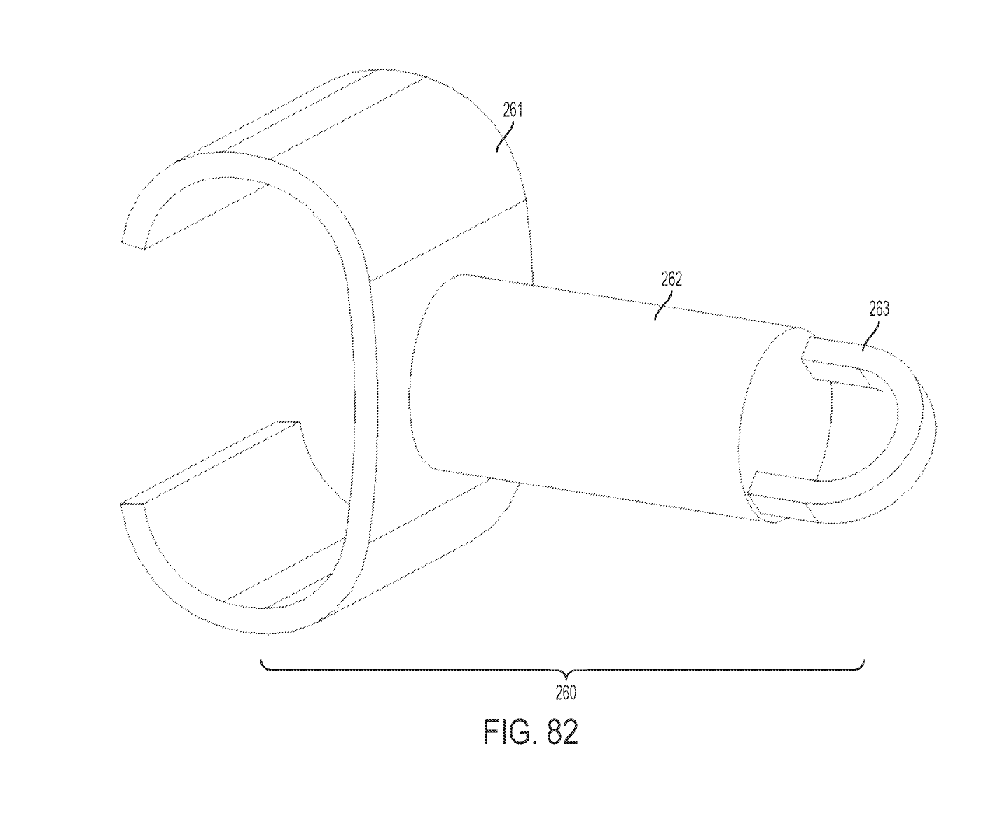

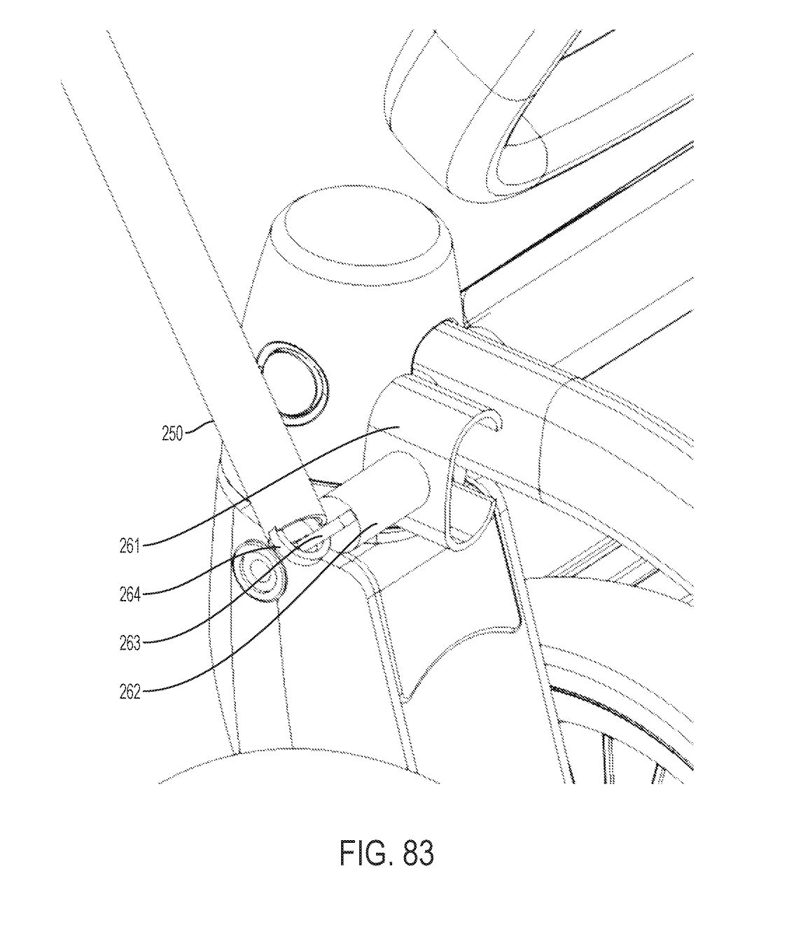

In one embodiment, as illustrated in FIGS. 80-83, a rigid pulling mechanism 250, e.g., a tow bar, can be attached to a frame of stroller 100 via side attachments 260, on opposite sides of the stroller frame. Side attachment 260 comprises a clamp 261 on one end of body 262 which can clamp onto the stroller frame, and a hook 263 on the other end of body 262. End 264 on the ends of pulling mechanism 250 can be hooked into hook 263 to attach the pulling mechanism 250 to the side attachment 260. Side attachment 260 can attach to the stroller frame such that body 262 sticks out horizontally from the stroller frame (i.e., parallel to the floor), which improves a user's ability to pull the stroller via pulling mechanism 250.

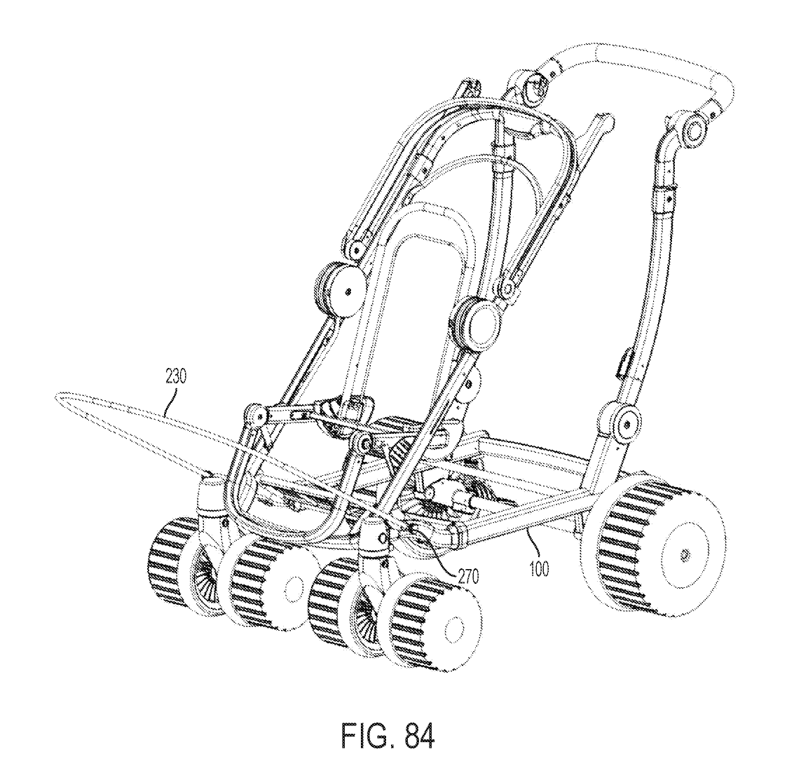

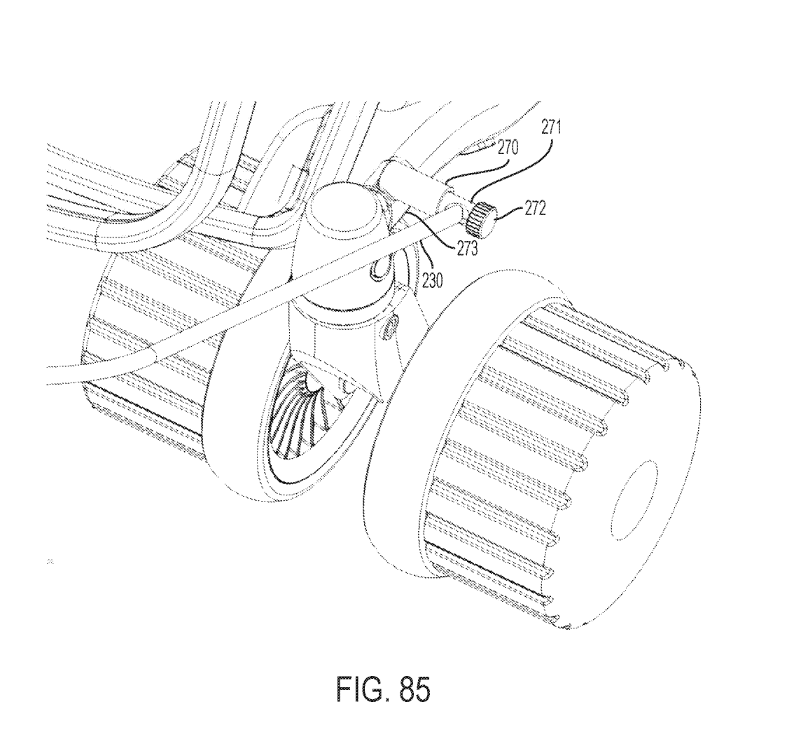

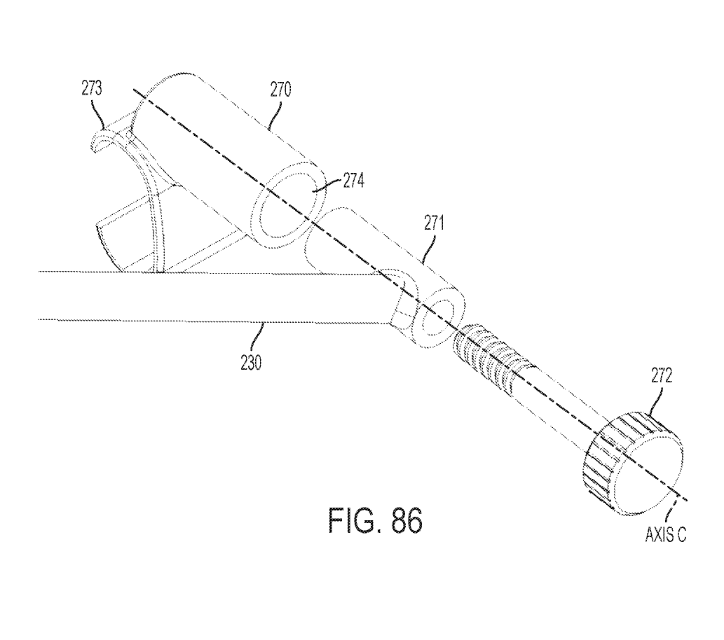

In one embodiment, as illustrated in FIGS. 84-86, a rigid pulling mechanism 230 can be attached to a frame of stroller 100 via pivot attachments 270, on opposite sides of the stroller frame. Pivot attachment 270 can comprise a clamp 273 which can clamp onto the stroller frame, and an opening 274 configured to receive insertion piece 271 on either end of the rigid pulling mechanism 230. Insertion piece 271 is held in place inside opening 274 via a screw 272 (other any other suitable attachment means) such that rigid pulling mechanism 230 can pivot about Axis C.

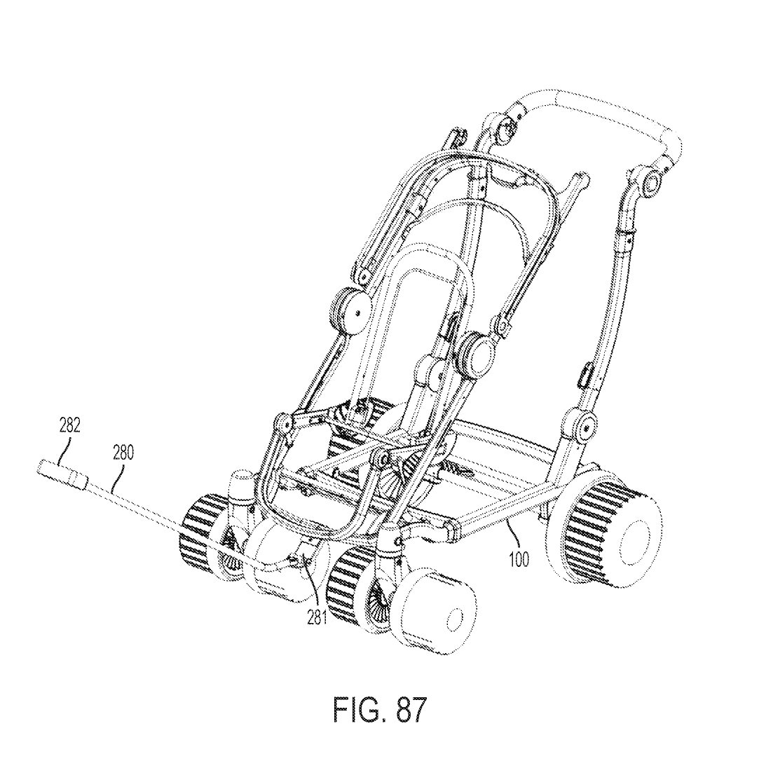

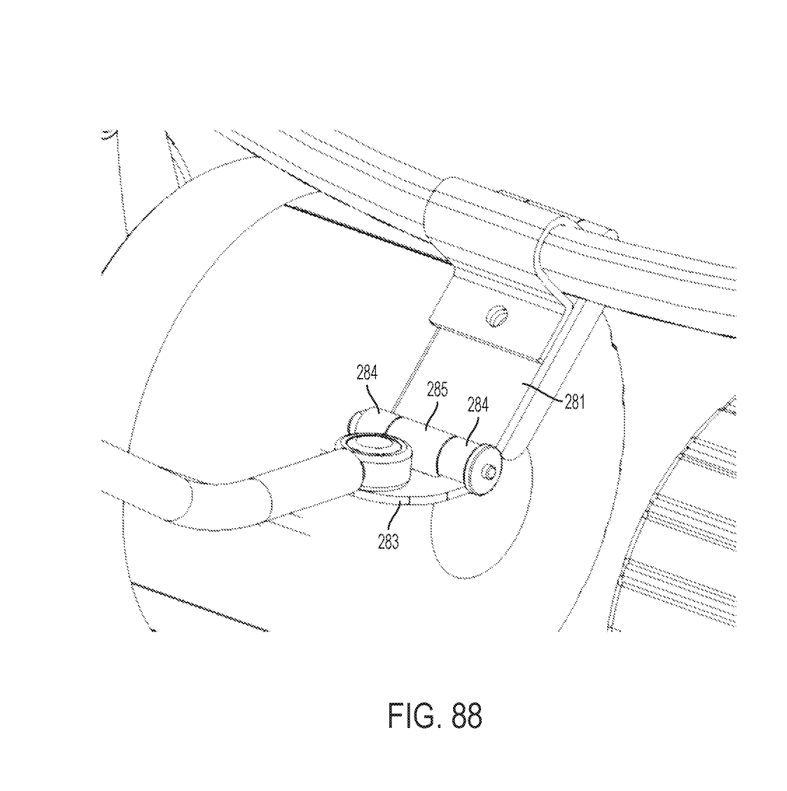

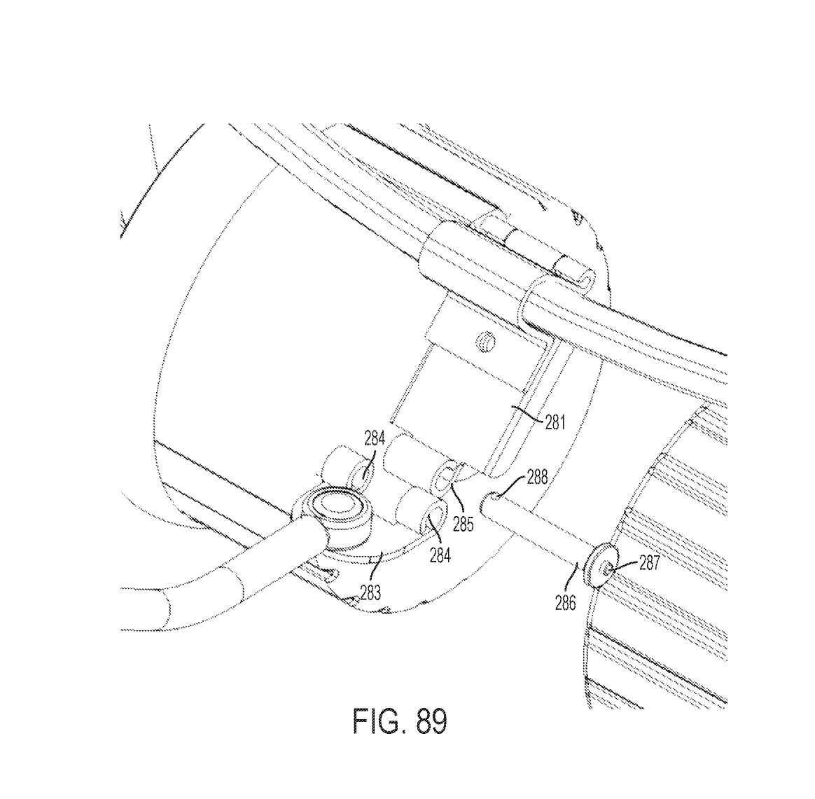

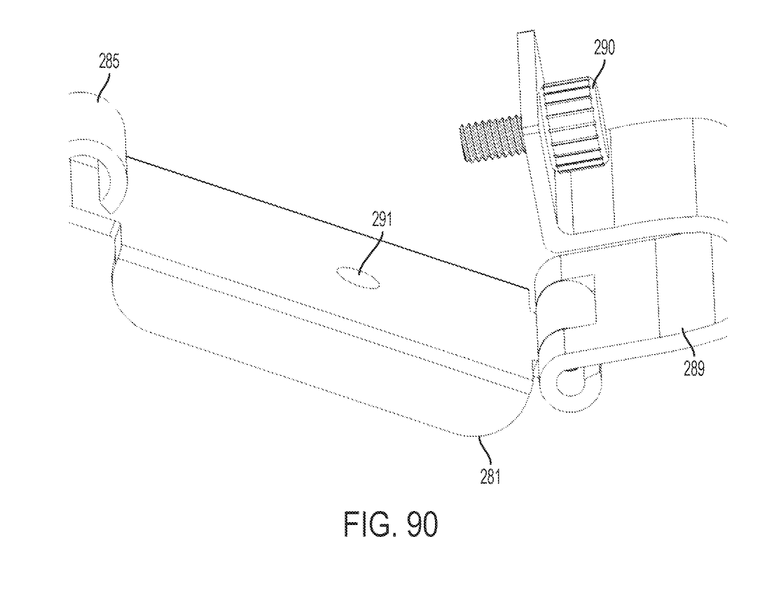

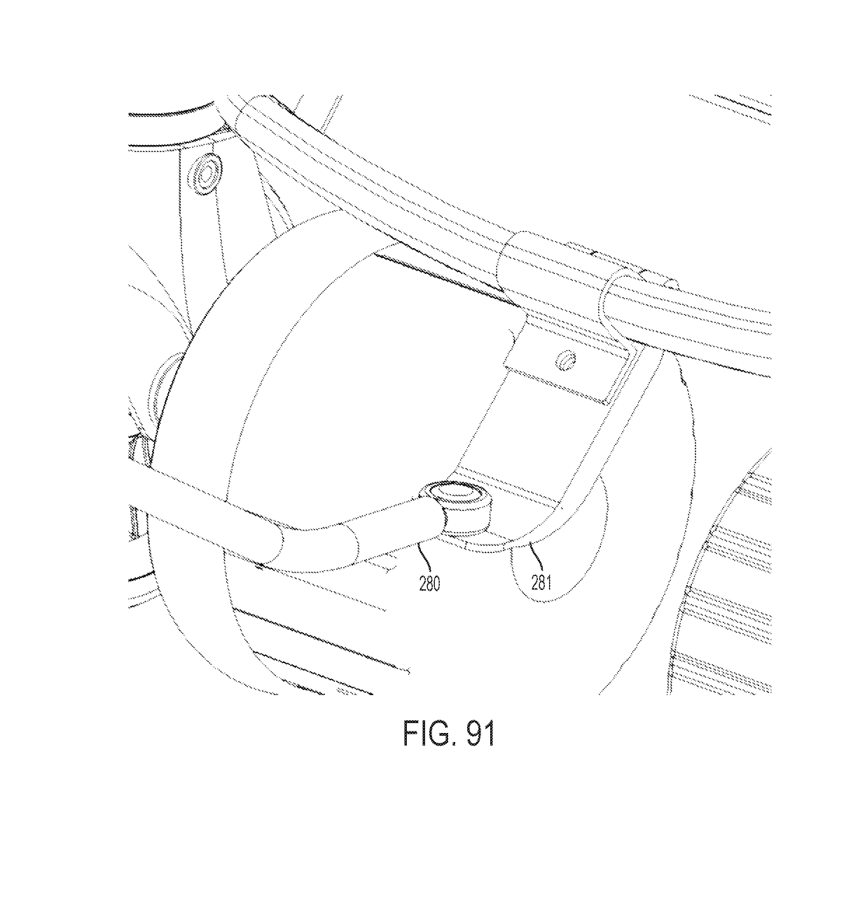

In one embodiment, as illustrated in FIGS. 87-90, a tow bar mechanism 280 can be attached to a frame of stroller 100 via tow bar attachment 281. Tow bar mechanism 280 can comprise a handle 282. Tow bar mechanism 280 can comprise tow bar plate 283 on which the tow bar is attached, and plate 283 can comprise cylinders 284. Cylinders 284 can line up with attachment cylinder 285 on either side, and tow bar plate 283 can be attached to attachment cylinder 285 via a pin mechanism 286. Pin 286 can be inserted through cylinders 284 and 285 by pushing button 287 which allows ball bearing 288 on pin 286 to depress, allowing pin 286 to slide through the openings in cylinders 284 and 285. Tow bar attachment 281 comprises attachment cylinder 285 and can be clamped onto the stroller frame via clamp 289. Clamp 289 can go over the frame and be locked via screw 290 screwing into hole 291. In this way, the tow bar attachment 281 is removable from the stroller frame and the tow bar mechanism 280 is removable from the tow bar attachment 281. In another embodiment, as illustrated in FIG. 91, tow bar mechanism 280 can be attached directly to tow bar attachment 281. In one embodiment, as illustrated in FIG. 92, tow bar mechanism 280 can comprise a telescoping handle 292.

Although the present disclosure has been described in terms of exemplary embodiments, it is not limited thereto. Rather, any claims should be construed broadly to include other variants and embodiments of the present disclosure which may be made by those skilled in the art without departing from the scope and range of equivalents of the present disclosure. This disclosure is intended to cover any adaptations or variations of the embodiments discussed herein.

1. A wheel assembly comprising:
at least one standard wheel, and
at least one modular wheel,
wherein the at least one standard wheel has a first diameter and the at least one modular wheel has a second diameter, and
wherein the first diameter is greater than the second diameter.

2. The wheel assembly of claim 1, wherein the at least one modular wheel is removably attached to the at least one standard wheel.

3. The wheel assembly of claim 1, wherein the at least one modular wheel is fixedly attached to the at least one standard wheel.

4. The wheel assembly of claim 1, wherein the at least one modular wheel is attached on the same rotational axis to the at least one standard wheel by means of a pivot axle.

5. The wheel assembly of claim 1, wherein the at least one modular wheel is attached to the at least one standard wheel via a snap-on fit mechanism.

6. The wheel assembly of claim 1, wherein the at least one standard wheel has a first surface area and the at least one modular wheel has a second surface area, and
wherein the first surface area is smaller than the second surface area.

7. The wheel assembly of claim 1, wherein the at least one standard wheel has a first tread pattern and the at least one modular wheel has a second tread pattern, and
wherein the first tread pattern is different than the second treat pattern.

8. The wheel assembly of claim 1, wherein the at least one standard wheel and the at least one modular wheel comprise at least one selected from the group consisting of plastic, rubber and synthetics.

9. The wheel assembly of claim 1, wherein one or more of the at least one standard wheel and the at least one modular wheel are gas-filled.

10. The wheel assembly of claim 1, wherein one or more of the at least one standard wheel and the at least one modular wheel are solid.

11. The wheel assembly of claim 1, wherein the wheel assembly is at least one of a rear wheel assembly of a stroller and a front wheel assembly of the stroller.

12. A stroller comprising:
a base; and
at least one rear wheel assembly located proximate to a rear of the base,
wherein the at least one rear wheel assembly comprises at least one rear standard wheel and at least one rear modular wheel,
wherein the at least one rear standard wheel has a first rear diameter and the at least one rear modular wheel has a second rear diameter, and
wherein the first rear diameter is greater than the second rear diameter.

13. The stroller of claim 12, further comprising at least one front wheel assembly located proximate to a front of the base,
wherein the at least one front wheel assembly comprises at least one front standard wheel and at least one front modular wheel,
wherein the at least one front standard wheel has a first front diameter and the at least one front modular wheel has a second front diameter, and
wherein the first front diameter is greater than the second front diameter.

14. The stroller of claim 13, wherein the at least one front wheel assembly is rotatably attached to the stroller and the at least one rear wheel assembly is rotatably attached to the stroller.

15. The stroller of claim 13, wherein the at least one front wheel assembly is rotatably attached to a front hub on the stroller on an axis substantially perpendicular to a supporting surface, and the at least one rear wheel assembly is rotatably attached to a rear hub on the stroller on an axis substantially parallel to the supporting surface.

16. The stroller of claim 13, wherein the at least one front modular wheel is removably attached to the at least one front standard wheel, and
the at least one rear modular wheel is removably attached to the at least one rear standard wheel.

17. The stroller of claim 13, wherein the at least one front modular wheel is fixedly attached to the at least one front standard wheel, and
the at least one rear modular wheel is fixedly attached to the at least one rear standard wheel.

18. The stroller of claim 13, wherein the at least one front modular wheel is attached on the same rotational axis to the at least one front standard wheel by means of a pivot axle, and
the at least one rear modular wheel is attached on the same rotational axis to the at least one rear standard wheel by means of a pivot axle.

19. The stroller of claim 13, wherein the at least one front modular wheel is attached to the at least one front standard wheel via a snap-on fit mechanism, and
the at least one rear modular wheel is attached to the at least one rear standard wheel via a snap-on fit mechanism.

20. A modular attachment to a stroller comprising:
a pulling mechanism located proximate to a front of a base of the stroller; wherein said stroller comprises a frame and a plurality of wheels attached to the frame, and wherein said pulling mechanism is attached to one or more of the frame and one or more wheels of said stroller.

21. The modular attachment of claim 20, wherein the pulling mechanism comprises one or more flexible members.

22. The modular attachment of claim 20, wherein the pulling mechanism comprises one or more rigid members.

23. The modular attachment of claim 20, further comprising a steering mechanism located proximate to the front of the base.

24. The wheel assembly of claim 1, wherein the at least one standard wheel has a radius that is about 5 mm to about 25 mm greater than the radius of the at least one modular wheel.

25. The wheel assembly of claim 1, wherein the at least one standard wheel has a radius that is about 10 mm to about 15 mm greater than the radius of the at least one modular wheel.
